(19) United States
(12) Patent Application Publication
(10) Pub. No.: US 2026/0208212 A1
(43) Pub. Date: Jul. 23, 2026

(54) SYSTEM FOR AND METHOD OF ELECTROMAGNETIC FIELD ASSISTED COLD SPRAY PROCESSING

(71) Applicant: Triton Systems, Inc., Chelmsford, MA (US)

(72) Inventors: Christopher J. Massar, Worcester, MA (US); Arthur Gavrin, Chelmsford, MA (US); Abigail Taylor, Chelmsford, MA (US); Bryer C. Sousa, Worcester, MA (US)

(73) Assignee: Triton Systems, Inc., Chelmsford, MA (US)

(21) Appl. No.: 19/457,388

(22) Filed: Jan. 23, 2026

Related U.S. Application Data
(60) Provisional application No. 63/748,803, filed on Jan. 23, 2025.

(51) Int. Cl. B05B 1/24; B22F 10/25; B22F 12/40; B22F 12/53; B33Y 30/00

(52) U.S. Cl. CPC B05B 1/24; B22F 10/25; B22F 12/40; B22F 12/53; B33Y 30/00

(57) ABSTRACT

Systems and methods can be assembled to assist in the consolidation of materials and the additive deposition of a feedstock onto a substrate. The system includes an electromagnetic field (EMF) emitter configured to heat a feedstock, a feedstock delivery device configured to deliver the feedstock, a thermal spray device comprising a spray nozzle in fluid communication with the feedstock delivery device and configured to accelerate the feedstock towards a substrate, wherein the EMF emitter is positioned relative to the spray nozzle such that it heats the feedstock in flight. The method includes heating, using an electromagnetic field (EMF) emitter, a feedstock, delivering, using a feedstock delivery device, the feedstock, and accelerating, using a thermal spray device comprising a spray nozzle, the feedstock towards a substrate, wherein the EMF emitter is positioned relative to the spray nozzle such that it heats the feedstock in flight.

### CROSS-REFERENCE TO RELATED APPLICATIONS

This application claims the benefit of priority of U.S. Provisional Patent Application Serial No. 63/748,803, filed on January 23, 2025, and titled “SYSTEM AND METHOD FOR ELECTROMAGNETIC FIELD ASSISTED COLD SPRAY PROCESSING VIA HIGH-FREQUENCY INDUCTION OR MICROWAVE HEATING,” which is incorporated by reference herein in its entirety.

### FIELD OF THE INVENTION

The present invention generally relates to the field of material processing. In particular, the present invention is directed to a system for and a method of electromagnetic field assisted cold spray processing.

### BACKGROUND

Feedstocks that are relatively harder as compared to commercially pure, non-alloyed feedstock, like ferrous materials, are notoriously difficult for cold spraying (CS) to process and require pre-processing feedstock and utilization of helium (He) as the carrier fluid. The carrier/processing gas, He, is more expensive than compressed air, non-renewable, and exceedingly difficult to reclaim. Additionally, achieving the conditions necessary to meet the required energy associated with the critical velocity includes applying high temperatures and pressures of the carrier fluid. This increases the cost of the process and the internal stresses generated in the systems.

### SUMMARY OF THE DISCLOSURE

In an aspect, a system for assisting in deposition of feedstock materials, the system comprising an electromagnetic field (EMF) emitter configured to heat a feedstock, a feedstock delivery device configured to deliver the feedstock, and a thermal spray device comprising a spray nozzle in fluid communication with the feedstock delivery device and configured to accelerate the feedstock towards a substrate, wherein the EMF emitter is positioned relative to the spray nozzle such that it heats the feedstock in flight.

In another aspect, a method of depositing feedstock materials, the method comprising heating, using an electromagnetic field (EMF) emitter, a feedstock, delivering, using a feedstock delivery device, the feedstock, and accelerating, using a thermal spray device comprising a spray nozzle in fluid communication with the feedstock delivery device, the feedstock towards a substrate, wherein the EMF emitter is positioned relative to the spray nozzle such that it heats the feedstock in flight.

These and other aspects and features of non-limiting embodiments of the present invention will become apparent to those skilled in the art upon review of the following description of specific non-limiting embodiments of the invention in conjunction with the accompanying drawings.

### BRIEF DESCRIPTION OF THE DRAWINGS

For the purpose of illustrating the invention, the drawings show aspects of one or more embodiments of the invention. However, it should be understood that the present invention is not limited to the precise arrangements and instrumentalities shown in the drawings, wherein:

FIGS. 1A and 1B depict illustrative diagrams of systems for assisting in feedstock deposition in accordance with an embodiment;

FIGS. 2A, FIG. 2B, FIG. 2C, and FIG. 3 depict illustrative diagrams of thermal spray systems in accordance with an embodiment;

FIG. 4 depicts a method of depositing feedstock materials in accordance with an embodiment;

FIG. 5 is an illustration of a platform-agnostic solution for generating depositions that meet or exceed the performance of those produced using helium as a carrier gas;

FIG. 6 is an illustration of a feasibility study examining the power transfer from an induced high-frequency field to the powder;

FIG. 7 is an illustration of an oxidation state of powder exposed to an electromagnetic field (EMF);

FIG. 8 is an illustration of an experimental Set Up for the Direct Observation and Measurement of High Frequency Input (EMF) on SS 316 Feedstock;

FIG. 9 is an illustration of two charts displaying thermal response over time with a 3.5 GHz and 7 dBm high-frequency signal input applied;

FIG. 10 is an illustration of a power draw of helical coil with respect to frequency;

FIG. 11 is an illustration of a design (Left) Build (Center) and Cross Section (Right) of transition strategy from static to dynamic testing of introducing high frequency energy (EMF) into feedstock;

FIG. 12 is an illustration of a particle in flight traveling under an rf emitter traveling at 1200 m/s as simulated by a finite-element analysis and Multiphysics simulation software platform radio-frequency module;

FIG. 13 is an illustration of an initial modeling for the environmental setup to determine the emission of high frequency (EMF) waves;

FIG. 14 is an illustration of a design (Left) build (Center) and cross section (Right) of transition strategy from static to dynamic testing of introducing high frequency energy (EMF) into feedstock;

FIG. 15A is an illustration of a control spray completed at 400 psi and 600 ˚C;

FIG. 15B is an illustration of an experimental spray completed at 400 psi and 600 ˚C and high frequency signal (EMF) of 3.5 GHz and 7.0 dBm input;

FIG. 16A is an illustration of a first chart quantification of perimeter values with respect to critical pore size;

FIG. 16B is an illustration of a second chart quantification of area values with respect to critical pore size;

FIG. 17 is an illustration of a Microhardness of substrate with respect to distance from bondline;

FIG. 18 is an illustration of a hardness measurements of the control (left) and the experimental high frequency input (EMF) (right);

FIG. 19 is an illustration of an Optical analysis of the bulk deposition revealed microcracking in the control sample, whereas the sample deposited with EMF assistance exhibited minimal to no microcracking;

FIG. 20 is an illustration of a bond line analysis comparing a control sample (left) reveals pores and cracking, while an experimental sample (right) is free of detrimental artifacts;

FIG. 21 is an illustration of a graphical representation of a concept to inductively heat powder particle just prior to deposition;

FIG. 22 is an illustration of a time lapse for deposition using a raster pattern onto a flat plate;

FIG. 23 is an illustration of a proposed EMF augmentation device from phase I with micrographs illustrating a reduction in porosity with EFM assistance for SS 316; and

FIG. 24 is a block diagram of a computing system that can be used to implement any one or more of the methodologies disclosed herein and any one or more portions thereof.

The drawings are not necessarily to scale and may be illustrated by phantom lines, diagrammatic representations and fragmentary views. In certain instances, details that are not necessary for an understanding of the embodiments or that render other details difficult to perceive may have been omitted.

### DETAILED DESCRIPTION

Cold Spray (CS) and Cold Spray Additive Manufacturing (CSAM) is a process in which traditionally metallic feedstock (expanding into polymeric, ceramic, and feedstock with combinations thereof) is accelerated through a de Laval nozzle reaching a critical velocity such that the powder undergoes severe levels of plastic deformation, lending itself to metallurgical bonding in which a deposition is formed. Through articulation of the nozzle relative to the substrate, or substrate to the nozzle, this deposition can be grown to generate a consolidation of a desired geometry. CS has been demonstrated to be exceedingly accommodating to a broad material base, with exceptional powder morphology and distribution forgiveness, and has been used for cosmetic and quasi-structural repairs. Feedstock powders, while becoming increasingly more adapted for additive manufacturing (AM) in general, are not necessarily suitable for CS. As a result, powders must be thermally preprocessed to process the powders of a pedigree via CS/CSAM. Even the ability to pre-process powder, which can triple the cost of the feedstock powder, may not be enough to make the feedstock suitable for deposition. In this case, to achieve a critical velocity suitable for disrupting the passivated layer encasing the feedstock, helium (He), a Defense Logistics Agency-listed critical material, is necessary. Using He allows for more significant acceleration of the metallic particles compared to other gases, thus yielding more substantial deformation of the particles upon impact with the substrate and improved properties, including lower porosity.

There exists a need for improvements in CS systems to increase the quality and efficiency of the deposition of feedstock powders towards structural repair/restoration and part generation.

In some aspects, a system for assisting in deposition of feedstock materials comprises an electromagnetic field (EMF) emitter configured to heat a feedstock, an attachment device configured to operably connect at least the EMF emitter to a thermal spray device carrying at least the feedstock, and one or more cooling channels operably coupled to the EMF emitter, wherein the one or more cooling channels are configured to control, using a cooling fluid, a temperature of the system.

In another aspect, a method of depositing feedstock materials comprises providing a feedstock delivery device, a spray nozzle, an electromagnetic field (EMF) emitter, a feedstock, a substrate, and a carrier fluid, mixing the feedstock and the carrier fluid, spraying the feedstock through the spray nozzle, heating the feedstock using the EMF emitter, and depositing the feedstock on the substrate.

Exemplary embodiments illustrating aspects of the present disclosure are described below in the context of several specific examples.

As used herein, the term “about,” when immediately preceding a numerical value, means a range of plus or minus 10% of that value; for example, “about 50” means 45 to 55, “about 25,000” means 22,500 to 27,500, etc., unless the context of the disclosure indicates otherwise, or is inconsistent with such an interpretation.

The present disclosure is not to be limited in terms of the particular embodiments described in this application, which are intended as illustrations of various aspects. Many modifications and variations can be made without departing from its spirit and scope, as will be apparent to those skilled in the art. Functionally equivalent methods and apparatuses within the scope of the disclosure and those enumerated herein will be evident to those skilled in the art from the descriptions. Such modifications and variations are intended to fall within the scope of the appended claims. The present disclosure is limited only by the terms of the appended claims and the full scope of equivalents to which such claims are entitled. It is to be understood that this disclosure is not limited to particular methods, reagents, compounds, compositions, or biological systems, which can, of course, vary. It is also to be understood that the terminology used herein describes particular embodiments only and is not intended to be limiting.

As used in this document, the singular forms “a,” “an,” and “the” include plural references unless the context dictates otherwise. Unless defined otherwise, all technical and scientific terms used herein have the same meanings as commonly understood by one of ordinary skill in the art. Nothing in this disclosure is to be construed as an admission that the embodiments described in this disclosure are not entitled to antedate such disclosure by prior invention. As this document uses, “comprising” means “including, but not limited to.”

While various compositions, methods, and devices are described in terms of "comprising" various components or steps (interpreted as meaning "including, but not limited to"), the compositions, methods, and devices can also "consist essentially of" or "consist of" the various components and steps, and such terminology should be interpreted as defining essentially closed-member groups.

Concerning the use of substantially any plural and singular terms herein, those having skill in the art can translate from the plural to the singular and from the singular to the plural as is appropriate to the context and application. The various singular/plural permutations may be expressly set forth herein for clarity.

It will be understood by those within the art that, in general, terms used herein, and especially in the appended claims (for example, bodies of the appended claims) are generally intended as “open” terms (for example, the term “including” should be interpreted as “including but not limited to,” the term “having” should be interpreted as “having at least,” the term “includes” should be interpreted as “includes but is not limited to,” etc.). It will be further understood by those skilled in the art that if a specific number of an introduced claim recitation is intended, such an intent will be explicitly recited in the claim, and in the absence of such recitation, no such intent is present. For example, as an aid to understanding, the following appended claims may use the introductory phrases "at least one" and "one or more" to introduce claim recitations. However, the use of such phrases should not be construed to imply that the introduction of a claim recitation by the indefinite articles "a" or "an" limits any particular claim containing such introduced claim recitation to embodiments containing only one such recitation, even when the same claim includes the introductory phrases "one or more" or "at least one" and indefinite articles such as "a" or "an" (for example, “a” and “an” should be interpreted to mean “at least one” or “one or more”); the same holds for the use of definite articles used to introduce claim recitations. In addition, even if a specific number of an introduced claim recitation is explicitly recited, those skilled in the art will recognize that such recitation should be interpreted to mean at least the recited number (for example, the bare recitation of "two recitations," without other modifiers, implies at least two recitations, or two or more recitations). Furthermore, in those instances where a convention analogous to “at least one of A, B, and C, etc.” is used, in general such a construction is intended in the sense one having skill in the art would understand the convention (for example, “ a system having at least one of A, B, and C” would include but not be limited to systems that have A alone, B alone, C alone, A and B together, A and C together, B and C together, and A, B, and C together, etc.). In those instances where a convention analogous to “at least one of A, B, or C, etc.” is used, in general such a construction is intended in the sense one having skill in the art would understand the convention (for example, “ a system having at least one of A, B, or C” would include but not be limited to systems that have A alone, B alone, C alone, A and B together, A and C together, B and C together, and A, B, and C together, etc.). It will be further understood by those within the art that virtually any disjunctive word and phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

In addition, where features or aspects of the disclosure are described in terms of Markush groups, those skilled in the art will recognize that the disclosure is also described in terms of any individual member or subgroup of members of the Markush group.

As will be understood by one skilled in the art, for any purposes, such as providing a written description, all ranges disclosed herein also encompass any possible subranges and combinations thereof. Any listed range can be easily recognized as sufficiently describing and enabling the same range to be broken down into at least equal halves, thirds, quarters, fifths, tenths, etc. As a non-limiting example, each range discussed herein can be readily broken down into a lower third, middle third, upper third, etc. As will also be understood by one skilled in the art, all languages such as “up to,” “at least,” and the like include the number recited and refer to ranges that can be broken down into subranges as discussed above. Finally, as will be understood by one skilled in the art, a range includes each member. Thus, for example, a group with 1-3 cells refers to groups with 1, 2, or 3 cells. Similarly, a group having 1-5 cells refers to groups having 1, 2, 3, 4, or 5 cells, and so forth.

This disclosure is not limited to the systems, devices, and methods described, as they may vary. The terminology used in the description is to describe the particular versions or embodiments only and is not intended to limit the scope.

Systems can be assembled to aid in depositing a metallic coating or coating containing blends of metallic, ceramic, and polymeric constituents on a substrate. In some embodiments, the system comprises an electromagnetic field (EMF) emitter configured to heat a feedstock, an attachment device configured to operably connect at least the EMF emitter to a thermal spray device carrying at least the feedstock, and one or more cooling channels configured to allow a cooling fluid to control the temperature of the system. In some embodiments, the EMF emitter comprises one of a point source emitter, an induction coil, a pair of parallel plates, at least two parallel bars, or a tube. The EMF emitter may be configured to heat the feedstock at any point in the thermal spray system. In some embodiments, the EMF emitter is configured to heat the feedstock at one of a feedstock delivery device, before a de Laval nozzle, at a converging region of a de Laval nozzle, at a stagnation region of a de Laval nozzle, at a diverging region of a de Laval nozzle, or after a de Laval nozzle.

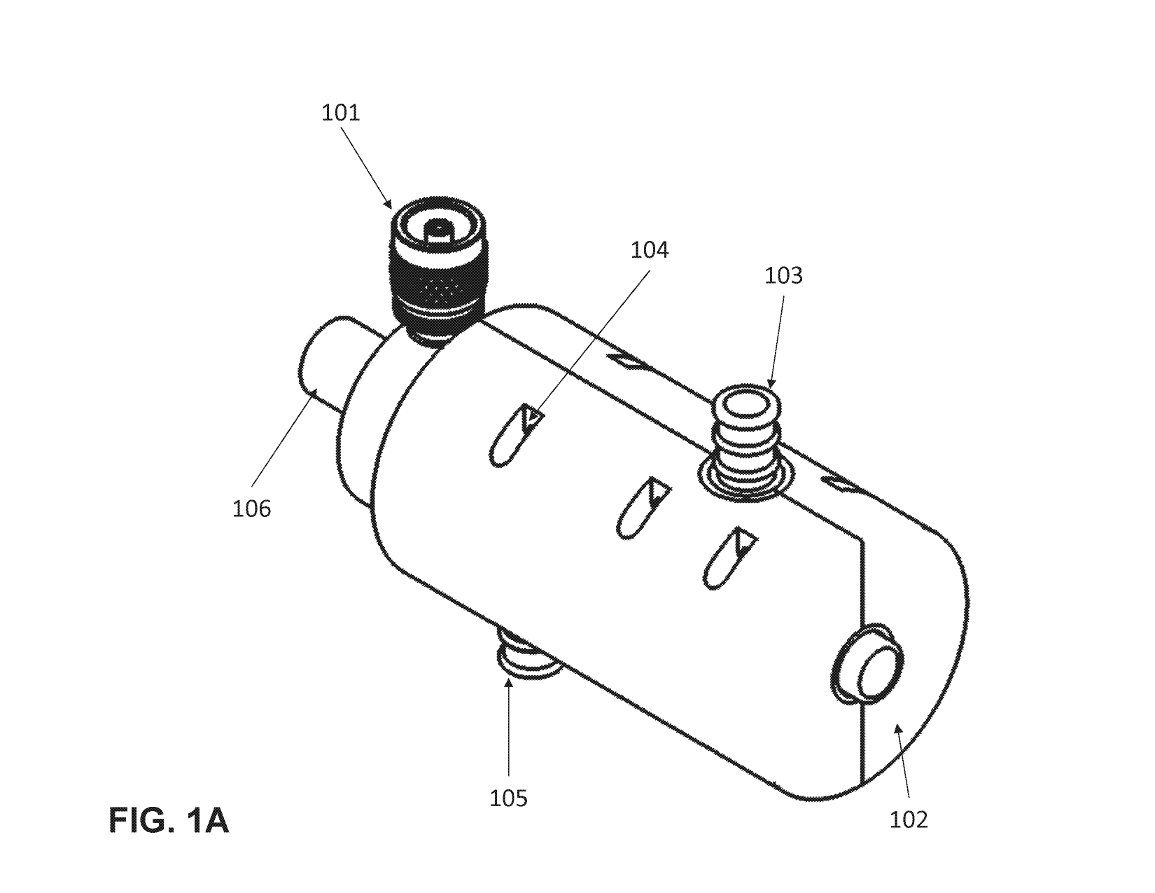

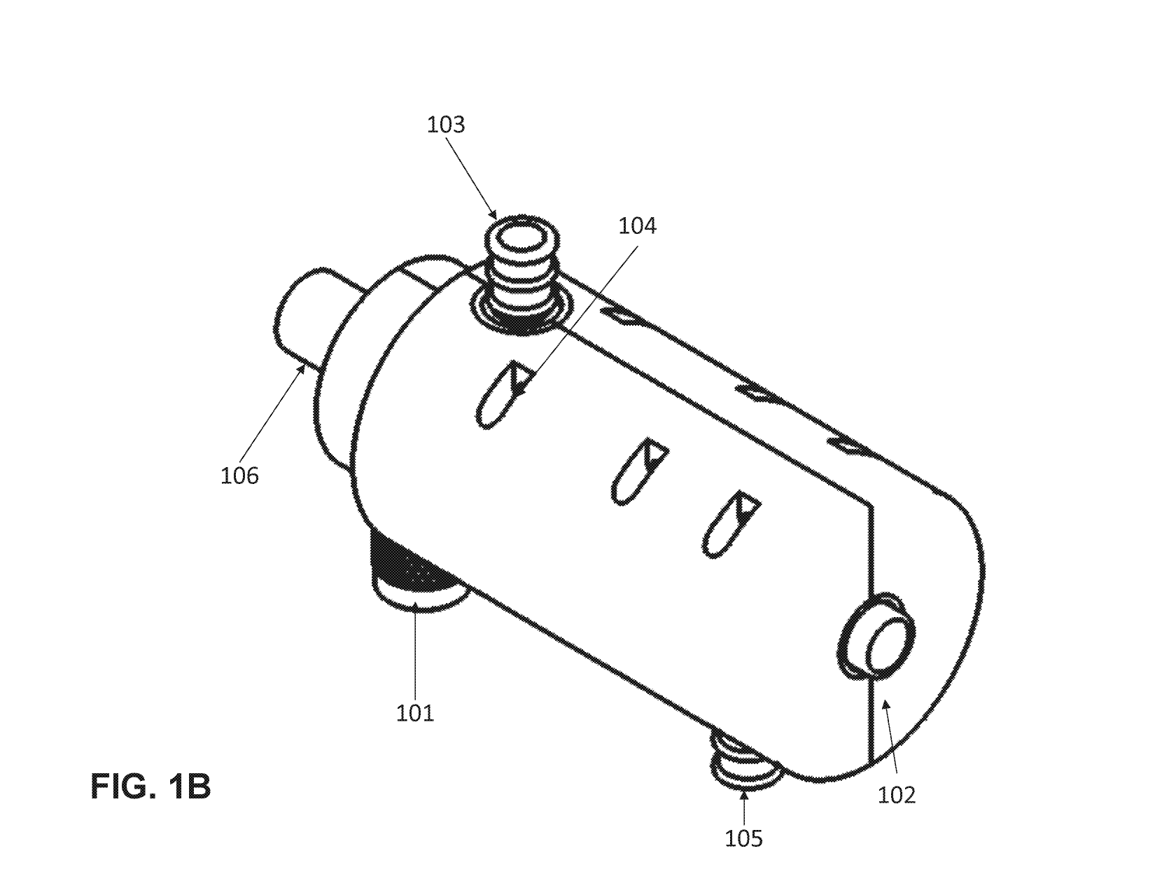

FIGS. 1A and 1B depict illustrative systems for increasing the energy of a feedstock material in a thermal spray device 106. The system comprises an electromagnetic field (EMF) emitter configured to generate an electromagnetic field and a coaxial connector 101 configured to connect a power supply to the EMF emitter. As used in this disclosure, “coaxial connector” is an electrical connector configured to operably connect a power supply to an electromagnetic field (EMF) emitter. In a non-limiting example, the coaxial connector 101 couples an external power supply to an EMF emitter to deliver a drive signal. In a non-limiting example, the coaxial connector 101 is selected to maintain signal integrity while routing power and/or frequency control to the EMF emitter. In a non-limiting example, the coaxial connector 101 is positioned on or adjacent the emitter assembly to provide a repeatable electrical interface for installation and removal. In some embodiments, the system may further comprise a coolant inlet 103 configured to allow a cooling fluid to enter the system, a coolant outlet 105 configured to allow the cooling fluid to exit the system, and one or more cooling channels configured to allow the cooling fluid to flow through the system and control the temperature of the system. As used in this disclosure, “coolant inlet” is a fluid interface configured to receive a cooling fluid for delivery into a system. In a non-limiting example, the coolant inlet 103 is a port configured to receive coolant from a supply line and direct the coolant into one or more cooling channels. In a non-limiting example, the coolant inlet 103 includes a fitting configured to couple to a hose, tube, or manifold. In a non-limiting example, the coolant inlet 103 is positioned to support continuous coolant flow during operation of an EMF emitter. As used in this disclosure, “coolant outlet” is a fluid interface configured to discharge a cooling fluid from a system. In a non-limiting example, the coolant outlet 105 is a port configured to convey coolant from one or more cooling channels to a return line. In a non-limiting example, the coolant outlet 105 includes a fitting configured to connect to a hose or tube leading to a reservoir or heat exchanger. In a non-limiting example, the coolant outlet 105 is configured to promote flow continuity and reduce backpressure. The system may further comprise at least one attachment device configured to operably connect at least the EMF emitter to the thermal spray device 106. As used in this disclosure, “thermal spray device” is an apparatus configured to deposit a material onto a substrate by propelling the material through a spray output toward the substrate to form a deposited material. This material can include a feedstock as discussed herein. As used in this disclosure, a “feedstock” is a material supplied to a deposition system and configured to be delivered, energized, and deposited onto a substrate to form a coating or deposited layer. The feedstock may include one or more of metallic materials, ceramic materials, polymeric materials, composite materials, or combinations thereof, and may be provided in a particulate, powder, granular, wire, rod, slurry, suspension, or other deliverable form suitable for transport through a feedstock delivery device. The feedstock may be conveyed alone or in combination with a carrier fluid, may be heated or energized by an electromagnetic field (EMF) emitter, and may remain in a solid, semi-solid, or partially softened state during deposition, depending on the deposition process and operating conditions. In a non-limiting example, the thermal spray device 106 includes a spray gun or nozzle assembly configured to accelerate a powder feedstock toward a target surface. In a non-limiting example, the thermal spray device 106 includes one or more of a gas supply, a feedstock feeder, and a controller configured to regulate process parameters. In a non-limiting example, the thermal spray device 106 is configured for cold spray deposition using a carrier gas to propel the feedstock while maintaining the feedstock in a solid state. The at least one attachment device may comprise one or more of bolts, fasteners, nails, screws, rivets, adhesives, clamps, or any combination of the above. The system may further comprise a case 102 encasing the system and configured to maintain a stable environment for the system. As used in this disclosure, “case” is a structure configured to at least partially enclose one or more components of a system. In a non-limiting example, the case is configured as a housing that surrounds at least a portion of an EMF emitter and defines an exterior surface for handling, mounting, or shielding. In a non-limiting example, the case is configured to support placement of internal components relative to a powder flow path or a nozzle region. In a non-limiting example, the case includes one or more openings, ports, or access features for routing cables, coolant lines, or fasteners. The system may further comprise at least one retaining device 104 configured to retain the position of the case 102. As used in this disclosure, “retaining device” is a component configured to maintain a positional relationship between two or more components. In a non-limiting example, the retaining device 104 secures a case relative to an attachment device or an emitter assembly to resist movement during use. In a non-limiting example, the retaining device 104 includes a fastener, clamp, latch, pin, or bracket configured to hold components together. In a non-limiting example, the retaining device 104 is configured to allow removal and reinstallation of the case for service or replacement. The at least one retaining device 104 may comprise one or more of bolts, fasteners, nails, screws, rivets, adhesives, clamps, or any combination of the above. In some embodiments, the case 102 comprises copper to reduce the emission of the EMF field from the system.

The EMF emitter may comprise any emitter capable of generating an electrical field known to one of skill in the art. In some embodiments, the EMF emitter comprises one a point source emitter, an induction coil, a pair of parallel plates, at least two parallel bars, or a tube. The EMF emitter may be configured to increase the kinetic energy of the feedstock to a level adequate for the direct energy deposition of the feedstock. The EMF emitter may be configured to heat the feedstock at any position in the thermal spray device. In some embodiments, the EMF emitter is configured to heat the feedstock in a feedstock delivery device. In some embodiments, the thermal spray device comprises a de Laval nozzle, and the EMF emitter is configured to heat the feedstock before the de Laval nozzle, at a converging region of the de Laval nozzle, at a stagnation region of the de Laval nozzle, at a diverging region of the de Laval nozzle, or after the de Laval nozzle. In some embodiments, the thermal spray system comprises a barrel positioned after the de Laval nozzle, and the EMF emitter is configured to heat the feedstock in the barrel. In some embodiments, the EMF emitter is configured to move to change the position at which the EMF emitter heats the feedstock. In some embodiments, the EMF emitter is configured to cover the entirety of the de Laval nozzle. In some embodiments, the position of the EMF emitter is selected to achieve a predetermined resonance frequency.

In some embodiments, the EMF emitter is configured to maintain a resonance frequency that is effective for the direct energy deposition of the feedstock. In some embodiments, the EMF emitter is configured to maintain a resonance frequency of about 500 MHz, about 550 MHz, about 600 MHz, about 650 MHz, about 700 MHz, about 750 MHz, about 800 MHz, about 850 MHz, about 900 MHz, about 850 MHz, about 900 MHz, about 950 MHz, about 1,000 MHz, about 1,100 MHz, about 1,200 MHz, about 1,300 MHz, about 1,400 MHz, about 1,500 MHz, about 1,600 MHz, about 1,700 MHz, about 1,800 MHz, about 1,900 MHz, about 2,000 MHz, about 2,500 MHz, about 3,000 MHz, about 3,500 MHz, about 4,000 MHz, about 4,500 MHz, about 5,000 MHz, about 5,500 MHz, about 6,000 MHz, about 6,500 MHz, or any value between any two of these values. In some embodiments the power supply is configured to maintain a resonance frequency of about 500 MHz to about 6,500 MHz. In some embodiments, the system comprises an antenna operably connected to the EMF emitter and configured to receive a signal to control the resonance frequency of the EMF emitter.

In some embodiments, the system further comprises a power supply. In some embodiments, the power supply is operably connected to the EMF emitter by the coaxial connector 101 and is configured to control the power and frequency of the EMF emitter. In some embodiments, the power supply is configured to maintain a resonance frequency of about 500 MHz, about 550 MHz, about 600 MHz, about 650 MHz, about 700 MHz, about 750 MHz, about 800 MHz, about 850 MHz, about 900 MHz, about 850 MHz, about 900 MHz, about 950 MHz, about 1,000 MHz, about 1,100 MHz, about 1,200 MHz, about 1,300 MHz, about 1,400 MHz, about 1,500 MHz, about 1,600 MHz, about 1,700 MHz, about 1,800 MHz, about 1,900 MHz, about 2,000 MHz, about 2,500 MHz, about 3,000 MHz, about 3,500 MHz, about 4,000 MHz, about 4,500 MHz, about 5,000 MHz, about 5,500 MHz, about 6,000 MHz, or any value between any two of these values. In some embodiments the power supply is configured to maintain a resonance frequency of about 500 MHz to about 6,000 MHz.

In some embodiments, the EMF emitter comprises an induction coil. The induction coil may comprise any configuration effective to heat the feedstock. In some embodiments, the length of the induction coil, the diameter of the induction coil, the number of coils, and the distance between the coils are controlled to achieve a predetermined resonance frequency effective to heat the feedstock. The induction coil may comprise any number of coils effective for achieving the predetermined resonance frequency. In some embodiments, the induction coil comprises 1, 2, 3, 4, 5, 6, 7, 8, 9, 10, 11, 12, 13, 14, 15, 16, 17, 18, 19, or 20 induction coils. The induction coil may comprise any diameter effective for achieving a predetermined resonance frequency.

The case 102 may comprise any configuration effective to enclose the system and configured to maintain to position of the system. In some embodiments, the case 102 is configured to act as one of a sleeve, a clamshell, or as multiple parts around the spray nozzle. In some embodiments, the case 102 comprises a Farraday cage positioned around the EMF emitter and configured to prevent the electromagnetic field from exiting the system. In some embodiments, the case 102 is configured to thermally insulate the system from the surrounding environment.

Thermal spray systems may be assembled using the above-described EMF emitter systems. In some embodiments, the thermal spray system is configured for the direct energy deposition of a feedstock. In some embodiments, the feedstock comprises one of a powder or a wire. In some embodiments, the thermal spray system is configured for cold spraying, high-pressure cold spraying, low-pressure cold spraying, vacuum cold spraying, powder-based thermal spraying, kinetic spraying, cold spray additive manufacturing, HOV, warm spraying, micro cold spraying, or directed energy deposition. The thermal spray system comprises a feedstock delivery system configured to deliver a feedstock, a spray nozzle configured to accelerate the feedstock towards a substrate, and an EMF emitter configured to enhance the kinetic energy of the feedstock within the pipe. In some embodiments, the thermal spray system comprises one or more fluid cooling channels configured to allow a cooling fluid to flow. The EMF emitter is configured to heat the feedstock to soften the feedstock thermally. This increases the feedstock's kinetic energy and allows the feedstock's total energy to be similar to the total energy of a feedstock in a system without the EMF emitter and moving at a faster velocity. Furthermore, this allows the thermal spray system to operate at a lower temperature and pressure than a thermal spray system without an EMF emitter while achieving similar quality results.

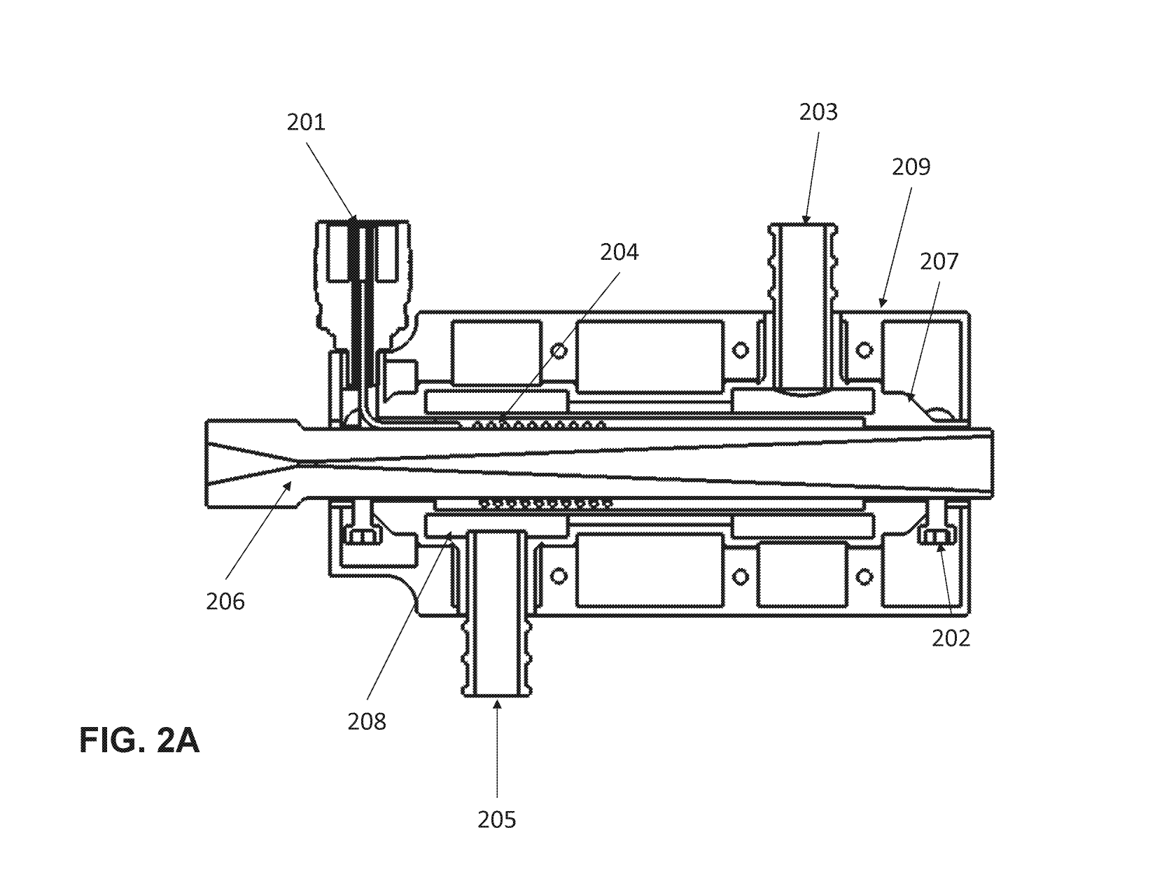

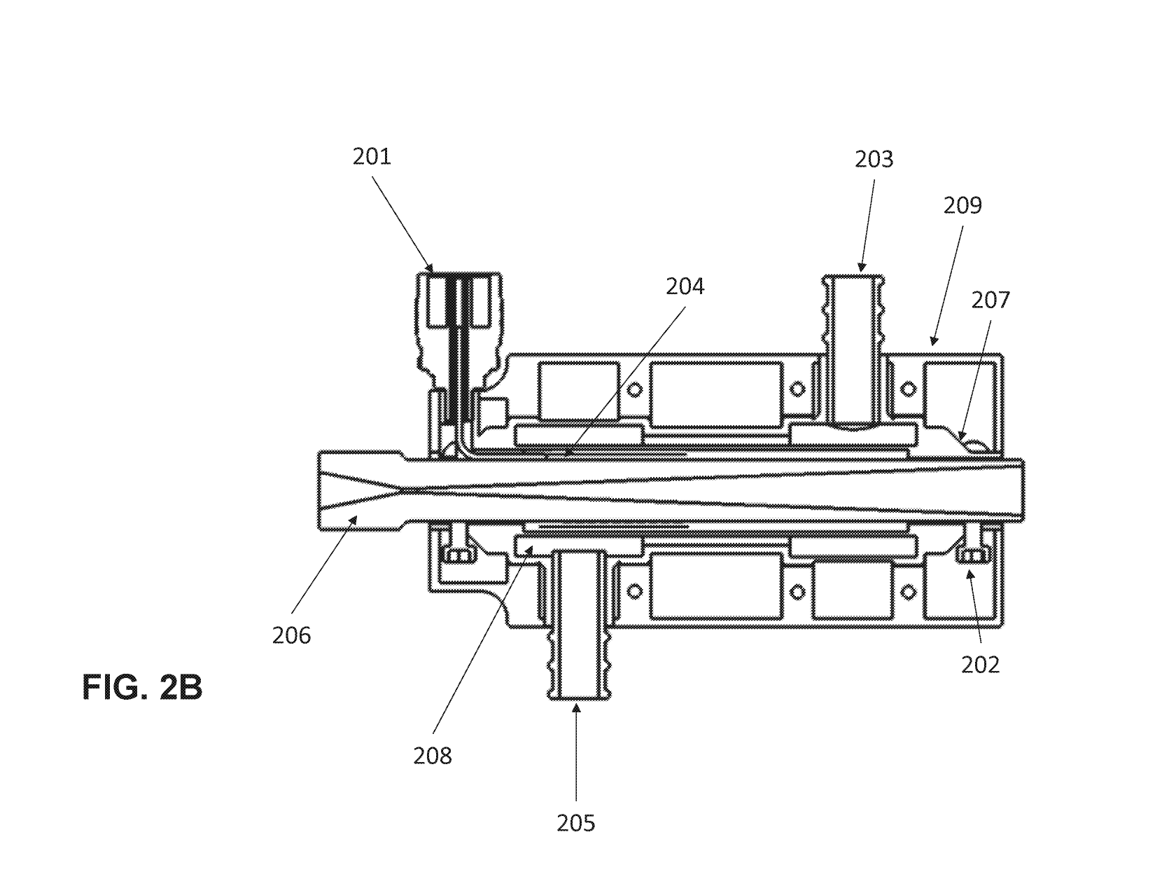

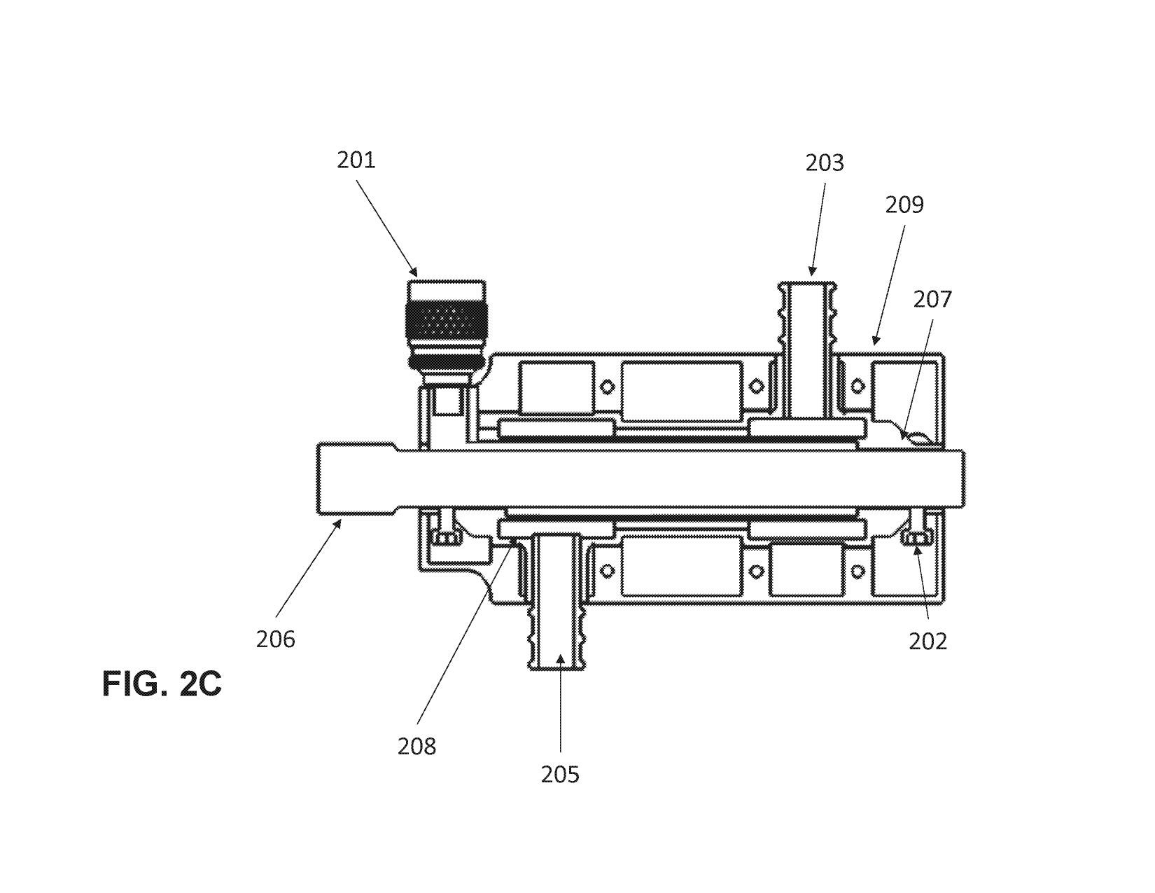

FIG. 2A depicts an illustrative feedstock deposition system comprising an electromagnetic field (EMF) emitter 204 configured to generate an electromagnetic field and a coaxial connector 201 configured to connect a power supply to the EMF emitter 204. As used in this disclosure, “EMF emitter” is a device configured to generate an electromagnetic field. In a non-limiting example, the EMF emitter 204 is configured to generate a high-frequency electromagnetic field to heat a feedstock during a deposition process. In a non-limiting example, the EMF emitter 204 is configured to be electrically connected to a power supply via a coaxial connector to receive electrical power and/or a drive signal. In a non-limiting example, the EMF emitter 204 comprises an inductive coil, an antenna, or another electromagnetic energy radiating or coupling structure configured to impart electromagnetic energy into a region containing the feedstock. In some embodiments, the feedstock deposition system may further comprise a coolant inlet 203 configured to allow a cooling fluid to enter the feedstock deposition system, a coolant outlet 205 configured to allow the cooling fluid to exit the feedstock deposition system, and one or more cooling channels 208 configured to allow the cooling fluid to flow through the feedstock deposition system and control the temperature of the feedstock deposition system. The system may further comprise a spray nozzle 206 configured to accelerate the feedstock towards a substrate using a carrier fluid. As used in this disclosure, “spray nozzle” is a flow-directing structure configured to receive a carrier fluid and feedstock and to discharge the feedstock in a stream toward a substrate at an accelerated velocity. In a non-limiting example, the spray nozzle 206 may be configured to accelerate a powder feedstock toward the substrate using a pressurized carrier gas as the carrier fluid. In a non-limiting example, the spray nozzle 206 is a de Laval nozzle having a converging section, a throat, and a diverging section to increase carrier fluid velocity and thereby accelerate the feedstock. In a non-limiting example, the spray nozzle 206 is configured to be operably coupled to a thermal spray device and positioned to establish a standoff distance relative to the substrate. In some embodiments, the spray nozzle is a de Laval nozzle. In a non-limiting example, the de Laval nozzle is configured to accelerate a carrier gas such that entrained feedstock particles are propelled at high velocity toward a substrate. In a non-limiting example, the de Laval nozzle geometry is selected to achieve a desired exit Mach number based on inlet pressure, temperature, and gas composition. In a non-limiting example, the de Laval nozzle is integrated into or coupled with a cold spray gun to support solid-state deposition of metallic powder feedstock.

The system may further comprise a case 209 encasing the EMF emitter and a portion of the feedstock deposition system and configured to maintain a stable environment for the encased portion of the feedstock deposition system. The feedstock deposition system may further comprise at least one attachment device 202 configured to operably connect the case 209 to the feedstock deposition system. As used in this disclosure, “attachment device” is a component configured to operably connect a case to a feedstock deposition system. In a non-limiting example, the attachment device 202 is configured to connect the case to the feedstock deposition system at a spray nozzle. In a non-limiting example, the attachment device 202 is configured to connect the case to the feedstock deposition system at a feedstock delivery device. In a non-limiting example, where the feedstock deposition system includes a smooth bore barrel, the attachment device 202 is configured to connect the case to the feedstock deposition system at the smooth bore barrel. In some embodiments, the at least one attachment device 202 is configured to operably connect the case 209 to the feedstock deposition system at one of the spray nozzle 206 or the feedstock delivery device. In some embodiments, the feedstock deposition system further comprises a smooth bore barrel, and the at least one attachment device 202 is configured to operably connect the case 209 to the feedstock deposition system at the smooth bore barrel.

In some embodiments, the spray nozzle 206 is configured to accelerate the feedstock at a predetermined temperature, a predetermined pressure, and with a carrier fluid selected to achieve a predetermined particle velocity. The predetermined particle velocity may be any velocity effective for directed energy deposition. In some embodiments, the predetermined velocity is about 150 m/s, about 200 m/s, about 250 m/s, about 300 m/s, about 350 m/s, about 400 m/s, about 450 m/s, about 500 m/s, about 550 m/s, about 600 m/s, about 650 m/s, about 700 m/s, about 750 m/s, about 800 m/s, about 850 m/s, about 900 m/s, about 950 m/s, about 1000 m/s, about 1050 m/s, about 1100 m/s, about 1150 m/s, about 1200 m/s, about 1250 m/s, about 1300 m/s, about 1350 m/s, about 1400 m/s, about 1450 m/s, about 1500 m/s, about 1550 m/s, about 1600 m/s, about 1650 m/s, about 1700 m/s, about 1750 m/s, about 1800 m/s, about 1850 m/s, about 1900 m/s, about 1950 m/s, about 2000 m/s, or any value between any two of these values. In some embodiments, the predetermined velocity is about 150 m/s to about 2,000 m/s.

The spray nozzle 206 may be configured to accelerate the feedstock at any pressure effective to achieve the predetermined velocity. In some embodiments, the spray nozzle 206 accelerates the feedstock with a pressure of about 80 psi, about 85 psi, about 90 psi, about 95 psi, about 100 psi, about 105 psi, about 110 psi, about 115 psi, about 120 psi, about 125 psi, about 130 psi, about 135 psi, about 140 psi, about 145 psi, about 150 psi, about 155 psi, about 160 psi, about 165 psi, about 170 psi, about 175 psi, about 180 psi, about 185 psi, about 190 psi, about 195 psi, about 200 psi, about 210 psi, about 220 psi, about 230 psi, about 240 psi, about 250 psi, about 260 psi, about 270 psi, about 280 psi, about 290 psi, about 300 psi, about 310 psi, about 320 psi, about 330 psi, about 340 psi, about 350 psi, about 360 psi, about 370 psi, about 380 psi, about 390 psi, about 400 psi, about 410 psi, about 420 psi, about 430 psi, about 440 psi, about 450 psi, about 460 psi, about 470 psi, about 480 psi, about 490 psi, about 500 psi, about 510 psi, about 520 psi, about 530 psi, about 540 psi, about 550 psi, about 560 psi, about 570 psi, about 580 psi, about 590 psi, about 600 psi, about 650 psi, about700 psi, about 750 psi, about 800 psi, about 850 psi, about 900 psi, about 950 psi, about 1,000 psi, about 1,050 psi, about 1,100 psi, about 1,150 psi, about 1,200 psi, about 1250 psi, about 1,300 psi, or any value between any two of these values. In some embodiments, the spray nozzle 206 accelerates the feedstock with a pressure of about 80 psi to about 1,300 psi, about 100 psi to about 1,000 psi, or about 400 psi to about 700 psi.

The spray nozzle 206 may be configured to accelerate the feedstock at any temperature effective to achieve the predetermined velocity. In some embodiments, the thermal spray system comprise a heater configured to heat the carrier fluid. In some embodiments, the spray nozzle 206 accelerates the feedstock at a temperature of about 10 °C, about 11 °C, about 12 °C, about 13 °C, about 14 °C, about 15 °C, about 16 °C, about 17 °C, about 18 °C, about 19 °C, about 20 °C, about 25 °C, about 30 °C, about 35 °C, about 40 °C, about 45 °C, about 50 °C, about 55 °C, about 60 °C, about 65 °C, about 70 °C, about 75 °C, about 80 °C, about 85 °C, about 90 °C, about 95 °C, about 100 °C, about 105 °C, about 110 °C, about 115 °C, about 120 °C, about 125 °C, about 130 °C, about 135 °C, about 140 °C, about 145 °C, about 150 °C, about 155 °C, about 160 °C, about 165 °C, about 170 °C, about 175 °C, about 180 °C, about 185 °C, about 190 °C, about 195 °C, about 200 °C, about 210 °C, about 220 °C, about 230 °C, about 240 °C, about 250 °C, about 260 °C, about 270 °C, about 280 °C, about 290 °C, about 300 °C, about 310 °C, about 320 °C, about 330 °C, about 340 °C, about 350 °C, about 360 °C, about 370 °C, about 380 °C, about 390 °C, about 400 °C, about 410 °C, about 420 °C, about 430 °C, about 440 °C, about 450 °C, about 460 °C, about 470 °C, about 480 °C, about 490 °C, about 500 °C, about 510 °C, about 520 °C, about 530 °C, about 540 °C, about 550 °C, about 560 °C, about 570 °C, about 580 °C, about 590 °C, about 600 °C, about 700 °C, about 800 °C, about 900 °C, about 1,000 °C, about 1,100 °C, about 1,200 °C, or any value between any two of these values. In some embodiments, the spray nozzle 206 accelerates the feedstock at a temperature selected based on the feedstock material. In some embodiments, the spray nozzle 206 accelerates the feedstock at a temperature of about two-thirds of the melting point of the feedstock to a temperature less than the melting point of the feedstock.

The carrier fluid may be any carrier fluid effective for achieving the predetermined velocity. In some embodiments, the carrier fluid comprises one or more of nitrogen, helium, neon, argon, krypton, xenon, radon, IPA, and air.

In some embodiments, the spray nozzle 206 comprises a converging region, a stagnation region, and a diverging region. In some embodiments, the converging region is angled to provide the feedstock to the stagnation region. The converging region may have any effective angle for delivering feedstock to the stagnation region and reducing the inner diameter of the spray nozzle 206. In some embodiments, the converging region has an angle of about 20 degrees, about 25 degrees, about 30 degrees, about 35 degrees, about 40 degrees, about 45 degrees, about 50 degrees, about 55 degrees, about 60 degrees, about 65 degrees, about 70 degrees, about 75 degrees, about 80 degrees, about 85 degrees, about 90 degrees, about 95 degrees, about 100 degrees, about 105 degrees, about 110 degrees, about 115 degrees, about 120 degrees, or any value between any two of these values.

In some embodiments, the stagnation region has a smaller diameter than the converging region and the diverging region and is configured to accelerate the feedstock. The stagnation region may have any diameter that is effective for the acceleration of the feedstock. In some embodiments, the stagnation region has a diameter of about 0.1 mm, about 0.2 mm, about 0.3 mm, about 0.4 mm, about 0.5 mm, about 0.6 mm, about 0.7 mm, about 0.8 mm, about 0.9 mm, about 1.0 mm, about 1.1 mm, about 1.2 mm, about 1.3 mm, about 1.4 mm, about 1.5 mm, about 1.6 mm, about 1.7 mm, about 1.8 mm, about 1.9 mm, about 2.0 mm, about 2.1 mm, about 2.2 mm, about 2.3 mm, about 2.4 mm, about 2.5 mm, about 2.6 mm, about 2.7 mm, about 2.8 mm, about 2.9 mm, about 3.0 mm, about 3.5 mm, about 4.0 mm, about 4.5 mm, about 5.0 mm, about 5.5 mm, about 6.0 mm, about 6.5 mm, about 7.0 mm, about 7.5 mm, about 8.0 mm, about 8.5 mm, about 9.0 mm, about 9.5 mm, about 10.0 mm, about 11 mm, about 12 mm, about 13 mm, about 14 mm, about 15 mm, about 16 mm, about 17 mm, about 18 mm, about 19 mm, about 20 mm, about 21 mm, about 22 mm, about 23 mm, about 24 mm, about 25 mm, about 26 mm, about 27 mm, about 28 mm, about 29 mm, about 30 mm, or any value between any two of these values.

In some embodiments, diverging region is configured to receive the accelerated feedstock from the stagnation region and deliver the feedstock to the substrate. In some embodiments, the diverging region is configured to deliver the feedstock to a substrate to create a coating. The diverging region may have any effective angle for delivering the accelerated feedstock to the substrate. In some embodiments, the diverging region is angled to increase the inner diameter of the spray nozzle 206. In some embodiments, the diverging region has an angle of about 5 degrees, about 10 degrees, about 15 degrees, about 20 degrees, about 25 degrees, about 30 degrees, about 35 degrees, about 40 degrees, about 45 degrees, about 50 degrees, about 55 degrees, about 60 degrees, about 65 degrees, about 70 degrees, about 75 degrees, about 80 degrees, about 85 degrees, about 90 degrees, about 95 degrees, about 100 degrees, about 105 degrees, about 110 degrees, about 115 degrees, about 120 degrees, or any value between any two of these values.

In some embodiments, spray nozzle 206 has a length of about 80 mm, about 85 mm, about 90 mm, about 95 mm, about 100 mm, about 105 mm, about 110 mm, about 115 mm, about 120 mm, about 125 mm, about 130 mm, about 135 mm, about 140 mm, about 145 mm, about 150 mm, about 155 mm, about 160 mm, about 165 mm, about 170 mm, about 175 mm, about 180 mm, about 185 mm, about 190 mm, about 195 mm, about 200 mm, about 210 mm, about 220 mm, about 230 mm, about 240 mm, about 250 mm, about 260 mm, about 270 mm, about 280 mm, about 290 mm, about 300 mm, about 350 mm, about 400 mm, about 450 mm, about 500 mm, about 550 mm, about 600 mm, about 650 mm, about 700 mm, about 750 mm, or any value between any two of these values.

In some embodiments, thermal spray system further comprises a smooth bore barrel configured to receive the accelerated feedstock from the spray nozzle and deliver the accelerated feedstock to the substrate. In some embodiments, the EMF emitter 204 is configured to heat the feedstock in the smooth bore barrel. In some embodiments, the EMF emitter 204 is configured to heat the feedstock just before the feedstock deposition on the substrate. In some embodiments, the thermal spray system comprises a pipe, wherein the pipe comprises one or more of the spray nozzle 206 and the smooth bore barrel. In some embodiments, the inner diameter of the EMF emitter 204 is in contact with the outer diameter of the pipe. In some embodiments, the inner diameter of EMF emitter 204 is larger than the outer diameter of the pipe, and the EMF emitter 204 does not contact pipe. The spacing between the EMF emitter 204and the pipe may be any distance effective for the inductive heating of the feedstock without melting the pipe. In some embodiments, the spacing between the EMF emitter 204 and the pipe is about 0.5 mm, about 1.0 mm, about 1.5 mm, about 2.0 mm, about 2.5 mm, about 3.0 mm, about 3.5 mm, about 4.0 mm, about 4.5 mm, about 5.0 mm, or any value between any two of these values. In some embodiments, the spacing between the EMF emitter 204 and the pipe is about 0.5 mm to about 5.0 mm or about 1.0 mm to about 3.0 mm.

The smooth bore barrel may have any length effective for delivering feedstock from the spray nozzle 206 to the substrate. In some embodiments, the smooth bore barrel has a length of about 50 mm, about 55 mm, about 60 mm, about 65 mm, about 70 mm, about 75 mm, about 80 mm, about 85 mm, about 90 mm, about 95 mm, about 100 mm, about 105 mm, about 110 mm, about 115 mm, about 120 mm, about 125 mm, about 130 mm, about 135 mm, about 140 mm, about 145 mm, about 150 mm, about 155 mm, about 160 mm, about 165 mm, about 170 mm, about 175 mm, about 180 mm, about 185 mm, about 190 mm, about 195 mm, about 200 mm, about 210 mm, about 220 mm, about 230 mm, about 240 mm, about 250 mm, about 260 mm, about 270 mm, about 280 mm, about 290 mm, about 300 mm, about 350 mm, about 400 mm, about 450 mm, about 500 mm, or any value between any two of these values.

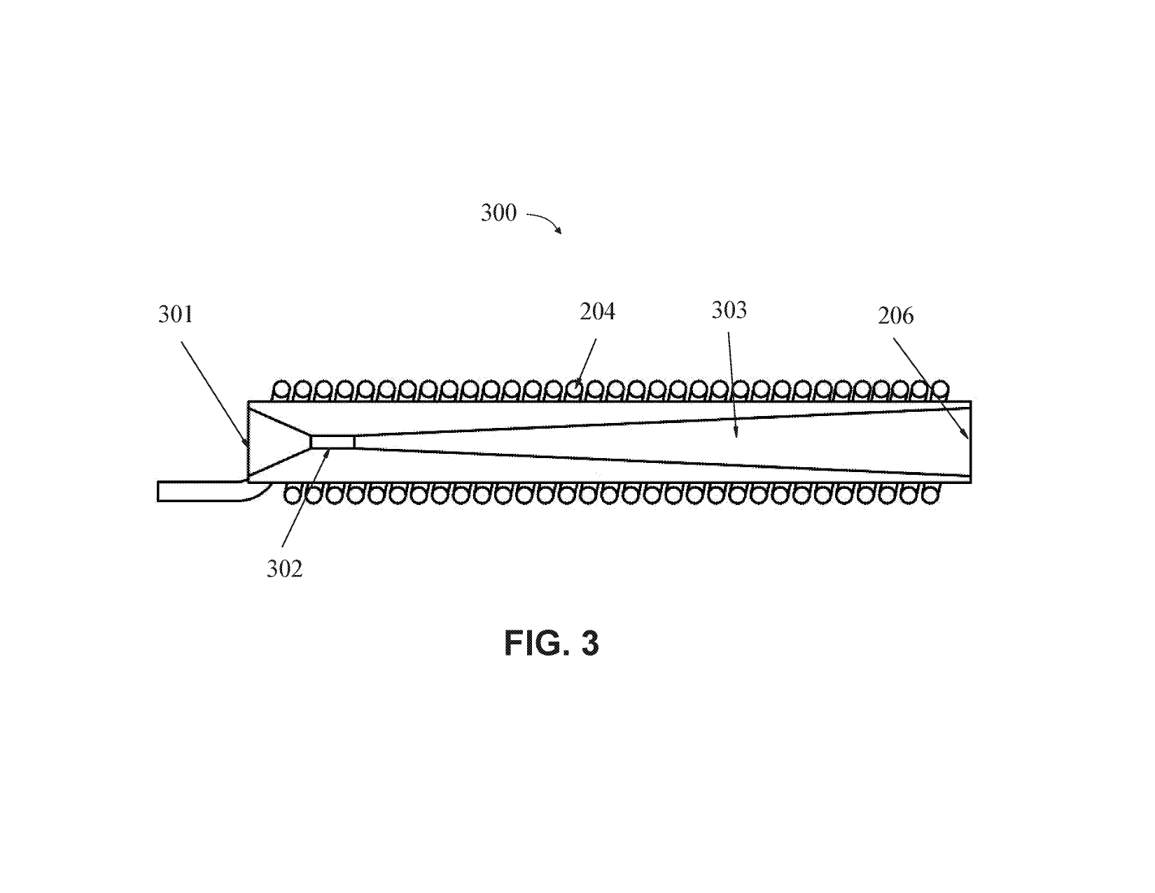

The EMF emitter 204 may be configured to heat the feedstock over any length which is effective for increasing the kinetic energy of the feedstock. In some embodiments, the EMF emitter 204 is positioned around the entire length of the pipe. In some embodiments, the EMF emitter 204 is placed around a portion of the size of the pipe. In some embodiments, the EMF emitter 204 is placed around the entire length of the smooth bore barrel. In some embodiments, the EMF emitter 204 is placed around a portion of the length of the smooth bore barrel. FIG. 3 depicts an illustrative diagram of an EMF emitter 204 positioned around a spray nozzle 206. In some embodiments, the EMF emitter 204 is placed around a portion of the size of the spray nozzle 206. In some embodiments, the EMF emitter 204 is placed around the entire length of the spray nozzle 206. In some embodiments, the EMF emitter 204 is positioned around a converging region 301 of the spray nozzle 206. As used in this disclosure, “converging region” is a portion of a spray nozzle having a decreasing cross-sectional flow area along a flow direction toward a throat. In a non-limiting example, the converging region 301 is configured to compress and accelerate a carrier fluid prior to the carrier fluid reaching the throat of a de Laval nozzle. In a non-limiting example, the converging region 301 is positioned upstream of a stagnation region 302 and a diverging region 303 within the spray nozzle. In a non-limiting example, an EMF emitter is positioned around the converging region to couple electromagnetic energy into a region through which feedstock passes prior to further acceleration downstream. In some embodiments, the EMF emitter 204 is positioned around a stagnation region 302 of the spray nozzle 206. As used in this disclosure, “stagnation region” is a region of a spray nozzle in which a flowing carrier fluid experiences a localized reduction in velocity and an increase in static pressure relative to an adjacent flow region. In a non-limiting example, the stagnation region 302 is located at or near a throat or transition portion of a nozzle where flow conditions change between upstream and downstream sections. In a non-limiting example, the stagnation region 302 is associated with a stagnation point or a local recirculation zone within the nozzle geometry. In a non-limiting example, an EMF emitter is positioned around the stagnation region 302 to couple electromagnetic energy into feedstock while limiting thermal loading of downstream nozzle portions. In some embodiments, the EMF emitter 204 is positioned around a diverging region 303 of the spray nozzle 206. As used in this disclosure, “diverging region” is a portion of a spray nozzle having an increasing cross-sectional flow area. Without limitation, the diverging region 303 may have an increasing cross-sectional flow area along a flow direction downstream of a throat. In a non-limiting example, the diverging region 303 may be configured to expand and accelerate a compressible carrier fluid to increase exit velocity and propel feedstock toward a substrate. In a non-limiting example, the diverging region 303 is positioned downstream of a converging region and a throat of a de Laval nozzle. In a non-limiting example, an EMF emitter is positioned around the diverging region to couple electromagnetic energy into feedstock particles as the particles travel toward an exit of the spray nozzle.

In some embodiments, the system further comprises a power supply. In some embodiments, the power supply is operably connected to the EMF emitter 204 and is configured to control the power and frequency of the EMF emitter 204. The power supply is configured to maintain the resonance frequency of the EMF emitter 204. In some embodiments, the power supply is configured to maintain a resonance frequency of about 500 MHz, about 550 MHz, about 600 MHz, about 650 MHz, about 700 MHz, about 750 MHz, about 800 MHz, about 850 MHz, about 900 MHz, about 850 MHz, about 900 MHz, about 950 MHz, about 1,000 MHz, about 1,100 MHz, about 1,200 MHz, about 1,300 MHz, about 1,400 MHz, about 1,500 MHz, about 1,600 MHz, about 1,700 MHz, about 1,800 MHz, about 1,900 MHz, about 2,000 MHz, about 2,500 MHz, about 3,000 MHz, about 3,500 MHz, about 4,000 MHz, about 4,500 MHz, about 5,000 MHz, about 5,500 MHz, about 6,000 MHz, or any value between any two of these values.

In some embodiments, the thermal spray system further comprises one or more temperature sensors. In some embodiments, one or more temperature sensors are configured to measure the temperature of the feedstock as the feedstock is deposited on the substrate. In some embodiments, one or more temperature sensors are configured to measure the temperature of the feedstock before the feedstock is deposited on the substrate. In some embodiments, one or more temperature sensors are positioned within the pipe. In some embodiments, one or more temperature sensors are positioned outside the pipe. In some embodiments, the thermal spray system further comprises at least one processing device. In some embodiments, the one or more temperature sensors are configured to transmit temperature measurements to at least one processing device. Each of the one or more temperature sensors may be configured to transmit temperature measurements to a display device by a wired or wireless connection, such as through a network, Wi-Fi, or Bluetooth connection. In some embodiments, at least one processing device is operable and connected to the power supply. In some embodiments, at least one processing device is configured to control the resonance frequency output of the power supply.

The substrate may comprise any material effective for the directed energy deposition of a feedstock. In some embodiments, the substrate includes one or more of aluminum, steel, iron, copper, nickel, titanium, Al₂O₃, and SiC.

The system may be configured to increase the kinetic energy of any powder that is effective for directed energy deposition. In some embodiments, the system is configured to increase the kinetic energy of a powder comprising one or more aluminum, steel, iron, copper, nickel, titanium, Al¬2O¬3, and SiC.

In some embodiments, the feedstock is a powder. In some embodiments, the thermal spray system may be configured to increase the kinetic energy of any size powder, which is effective for directed energy deposition. In some embodiments, the thermal spray system is configured to increase the kinetic energy of a powder with an average particle size of about 0.1 nm, about 1 nm, about 5 nm, about 10 nm, about 20 nm, about 30 nm, about 40 nm, about 50 nm, about 60 nm, about 70 nm, about 80 nm, about 90 nm, about 100 nm, about 125 nm, 150 nm, about 175 nm, about 200 nm, about 225 nm, about 250 nm, about 275 nm, about 300 nm, about 325 nm, about 350 nm, about 375 nm, about 400 nm, about 425 nm, about 450 nm, about 475 nm, about 500 nm, about 550 nm, about 600 nm, about 650 nm, about 700 nm, about 750 nm, about 800 nm, about 850 nm, about 900 nm, about 950 nm, about 1 µm, about 2 µm, about 3 µm, about 4 µm, about 5 µm, about 10 µm, about 15 µm, about 20 µm, about 25 µm, about 30 µm, about 35 µm, about 40 µm, about 45 µm, about 50 µm, about 55 µm, about 60 µm, about 65 µm, about 70 µm, about 75 µm, about 80 µm, about 85 µm, about 90 µm, about 95 µm, about 100 µm, about 105 µm, about 110 µm, about 115 µm, about 120 µm, about 125 µm, about 130 µm, about 135 µm, about 140 µm, about 145 µm, about 150 µm, about 155 µm, about 160 µm, about 165 µm, about 170 µm, about 175 µm, about 180 µm, about 185 µm, about 190 µm, about 195 µm, about 200 µm, or any value between any two of these values. In some embodiments, the powder has an average particle size of about 0.1 nm to about 200 µm, about 500 nm to about 100 µm, or about 1 µm to about 60 µm.

The thermal spray system may be configured to increase the kinetic energy of any powder shape which is effective for directed energy deposition. In some embodiments, the thermal spray system is configured to increase the kinetic energy of a powder with one or more of a spherical shape, a globular shape, an angular shape, a plate shape, a flake shape, or a cylindrical shape.

In some embodiments, the thermal spray system further comprises a thickness sensor configured to measure the thickness of the deposited feedstock. In some embodiments, the thickness sensor is configured to display the thickness of the deposited feedstock to a user.

FIG. 2B depicts an illustrative feedstock deposition system comprising an electromagnetic field (EMF) emitter 204 wherein the EMF emitter 204 is a pair of parallel plates. The pair of parallel plates may be configured to heat the feedstock over any length which is effective for increasing the kinetic energy of the feedstock. In some embodiments, the pair of parallel plates is positioned around the entire length of a pipe comprising one or more of the spray nozzle 206 and a smooth bore barrel. In some embodiments, the pair of parallel plates is placed around a portion of the size of the pipe. In some embodiments, the pair of parallel plates is placed around the entire length of the smooth bore barrel. In some embodiments, the pair of parallel plates is placed around a portion of the length of the smooth bore barrel. In some embodiments, the pair of parallel plates is placed around a portion of the size of the spray nozzle 206. In some embodiments, the pair of parallel plates is placed around the entire length of the spray nozzle 206. In some embodiments, the pair of parallel plates is positioned around a converging region of the spray nozzle 206. In some embodiments, the pair of parallel plates is positioned around a stagnation region of the spray nozzle 206. In some embodiments, the EMF emitter 204 is positioned around a diverging region of the spray nozzle 206.

FIG. 2C depicts an illustrative feedstock deposition system comprising an electromagnetic field (EMF) emitter 204 wherein the EMF emitter 204 is a point source emitter. The point source emitter may be configured to heat the feedstock at any point which is effective for increasing the kinetic energy of the feedstock. In some embodiments, the point source emitter is configured to heat the feedstock at one of a point in the feedstock delivery device, a point before the spray nozzle 206, at a point in the converging region of the spray nozzle 206, at a point in the stagnation region of the spray nozzle 206, at a point in the diverging region of the spray nozzle 206, or a point after the spray nozzle 206. In some embodiments, the thermal spray system comprises a smooth bore barrel, and the point source emitter is configured to heat the feedstock at a point in the smooth bore barrel.

In some embodiments, the system further comprises a case 209. In a non-limiting example, the case 209 may include one or more openings or interfaces configured to receive one or more coaxial connectors to allow the EMF emitter to connect to a power supply. In a non-limiting example, the case 209 may be securely attached to the EMF emitter to retain the EMF emitter around the spray nozzle during operation. In a non-limiting example, the case 209 encloses the EMF emitter and at least a portion of the spray nozzle to provide positional retention and a controlled local environment around the emitter region. In some embodiments, the case 209 comprises one or more coaxial connectors 201 configured to allow the EMF emitter 204 to connect to a power supply. In some embodiments, the case 209 is securely attached to the EMF emitter 204. In some embodiments, the case 209 is configured to maintain the position of the EMF emitter 204 around the spray nozzle 206. In some embodiments, the case 209 may be securely connected to the EMF emitter 204 by any means known to one of skill in the art. In some embodiments, the case 209 is securely connected to the EMF emitter 204 by one or more of bolts, fasteners, nails, screws, rivets, adhesives, clamps, or any combination of the above. In some embodiments, the case 209 encloses the EMF emitter 204 and the spray nozzle 206.

In some embodiments, the case 209 and the EMF emitter 204 are configured to be placed around the spray nozzle 206 before use and removed from the spray nozzle 206 after use. In some embodiments, the case 209 and the EMF emitter 204 may be placed around the spray nozzle 206 by any means known to one of skill in the art. In some embodiments, the case 209 and the EMF emitter 204 act as a sleeve and are configured to slide over the spray nozzle 206. In some embodiments, the case 209 and the EMF emitter 204 act as a clamshell and are configured to be enclosed around the spray nozzle 206. In some embodiments, the case 209 and EMF emitter 204 comprise multiple parts, which are configured to be assembled around the spray nozzle 206. In some embodiments, the case 209 comprises a Farraday cage 207 positioned around the EMF emitter 204 and configured to prevent the electromagnetic field from exiting the thermal spray system. As used in this disclosure, “Faraday cage” is an electrically conductive shielding structure configured to attenuate electromagnetic field emission from an enclosed region. In a non-limiting example, the Faraday cage 207 is positioned around an EMF emitter 204 within a case to reduce electromagnetic field leakage from the thermal spray system. In a non-limiting example, the Faraday cage 207 is implemented as a conductive mesh, foil, or enclosure that is electrically continuous around at least a portion of the EMF emitter 204. In a non-limiting example, the Faraday cage 207 is integrated with, or mounted within, the case 209 while the case is also configured to provide thermal insulation relative to a surrounding environment. In some embodiments, the case 209 is configured to thermally insulate the thermal spray system from the surrounding environment.

In some embodiments, the thermal spray system further comprises a cooling chamber. In some embodiments, the cooling chamber is configured to receive cooling fluid from the one or more cooling channels 208 to cool the thermal spray system. As used in this disclosure, “cooling channels” are one or more fluid passages configured to convey a cooling fluid to control a temperature of at least a portion of a system. In a non-limiting example, the cooling channels 208 may be formed within, attached to, or integrated with a case, an attachment device, and/or an EMF emitter assembly. In a non-limiting example, the cooling channels 208 may be fluidly coupled to a coolant inlet and a coolant outlet to circulate the cooling fluid through the system. In a non-limiting example, the cooling channels 208 are arranged proximate to heat-generating components to remove heat and reduce thermal loading during operation. In some embodiments, the cooling chamber is an area between the inner diameter of the case 209 and the outer diameter of the spray nozzle 206.

Methods can be assembled for depositing powder materials using the above-described systems.

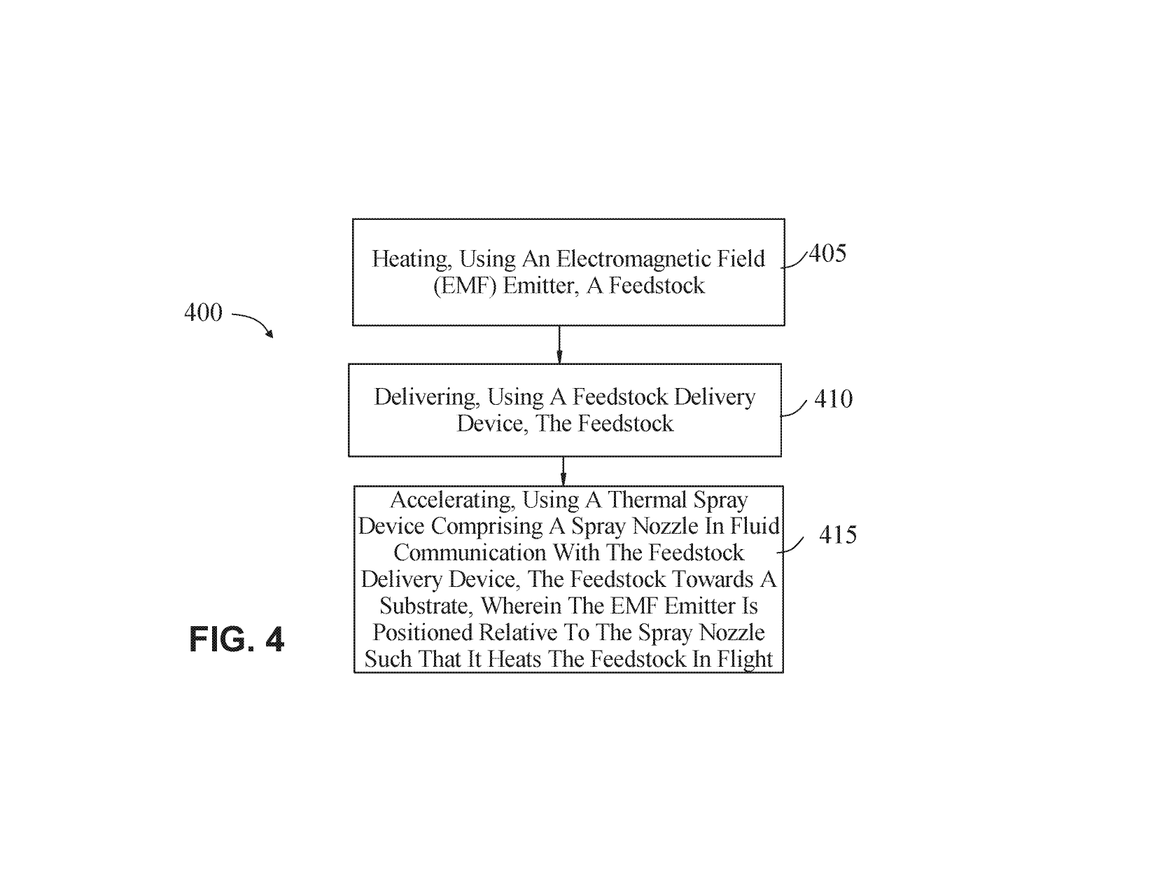

FIG. 4 depicts a diagram of a method for depositing feedstock materials. The method comprises heating 405, using an electromagnetic field (EMF) emitter, a feedstock. The spray nozzle may be any nozzle that is effective for accelerating a feedstock. In some embodiments, the spray nozzle is a de Laval nozzle.

The feedstock may be any material that is effective for directed energy deposition. In some embodiments, the powder comprises one or more aluminum, steel, iron, copper, nickel, titanium, Al¬2O¬3, and SiC. In some embodiments, the feedstock is one of a powder or a wire.

In some embodiments, the feedstock is a powder. The powder may be any size that is effective for directed energy deposition. In some embodiments, the powder has an average particle size of about 0.1 nm, about 1 nm, about 5 nm, about 10 nm, about 20 nm, about 30 nm, about 40 nm, about 50 nm, about 60 nm, about 70 nm, about 80 nm, about 90 nm, about 100 nm, about 125 nm, 150 nm, about 175 nm, about 200 nm, about 225 nm, about 250 nm, about 275 nm, about 300 nm, about 325 nm, about 350 nm, about 375 nm, about 400 nm, about 425 nm, about 450 nm, about 475 nm, about 500 nm, about 550 nm, about 600 nm, about 650 nm, about 700 nm, about 750 nm, about 800 nm, about 850 nm, about 900 nm, about 950 nm, about 1 µm, about 2 µm, about 3 µm, about 4 µm, about 5 µm, about 10 µm, about 15 µm, about 20 µm, about 25 µm, about 30 µm, about 35 µm, about 40 µm, about 45 µm, about 50 µm, about 55 µm, about 60 µm, about 65 µm, about 70 µm, about 75 µm, about 80 µm, about 85 µm, about 90 µm, about 95 µm, about 100 µm, about 105 µm, about 110 µm, about 115 µm, about 120 µm, about 125 µm, about 130 µm, about 135 µm, about 140 µm, about 145 µm, about 150 µm, about 155 µm, about 160 µm, about 165 µm, about 170 µm, about 175 µm, about 180 µm, about 185 µm, about 190 µm, about 195 µm, about 200 µm, or any value between any two of these values. In some embodiments, the powder has an average particle size of about 0.1 nm to about 200 µm, about 500 nm to about 100 µm, or about 1 µm to about 60 µm.

The powder may have any shape that is effective for directed energy deposition. In some embodiments, the powder comprises one or more of a spherical shape, a globular shape, an angular shape, a plate shape, a flake shape, or a cylindrical shape. The carrier fluid may be any fluid that is effective for the directed energy deposition of a powder. In some embodiments, the carrier fluid comprises one or more of nitrogen, helium, neon, argon, krypton, xenon, radon, IPA, and air. In some embodiments, the carrier fluid is selected to achieve a predetermined particle velocity of the feedstock.

The EMF emitter may comprise any device effective for generating an electromagnetic field known to one of skill in the art. In some embodiments, the EMF emitter comprises one of a point source emitter, an induction coil, a pair of parallel plates, at least two parallel bars, or a tube.

The method further comprises delivering 410, using a feedstock delivery device, the feedstock. The method further comprises accelerating 415 the feedstock through the spray nozzle. In some embodiments, accelerating 415, using a thermal spray device comprising a spray nozzle in fluid communication with the feedstock delivery device, the feedstock towards a substrate, wherein the EMF emitter is positioned relative to the spray nozzle such that it heats the feedstock in flight. In some embodiments, feedstock is accelerated 415 at a predetermined temperature, a predetermined pressure, and with a carrier fluid selected to achieve a predetermined particle velocity. The predetermined particle velocity may be any velocity effective for directed energy deposition. In some embodiments, the predetermined velocity is about 150 m/s, about 200 m/s, about 250 m/s, about 300 m/s, about 350 m/s, about 400 m/s, about 450 m/s, about 500 m/s, about 550 m/s, about 600 m/s, about 650 m/s, about 700 m/s, about 750 m/s, about 800 m/s, about 850 m/s, about 900 m/s, about 950 m/s, about 1000 m/s, about 1050 m/s, about 1100 m/s, about 1150 m/s, about 1200 m/s, about 1250 m/s, about 1300 m/s, about 1350 m/s, about 1400 m/s, about 1450 m/s, about 1500 m/s, about 1550 m/s, about 1600 m/s, about 1650 m/s, about 1700 m/s, about 1750 m/s, about 1800 m/s, about 1850 m/s, about 1900 m/s, about 1950 m/s, about 2000 m/s, or any value between any two of these values. In some embodiments, the predetermined velocity is about 150 m/s to about 2,000 m/s.

The feedstock may be accelerated 415 at any pressure effective to achieve the predetermined velocity. In some embodiments, the feedstock is accelerated 415 with a pressure of about 80 psi, about 85 psi, about 90 psi, about 95 psi, about 100 psi, about 105 psi, about 110 psi, about 115 psi, about 120 psi, about 125 psi, about 130 psi, about 135 psi, about 140 psi, about 145 psi, about 150 psi, about 155 psi, about 160 psi, about 165 psi, about 170 psi, about 175 psi, about 180 psi, about 185 psi, about 190 psi, about 195 psi, about 200 psi, about 210 psi, about 220 psi, about 230 psi, about 240 psi, about 250 psi, about 260 psi, about 270 psi, about 280 psi, about 290 psi, about 300 psi, about 310 psi, about 320 psi, about 330 psi, about 340 psi, about 350 psi, about 360 psi, about 370 psi, about 380 psi, about 390 psi, about 400 psi, about 410 psi, about 420 psi, about 430 psi, about 440 psi, about 450 psi, about 460 psi, about 470 psi, about 480 psi, about 490 psi, about 500 psi, about 510 psi, about 520 psi, about 530 psi, about 540 psi, about 550 psi, about 560 psi, about 570 psi, about 580 psi, about 590 psi, about 600 psi, about 650 psi, about700 psi, about 750 psi, about 800 psi, about 850 psi, about 900 psi, about 950 psi, about 1,000 psi, about 1,050 psi, about 1,100 psi, about 1,150 psi, about 1,200 psi, about 1250 psi, about 1,300 psi, or any value between any two of these values. In some embodiments, the feedstock is accelerated 415 with a pressure of about 80 psi to about 1,300 psi, about 100 psi to about 1,000 psi, or about 400 psi to about 700 psi.

The feedstock may be accelerated 415 at any temperature effective to achieve the predetermined velocity. In some embodiments, the feedstock is accelerated 415 at a temperature of about 10 °C, about 11 °C, about 12 °C, about 13 °C, about 14 °C, about 15 °C, about 16 °C, about 17 °C, about 18 °C, about 19 °C, about 20 °C, about 25 °C, about 30 °C, about 35 °C, about 40 °C, about 45 °C, about 50 °C, about 55 °C, about 60 °C, about 65 °C, about 70 °C, about 75 °C, about 80 °C, about 85 °C, about 90 °C, about 95 °C, about 100 °C, about 105 °C, about 110 °C, about 115 °C, about 120 °C, about 125 °C, about 130 °C, about 135 °C, about 140 °C, about 145 °C, about 150 °C, about 155 °C, about 160 °C, about 165 °C, about 170 °C, about 175 °C, about 180 °C, about 185 °C, about 190 °C, about 195 °C, about 200 °C, about 210 °C, about 220 °C, about 230 °C, about 240 °C, about 250 °C, about 260 °C, about 270 °C, about 280 °C, about 290 °C, about 300 °C, about 310 °C, about 320 °C, about 330 °C, about 340 °C, about 350 °C, about 360 °C, about 370 °C, about 380 °C, about 390 °C, about 400 °C, about 410 °C, about 420 °C, about 430 °C, about 440 °C, about 450 °C, about 460 °C, about 470 °C, about 480 °C, about 490 °C, about 500 °C, about 510 °C, about 520 °C, about 530 °C, about 540 °C, about 550 °C, about 560 °C, about 570 °C, about 580 °C, about 590 °C, about 600 °C, about 700 °C, about 800 °C, about 900 °C, about 1,000 °C, about 1,100 °C, about 1,200 °C, or any value between any two of these values. In some embodiments, the feedstock is accelerated 415 at a temperature selected based on the feedstock material. In some embodiments, the feedstock is accelerated 415 at a temperature of about two-thirds of the melting point of the feedstock to a temperature less than the melting point of the feedstock.

The method further comprises heating 404 the feedstock using the EMF emitter. In some embodiments, heating 404 the powder consists of heating 404 the feedstock throughout the entire length of the spray nozzle. In some embodiments, heating 404 the feedstock consists of heating 404 the feedstock throughout a portion of the spray nozzle. The EMF emitter may heat 404 the feedstock to any temperature effective for the directed energy deposition of the feedstock. In some embodiments, the EMF emitter heats 404 the powder to about 25 °C, about 30 °C, about 35 °C, about 40 °C, about 45 °C, about 50 °C, about 55 °C, about 60 °C, about 65 °C, about 70 °C, about 75 °C, about 80 °C, about 85 °C, about 90 °C, about 95 °C, about 100 °C, about 105 °C, about 110 °C, about 115 °C, about 120 °C, about 125 °C, about 130 °C, about 135 °C, about 140 °C, about 145 °C, about 150 °C, about 155 °C, about 160 °C, about 165 °C, about 170 °C, about 175 °C, about 180 °C, about 185 °C, about 190 °C, about 195 °C, about 200 °C, about 210 °C, about 220 °C, about 230 °C, about 240 °C, about 250 °C, about 260 °C, about 270 °C, about 280 °C, about 290 °C, about 300 °C, about 310 °C, about 320 °C, about 330 °C, about 340 °C, about 350 °C, about 360 °C, about 370 °C, about 380 °C, about 390 °C, about 400 °C, about 410 °C, about 420 °C, about 430 °C, about 440 °C, about 450 °C, about 460 °C, about 470 °C, about 480 °C, about 490 °C, about 500 °C, about 510 °C, about 520 °C, about 530 °C, about 540 °C, about 550 °C, about 560 °C, about 570 °C, about 580 °C, about 590 °C, about 600 °C, about 700 °C, about 800 °C, about 900 °C, about 1,000 °C, about 1,100 °C, about 1,200 °C, or any value between any two of these values. In some embodiments, the EMF emitter heats 404 the feedstock to a temperature selected based on the feedstock material. In some embodiments, the EMF emitter heats 404 the feedstock to a temperature of about two-thirds of the melting point of the feedstock to a temperature less than the melting point of the feedstock.

In some embodiments, the method further comprises maintaining the resonance frequency of the EMF emitter. In some embodiments, the resonance frequency of the EMF emitter is kept at a value effective for the direct energy deposition of the feedstock. In some embodiments, the resonance frequency of the induction coil is maintained at about 500 MHz, about 550 MHz, about 600 MHz, about 650 MHz, about 700 MHz, about 750 MHz, about 800 MHz, about 850 MHz, about 900 MHz, about 850 MHz, about 900 MHz, about 950 MHz, about 1,000 MHz, about 1,100 MHz, about 1,200 MHz, about 1,300 MHz, about 1,400 MHz, about 1,500 MHz, about 1,600 MHz, about 1,700 MHz, about 1,800 MHz, about 1,900 MHz, about 2,000 MHz, about 2,500 MHz, about 3,000 MHz, about 3,500 MHz, about 4,000 MHz, about 4,500 MHz, about 5,000 MHz, about 5,500 MHz, about 6,000 MHz, or any value between any two of these values. In some embodiments, the resonance frequency of the induction coil is maintained at about 500 MHz to about 6,000 MHz, about 1,000 MHz to about 4,000 MHz, or about 2,000 MHz to about 3,000 MHz. In some embodiments, the method further comprises providing a power supply configured to maintain the resonance frequency of the induction coil.

The method further comprises depositing 405 the feedstock on the substrate. In some embodiments, depositing 405 of the feedstock consists of creating a coating of the feedstock material on the substrate. The feedstock may be deposited 405 on the substrate at any thickness effective for cosmetic repairs, additive manufacturing, and quasi-structural repairs. In some embodiments, the feedstock is deposited 405 on the substrate at a thickness of about 0.1 nm, about 1 nm, about 5 nm, about 10 nm, about 20 nm, about 30 nm, about 40 nm, about 50 nm, about 60 nm, about 70 nm, about 80 nm, about 90 nm, about 100 nm, about 125 nm, 150 nm, about 175 nm, about 200 nm, about 225 nm, about 250 nm, about 275 nm, about 300 nm, about 325 nm, about 350 nm, about 375 nm, about 400 nm, about 425 nm, about 450 nm, about 475 nm, about 500 nm, about 550 nm, about 600 nm, about 650 nm, about 700 nm, about 750 nm, about 800 nm, about 850 nm, about 900 nm, about 950 nm, about 1 µm, about 2 µm, about 3 µm, about 4 µm, about 5 µm, about 10 µm, about 15 µm, about 20 µm, about 25 µm, about 30 µm, about 35 µm, about 40 µm, about 45 µm, about 50 µm, about 55 µm, about 60 µm, about 65 µm, about 70 µm, about 75 µm, about 80 µm, about 85 µm, about 90 µm, about 95 µm, about 100 µm, about 105 µm, about 110 µm, about 115 µm, about 120 µm, about 125 µm, about 130 µm, about 135 µm, about 140 µm, about 145 µm, about 150 µm, about 155 µm, about 160 µm, about 165 µm, about 170 µm, about 175 µm, about 180 µm, about 185 µm, about 190 µm, about 195 µm, about 200 µm, or any value between any two of these values. In some embodiments, the powder has an average particle size of about 0.1 nm to about 200 µm, about 500 nm to about 100 µm, or about 1 µm to about 60 µm, about 250 µm, about 300 µm, about 350 µm, about 400 µm, about 450 µm, about 500 µm, about 550 µm, about 600 µm, about 650 µm, about 700 µm, about 750 µm, about 800 µm, about 850 µm, about 900 µm, about 950 µm, about 1,000 µm, about 5 mm, about 10 mm, about 15 mm, about 20 mm, about 25 mm, about 30 mm, about 35 mm, about 40 mm, about 45 mm, about 50 mm, about 100 mm, about 150 mm, about 200 mm, about 250 mm, about 300 mm, about 350 mm, about 400 mm, about 450 mm, about 500 mm, about 550 mm, about 600 mm, about 650 mm, about 700 mm, about 750 mm, about 800 mm, about 850 mm, about 900 mm, about 950 mm, about 1,000 mm, about 1,100 mm, about 1,200 mm, about 1,300 mm, about 1,400 mm, about 1,500 mm, about 1,600 mm, about 1,700 mm, about 1,800 mm, about 1,900 mm, about 2,000 mm, about 2,500 mm, about 3,000 mm, 3,500 mm, about 4,000 mm, about 4,500 mm, about 5,000 mm, about 5,500 mm, about 6,000 mm, about 6,500 mm, about 7,000 mm, about 7,500 mm, about 8,000 mm, about 8,500 mm, about 9,000 mm, about 9,500 mm, about 10,000 mm, or any value between any two of these values. In some embodiments, the powder is deposited 405 on the substrate at a thickness of about 10 µm to about 40 µm, about 1 mm to about 10 mm, or about 500 mm to about 10 m.

The substrate may be any material that is effective for receiving directed energy deposition. In some embodiments, the substrate comprises one or more aluminum, steel, iron, copper, nickel, titanium Al¬2O¬3, and SiC.

In some embodiments, the method further comprises providing one or more cooling channels and cooling the spray nozzle using a cooling fluid. The cooling fluid may be effective in decreasing the temperature of the spray nozzle. In some embodiments, the cooling fluid is one or more water, air, or an inert gas.

In some embodiments, the method further comprises providing a case and enclosing the spray nozzle and the EMF emitter within the case. In some embodiments, the EMF emitter is securely fastened to the case. In some embodiments, the case is securely fastened to the EMF emitter by one or more of bolts, fasteners, nails, screws, rivets, adhesives, clamps, or any combination of the above. In some embodiments, the method further comprises placing the case and the EMF emitter around the spray nozzle. In some embodiments, the case and the EMF emitter act as one of a sleeve, a clamshell, or multiple parts encasing the spray nozzle. In some embodiments, the method further comprises removing the case and the EMF emitter from around the spray nozzle.

In some embodiments, the method further comprises preheating the feedstock and the carrier fluid before spraying 415 the feedstock through the spray nozzle. The feedstock and carrier fluid may be preheated to any temperature that is effective for the directed energy deposition of the feedstock. In some embodiments, the feedstock and carrier fluid are preheated to about 25 °C, about 30 °C, about 35 °C, about 40 °C, about 45 °C, about 50 °C, about 55 °C, about 60 °C, about 65 °C, about 70 °C, about 75 °C, about 80 °C, about 85 °C, about 90 °C, about 95 °C, about 100 °C, about 105 °C, about 110 °C, about 115 °C, about 120 °C, about 125 °C, about 130 °C, about 135 °C, about 140 °C, about 145 °C, about 150 °C, about 155 °C, about 160 °C, about 165 °C, about 170 °C, about 175 °C, about 180 °C, about 185 °C, about 190 °C, about 195 °C, about 200 °C, about 210 °C, about 220 °C, about 230 °C, about 240 °C, about 250 °C, about 260 °C, about 270 °C, about 280 °C, about 290 °C, about 300 °C, about 310 °C, about 320 °C, about 330 °C, about 340 °C, about 350 °C, about 360 °C, about 370 °C, about 380 °C, about 390 °C, about 400 °C, about 410 °C, about 420 °C, about 430 °C, about 440 °C, about 450 °C, about 460 °C, about 470 °C, about 480 °C, about 490 °C, about 500 °C, about 510 °C, about 520 °C, about 530 °C, about 540 °C, about 550 °C, about 560 °C, about 570 °C, about 580 °C, about 590 °C, about 600 °C, or any value between any two of these values. In some embodiments, the powder and carrier fluid are preheated to about 10 °C to about 700 °C or about 400 °C to about 500 °C.

In some embodiments, the method further comprises providing at least one temperature sensor and measuring temperature data of the feedstock using at least one temperature sensor after the feedstock is deposited 405 on the substrate. In some embodiments, the method further comprises providing at least one temperature sensor and measuring temperature data of the feedstock using at least one temperature sensor just before the feedstock is deposited 405 on the substrate. In some embodiments, the method comprises adjusting the resonance frequency of the EMF emitter based on the temperature data. In some embodiments, the resonance frequency of the EMF emitter is adjusted to maintain the temperature of the feedstock within a known tolerance. In some embodiments, the temperature of the feedstock is maintained within a tolerance of about 1.0 °C, about 1.1 °C, about 1.2 °C, about 1.3 °C, about 1.4 °C, about 1.5 °C, about 1.6 °C, about 1.7 °C, about 1.8 °C, about 1.9 °C, about 2.0 °C, about 2.1 °C, about 2.2 °C, about 2.3 °C, about 2.4 °C, about 2.5 °C, about 2.6 °C, about 2.7 °C, about 2.8 °C, about 2.9 °C, about 3.0 °C, about 3.1 °C, about 3.2 °C, about 3.3 °C, about 3.4 °C, about 3.5 °C, about 3.6 °C, about 3.7 °C, about 3.8 °C, about 3.9 °C, about 4.0 °C, about 4.1 °C, about 4.2 °C, about 4.3 °C, about 4.4 °C, about 4.5 °C, about 4.6 °C, about 4.7 °C, about 4.8 °C, about 4.9 °C, about 5.0 °C, about 6.0 °C, about 7.0 °C, about 8.0 °C, about 9.0 °C, about 10.0°C, or any value between any two of these values.

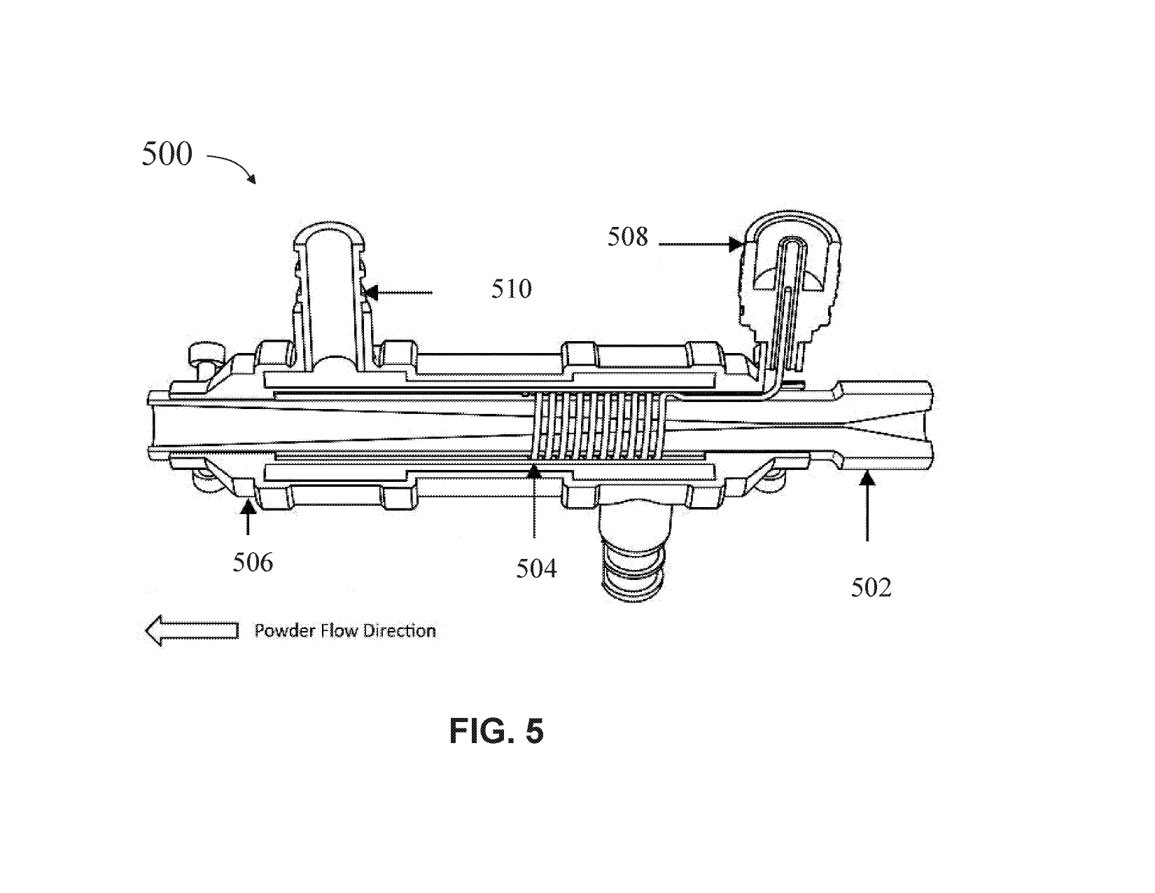

Referring now to FIG. 5, an exemplary embodiment of system 500 for electromagnetic field assisted cold spray processing is illustrated. System 500 may include a processor communicatively connected to a memory. As used in this disclosure, “communicatively connected” means connected by way of a connection, attachment, or linkage between two or more relata which allows for reception and/or transmittance of information therebetween. For example, and without limitation, this connection may be wired or wireless, direct or indirect, and between two or more components, circuits, devices, systems, and the like, which allows for reception and/or transmittance of data and/or signal(s) therebetween. Data and/or signals there between may include, without limitation, electrical, electromagnetic, magnetic, video, audio, radio and microwave data and/or signals, combinations thereof, and the like, among others. A communicative connection may be achieved, for example and without limitation, through wired or wireless electronic, digital or analog, communication, either directly or by way of one or more intervening devices or components. Further, communicative connection may include electrically coupling or connecting at least an output of one device, component, or circuit to at least an input of another device, component, or circuit. For example, and without limitation, via a bus or other facility for intercommunication between elements of a computing device. Communicative connecting may also include indirect connections via, for example and without limitation, wireless connection, radio communication, low power wide area network, optical communication, magnetic, capacitive, or optical coupling, and the like. In some instances, the terminology “communicatively coupled” may be used in place of communicatively connected in this disclosure.

With continued reference to FIG. 5, memory may include a primary memory and a secondary memory. “Primary memory” also known as “random access memory” (RAM) for the purposes of this disclosure is a short-term storage device in which information is processed. In one or more embodiments, during use of the computing device, instructions and/or information may be transmitted to primary memory wherein information may be processed. In one or more embodiments, information may only be populated within primary memory while a particular software is running. In one or more embodiments, information within primary memory is wiped and/or removed after the computing device has been turned off and/or use of a software has been terminated. In one or more embodiments, primary memory may be referred to as “Volatile memory” wherein the volatile memory only holds information while data is being used and/or processed. In one or more embodiments, volatile memory may lose information after a loss of power. “Secondary memory” also known as “storage,” “hard disk drive” and the like for the purposes of this disclosure is a long-term storage device in which an operating system and other information is stored. In one or remote embodiments, information may be retrieved from secondary memory and transmitted to primary memory during use. In one or more embodiments, secondary memory may be referred to as non-volatile memory wherein information is preserved even during a loss of power. In one or more embodiments, data within secondary memory cannot be accessed by processor. In one or more embodiments, data is transferred from secondary to primary memory wherein processor may access the information from primary memory.

Still referring to FIG. 5, system 500 may include a database. The database may include a remote database. The database may be implemented, without limitation, as a relational database, a key-value retrieval database such as a NOSQL database, or any other format or structure for use as database that a person skilled in the art would recognize as suitable upon review of the entirety of this disclosure. The database may alternatively or additionally be implemented using a distributed data storage protocol and/or data structure, such as a distributed hash table or the like. The database may include a plurality of data entries and/or records as described above. Data entries in database may be flagged with or linked to one or more additional elements of information, which may be reflected in data entry cells and/or in linked tables such as tables related by one or more indices in a relational database. Persons skilled in the art, upon reviewing the entirety of this disclosure, will be aware of various ways in which data entries in database may store, retrieve, organize, and/or reflect data and/or records.

With continued reference to FIG. 5, system 500 may include and/or be communicatively connected to a server, such as but not limited to, a remote server, a cloud server, a network server and the like. In one or more embodiments, the computing device may be configured to transmit one or more processes to be executed by server. In one or more embodiments, server may contain additional and/or increased processor power wherein one or more processes as described below may be performed by server. For example, and without limitation, one or more processes associated with machine learning may be performed by network server, wherein data is transmitted to server, processed and transmitted back to computing device. In one or more embodiments, server may be configured to perform one or more processes as described below to allow for increased computational power and/or decreased power usage by the system computing device. In one or more embodiments, computing device may transmit processes to server wherein computing device may conserve power or energy.

Further referring to FIG. 5, system 500 may include any “computing device” as described in this disclosure, including without limitation a microcontroller, microprocessor, digital signal processor (DSP) and/or system on a chip (SoC) as described in this disclosure. System 500 may include, be included in, and/or communicate with a mobile device such as a mobile telephone or smartphone. System 500 may include a single computing device operating independently, or may include two or more computing devices operating in concert, in parallel, sequentially or the like; two or more computing devices may be included together in a single computing device or in two or more computing devices. System 500 may interface or communicate with one or more additional devices as described below in further detail via a network interface device. Network interface device may be utilized for connecting processor to one or more of a variety of networks, and one or more devices. Examples of a network interface device include, but are not limited to, a network interface card (e.g., a mobile network interface card, a LAN card), a modem, and any combination thereof. Examples of a network include, but are not limited to, a wide area network (e.g., the Internet, an enterprise network), a local area network (e.g., a network associated with an office, a building, a campus or other relatively small geographic space), a telephone network, a data network associated with a telephone/voice provider (e.g., a mobile communications provider data and/or voice network), a direct connection between two computing devices, and any combinations thereof. A network may employ a wired and/or a wireless mode of communication. In general, any network topology may be used. Information (e.g., data, software etc.) may be communicated to and/or from a computer and/or a computing device. Processor may include but is not limited to, for example, a computing device or cluster of computing devices in a first location and a second computing device or cluster of computing devices in a second location. System 500 may include one or more computing devices dedicated to data storage, security, distribution of traffic for load balancing, and the like. System 500 may distribute one or more computing tasks as described below across a plurality of computing devices of computing device, which may operate in parallel, in series, redundantly, or in any other manner used for distribution of tasks or memory between computing devices. System 500 may be implemented, as a non-limiting example, using a “shared nothing” architecture.

With continued reference to FIG. 5, processor may be designed and/or configured to perform any method, method step, or sequence of method steps in any embodiment described in this disclosure, in any order and with any degree of repetition. For instance, processor may be configured to perform a single step or sequence repeatedly until a desired or commanded outcome is achieved; repetition of a step or a sequence of steps may be performed iteratively and/or recursively using outputs of previous repetitions as inputs to subsequent repetitions, aggregating inputs and/or outputs of repetitions to produce an aggregate result, reduction or decrement of one or more variables such as global variables, and/or division of a larger processing task into a set of iteratively addressed smaller processing tasks. Processor may perform any step or sequence of steps as described in this disclosure in parallel, such as simultaneously and/or substantially simultaneously performing a step two or more times using two or more parallel threads, processor cores, or the like; division of tasks between parallel threads and/or processes may be performed according to any protocol suitable for division of tasks between iterations. Persons skilled in the art, upon reviewing the entirety of this disclosure, will be aware of various ways in which steps, sequences of steps, processing tasks, and/or data may be subdivided, shared, or otherwise dealt with using iteration, recursion, and/or parallel processing.

Referring now to FIG. 5, an illustration of a system 500 which includes a platform-agnostic solution for generating depositions that meet or exceed the performance of those produced using helium as a carrier gas. Without limitation, FIG. 5 illustrates a cross-sectional view of an electromagnetic field (EMF)-assisted cold spray system 500 in accordance with one or more embodiments. System 500 provides a platform-agnostic solution for generating depositions that meet or exceed performance characteristics of depositions produced using helium as a carrier gas. System 500 may enable deposition of materials traditionally suitable for helium-based cold spray processes, such as Aluminum 7075, Ti64, and Aeromet 100, without utilizing helium as a carrier gas. System 500 may reduce repair costs associated with helium-based cold spray operations. System 500 may integrate onto various cold spray platforms, allowing Department of Defense (DoD) service bureaus and the like to enhance existing systems and increase effectiveness in repairing equipment. In an embodiment, system 500 may include a polybenzimidazole (PBI) nozzle 502, an inductive coil 504, an electromagnetic interference (EMI) shielding jacket 506, a Bayonet Neill–Concelman (BNC) connection 508, and a cooling port 510. PBI nozzle 502 may define a flow path through which powder particles and carrier gas travel. PBI nozzle 502 may include a radio frequency (RF) transparent material that permits electromagnetic field penetration while maintaining structural integrity under cold spray operating conditions. In some examples, PBI nozzle 502 may include polybenzimidazole, a thermoplastic material that exhibits thermal stability and chemical resistance without exhibiting a defined melting point. In an embodiment, PBI nozzle 502 may include alternative RF transparent materials including silicon nitride, silicon oxynitride, niroxyceram, and the like. Inductive coil 504 may surround a portion of PBI nozzle 502 and generate an electromagnetic field when energized. Inductive coil 504 may include a plurality of conductive windings arranged circumferentially around PBI nozzle 502. Inductive coil 504 may operate at frequencies in a gigahertz (GHz) range and apply power levels measured in decibels relative to one milliwatt (dBm). In an embodiment, inductive coil 504 may operate at a frequency of 3.5 GHz and a power level of 7.0 dBm. Inductive coil 504 may induce eddy currents within powder particles flowing through PBI nozzle 502, causing resistive heating within the powder particles. The electromagnetic field generated by inductive coil 504 may selectively heat powder particles based on particle size, material composition, electromagnetic coupling characteristics, and the like. EMI shielding jacket 506 may surround inductive coil 504 and contain electromagnetic radiation generated by inductive coil 504. EMI shielding jacket 506 may prevent electromagnetic interference with external equipment and personnel. EMI shielding jacket 506 may include a conductive material that reflects or absorbs electromagnetic radiation. Without limitation, EMI shielding jacket 506 may include copper, aluminum, a conductive composite material, and the like. BNC connection 508 may provide electrical coupling between inductive coil 504 and an external RF signal generator. BNC connection 508 may transmit RF signals from the external RF signal generator to inductive coil 504. BNC connection 508 may include a coaxial connector that maintains signal integrity at GHz frequencies. Without limitation, BNC connection 508 may include a bayonet Neill-Concelman connector or an alternative RF connector suitable for GHz frequency transmission. Cooling port 510 may provide thermal management for inductive coil 504 and EMI shielding jacket 506. Cooling port 510 may receive a cooling fluid that removes heat generated by inductive coil 504 during operation. Without limitation, cooling port 510 may connect to a closed-loop cooling system that circulates water, glycol, or another cooling fluid through channels adjacent to inductive coil 504. Cooling port 510 may maintain inductive coil 504 and EMI shielding jacket 506 within an operating temperature range that prevents thermal degradation of components. Without limitation, powder particles may flow through PBI nozzle 502 in a direction indicated by an arrow labeled "Powder Flow Direction." The powder particles may enter PBI nozzle 502 at a first end and exit PBI nozzle 502 at a second end. As the powder particles traverse a region surrounded by inductive coil 504, the electromagnetic field generated by inductive coil 504 may couple with the powder particles and induce eddy currents within the powder particles. The eddy currents may generate resistive heating within the powder particles, increasing a temperature of the powder particles. The temperature increase may soften the powder particles, reducing a critical velocity required for bonding upon impact with a substrate. System 500 may operate with non-helium carrier gases including nitrogen (N₂) and compressed air. The electromagnetic field generated by inductive coil 504 may increase a total energy of powder particles before impact with a substrate. The increased total energy may result from internal thermal loading induced by the electromagnetic field rather than external thermal loading from a heated carrier gas. The internal thermal loading may reduce a critical velocity required for proper mechanical deformation of powder particles upon impact. System 500 may achieve deposition characteristics comparable to helium-based cold spray systems while operating at lower pressures and temperatures than helium-based systems. Without limitation, system 500 may operate at a pressure of 400 pounds per square inch (psi) and a temperature of 600 degrees Celsius (°C). In an embodiment, system 500 may operate at pressures ranging from 400 psi to 800 psi and temperatures ranging from 400°C to 800°C. System 500 may produce depositions with porosity levels below 1% when operating with non-helium carrier gases. Without limitation, system 500 may produce depositions of stainless steel 316 on an aluminum 6061-T651 substrate with a porosity of 2.2% when operating at 400 psi, 600°C, with a 3.5 GHz electromagnetic field at 7.0 dBm power level. System 500 may adapt to different powder materials by adjusting a frequency and power level of the electromagnetic field generated by inductive coil 504. Ferrous materials may exhibit different electromagnetic coupling characteristics than non-ferrous materials. System 500 may adjust the frequency and power level of inductive coil 504 based on a composition of powder particles to achieve a target temperature increase. Without limitation, system 500 operates at frequencies ranging from 100 megahertz (MHz) to 4 GHz and power levels ranging from 0 dBm to 50 dBm. System 500 may integrate onto existing cold spray platforms without requiring modifications to a primary cold spray apparatus. System 500 may include a modular accessory that attaches to a cold spray gun barrel. Without limitation, system 500 attaches to a VRC Gen III cold spray system. In an embodiment, system 500 may attach to a Titomic TKF-1000 cold spray system or a SPEE3D cold spray system. System 500 may provide a retrofit solution for existing cold spray equipment, enabling non-helium cold spray operations without replacing existing cold spray systems. System 500 may reduce operating costs associated with cold spray operations by eliminating a need for helium as a carrier gas. Helium costs exceed nitrogen costs by a factor of 1,000 in some markets. System 500 may eliminate a need for helium recovery systems, reducing capital equipment costs and facility space requirements. System 500 may enable portable cold spray operations in field environments where helium supply logistics present challenges. System 500 may produce depositions suitable for structural repair applications. Depositions produced by system 500 may exhibit mechanical properties including tensile strength, yield strength, elongation, hardness, and the like that meet or exceed properties of depositions produced by helium-based cold spray systems. Without limitation, depositions produced by system 500 may exhibit a bond line with 24.2% greater mixing between a deposition material and a substrate material compared to depositions produced without electromagnetic field assistance. System 500 may reduce microcracking in depositions compared to depositions produced without electromagnetic field assistance. System 500 may enable deposition of materials including aluminum alloys, titanium alloys, stainless steels, and high-strength steels using non-helium carrier gases. Without limitation, system 500 may deposit Aluminum 7075, Ti-6Al-4V (Ti64), Aeromet 100, or stainless steel 316 using nitrogen or compressed air as a carrier gas. System 500 may produce depositions of the materials with porosity levels below 1%, tensile strengths exceeding 90% of wrought material properties, and elongation values exceeding 5%. System 500 may operate with cold spray process parameters including standoff distance, step-over distance, and traverse speed. Without limitation, system 500 may operate with a standoff distance of 25 millimeters (mm), a step-over distance of 0.5 mm, and a traverse speed of 40 mm per second (mm/s). System 500 may adjust the process parameters based on a material being deposited and a substrate material. System 500 may reduce thermal loading of a substrate compared to helium-based cold spray systems operating at higher pressures and temperatures. The reduced thermal loading may reduce formation of thermal gradients and internal stress formation in a substrate. System 500 may reduce a likelihood of substrate distortion or warpage during deposition operations. System 500 may enable deposition onto thermally sensitive substrates that cannot withstand thermal loading associated with high-temperature helium-based cold spray operations. System 500 may reduce nozzle fouling compared to cold spray systems that heat powder particles through external thermal loading from a heated carrier gas. Inductive coil 504 may heat powder particles after the powder particles pass through a stagnation point in PBI nozzle 502. The post-stagnation heating may reduce a likelihood of powder particles adhering to interior surfaces of PBI nozzle 502. System 500 may extend a service life of PBI nozzle 502 compared to nozzles used in high-temperature helium-based cold spray systems. System 500 may provide tunable control of powder particle heating through adjustment of frequency and power level of inductive coil 504. The tunable control may enable material-specific optimization of deposition parameters. System 500 may store a plurality of frequency and power level profiles corresponding to different powder materials. Without limitation, system 500 may select a frequency and power level profile based on a user input indicating a powder material being deposited. In an embodiment, system 500 may automatically detect a powder material based on sensor data and selects a corresponding frequency and power level profile. System 500 may include a controller that regulates operation of inductive coil 504. The controller adjusts a frequency and power level of an RF signal supplied to inductive coil 504 based on a target temperature for powder particles. Without limitation, the controller receives feedback from a temperature sensor that measures a temperature of powder particles exiting PBI nozzle 502. The controller may adjust the frequency or power level of inductive coil 504 based on a difference between a measured temperature and a target temperature. System 500 operate in conjunction with a cold spray apparatus that supplies powder particles and carrier gas to PBI nozzle 502. The cold spray apparatus may include a powder feeder, a gas supply system, and a control system. Without limitation, the cold spray apparatus may include a high-pressure cold spray system that operates at pressures exceeding 300 psi. In an embodiment, the cold spray apparatus may include a low-pressure cold spray system that operates at pressures below 300 psi. System 500 may enable Navy fleet readiness centers, shipyards, intermediate maintenance facilities, and the like to perform structural repairs on aircraft, ships, weapon systems, and the like using cold spray technology without dependence on helium supply chains. System 500 may reduce logistics burdens associated with helium procurement and storage. System 500 may enable expeditionary repair operations in forward-deployed environments where helium availability presents operational constraints.

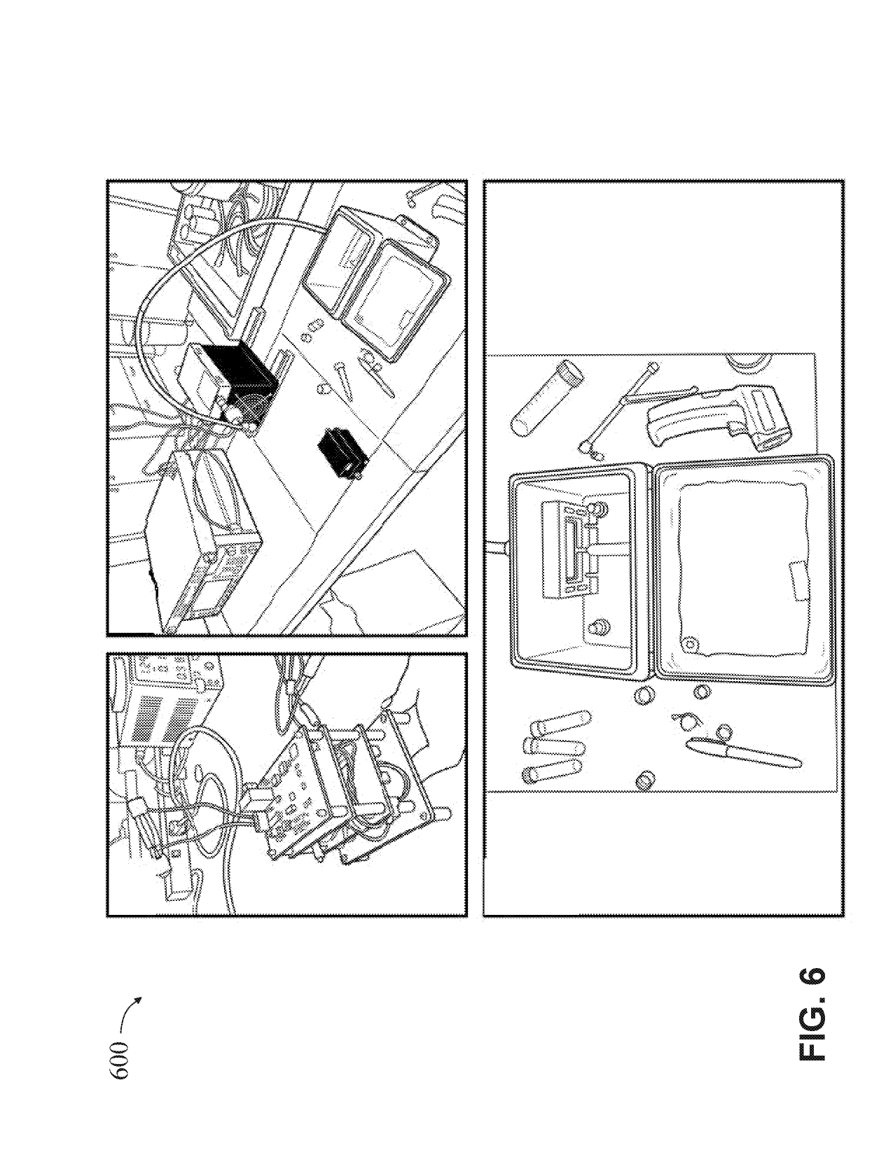

Referring now to FIG. 6, an illustration 600 of a feasibility study examining a power transfer from an induced high-frequency field to a powder is shown. Illustration 600 includes panels A, B, and C, each corresponding to a distinct configuration or stage of the experimental evaluation conducted to assess the capability of electromagnetic field (EMF) energy to impart thermal input to powder particles prior to cold spray deposition. Panel A of illustration 600 illustrates an initial experimental configuration employing a compact inductive coil cable device, referred to herein as a Traceptor, positioned proximate to a quantity of powder feedstock. The Traceptor is configured to impart electromagnetic energy across a broad frequency range extending from the megahertz regime into the low gigahertz regime, including frequencies from approximately 80 MHz to approximately 1.2 GHz. This configuration was used to qualitatively assess whether inductive coupling could transfer sufficient energy to the powder feedstock. Experimental results from this configuration demonstrated that, while electromagnetic coupling was achieved, the available power level was insufficient to selectively heat the powder feedstock in a temporally efficient manner suitable for cold spray processing.

With continued reference to FIG. 6, panel B of illustration 600 depicts a subsequent experimental configuration incorporating a microwave emitter system configured to deliver substantially higher electromagnetic power to the powder feedstock. In this configuration, a signal generator is operatively coupled to a power amplifier configured to produce amplified electromagnetic signals at frequencies in a range of approximately 3.2 GHz to approximately 3.4 GHz. The amplifier is further configured to provide output power levels of up to approximately 800 W with a gain factor of approximately 47, thereby enabling significantly greater energy transfer to the powder feedstock as compared to the Traceptor-based configuration. The microwave emitter shown in panel B is positioned such that the emitted high-frequency electromagnetic field interacts with the powder feedstock, inducing currents within the conductive particles. Post-experimental analysis indicated that the powder feedstock was heated to elevated temperatures, as evidenced by visible discoloration and associated oxide state changes consistent with known tempering behavior of metallic materials.

With continued reference to FIG. 6, panel C of illustration 600 illustrates a representative testing apparatus used during the microwave-based feasibility evaluation. In this configuration, the experimental hardware was adapted from a prior project, which limited the ability to directly measure temperature profiles or capture real-time thermal data from the powder feedstock. Nevertheless, the configuration shown in panel C confirmed that meaningful thermal input could be imparted to the powder feedstock using high-frequency electromagnetic energy. Based on the results obtained from the configurations shown in panels A through C, a determination was made that a refined experimental apparatus was required to enable direct measurement and quantification of thermal response. Accordingly, a subsequent test setup was developed to allow direct observation of temperature evolution within the powder feedstock under high-frequency electromagnetic excitation. Using the refined apparatus, thermal gradients as high as approximately 195 °C per second were recorded, with peak temperatures reaching approximately 889 °C after approximately 17 seconds of electromagnetic exposure. These measurements may confirm that high-frequency electromagnetic fields are capable of delivering substantial and controllable thermal input to metallic powder feedstock. The feasibility study represented by illustration 600 may demonstrate that electromagnetic field-assisted heating can be applied to powder feedstock independently of the carrier gas and substrate, enabling localized thermal softening of particles without globally elevating system temperatures. The results may further indicate that such localized thermal conditioning may reduce the critical particle velocity required for effective cold spray deposition, thereby enabling the use of non-helium carrier gases, including nitrogen or air, while maintaining desirable deposition characteristics. The feasibility study may also establish a framework for systematic evaluation of electromagnetic frequency, power level, exposure duration, and powder material characteristics, providing experimental data suitable for optimizing EMF-assisted cold spray processes across a range of materials and applications. Additionally, the experimental configurations shown in illustration 600 may demonstrate the modular nature of the EMF heating approach, as the electromagnetic energy delivery hardware can be adapted for integration with various cold spray platforms and test environments. The feasibility study therefore may provide experimental validation of electromagnetic field-assisted powder heating as a viable mechanism for enhancing cold spray deposition performance. Collectively, the results obtained from illustration 600 may support further development, optimization, and integration of EMF-assisted cold spray systems for structural repair, additive manufacturing, and coating deposition applications.

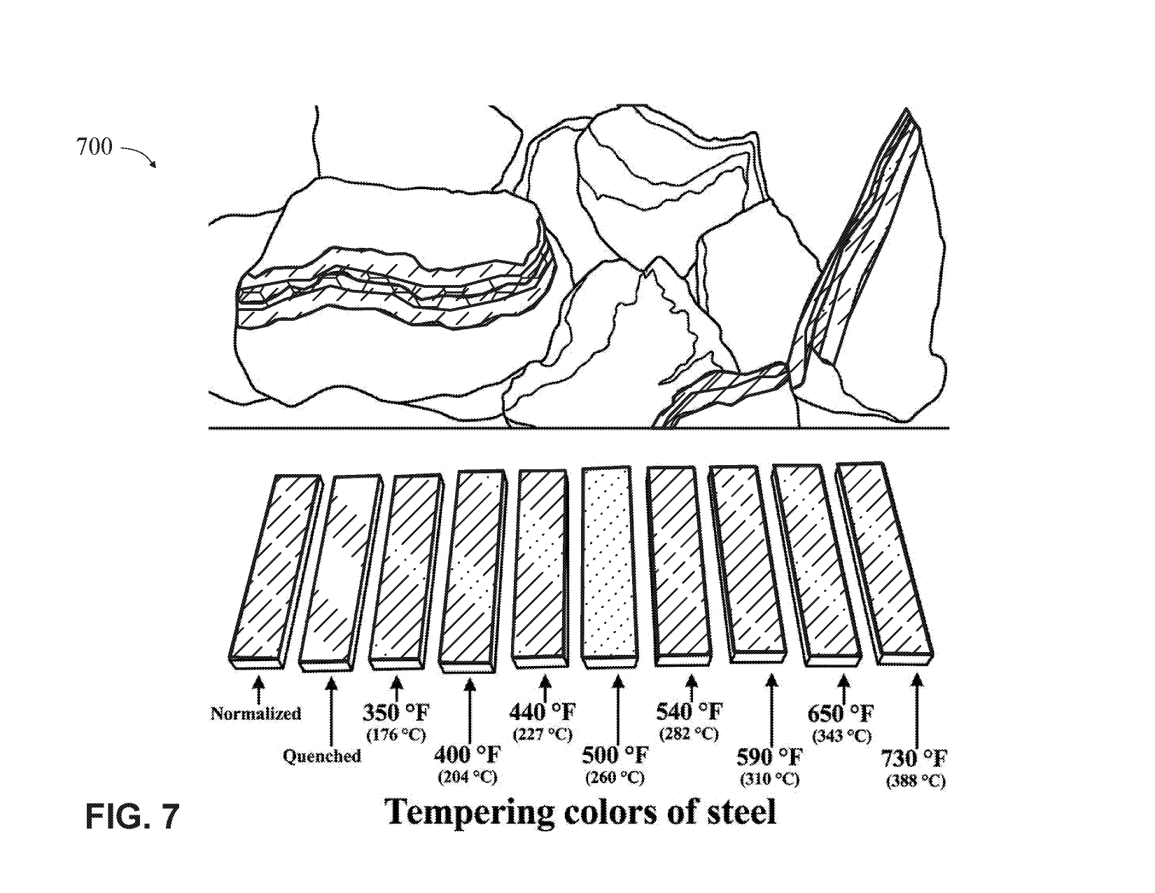

Referring now to FIG. 7, an illustration 700 of an oxidation state of powder exposed to an electromagnetic field (EMF) is shown. The illustration is arranged in an upper portion and a lower portion. The upper portion of illustration 700 shows representative metallic powder agglomerates following exposure to the electromagnetic field. The powder particles exhibit visible surface discoloration, including regions of straw, brown, blue, and darkened oxide formation. These color variations are characteristic of thermally induced oxidation and indicate that the powder particles experienced localized heating as a result of electromagnetic field coupling. The lower portion of illustration 700 may present a tempering color reference scale for steel, correlating surface oxide coloration with approximate temperature ranges. The reference scale includes progressive color changes associated with increasing temperature, ranging from light straw tones through brown and blue hues to darker oxide colors. By comparison of the discoloration observed in the upper portion of illustration 700 with the tempering color reference shown in the lower portion, the illustration 700 qualitatively indicates that the powder feedstock reached elevated temperatures consistent with thermal softening regimes, while remaining below melting conditions. Illustration 700 may demonstrate that exposure of the powder feedstock to an electromagnetic field results in measurable thermal input, as evidenced by oxidation-driven color changes, and supports the conclusion that electromagnetic field-assisted processing can induce controlled, localized heating of powder particles suitable for use in cold spray and related deposition processes.

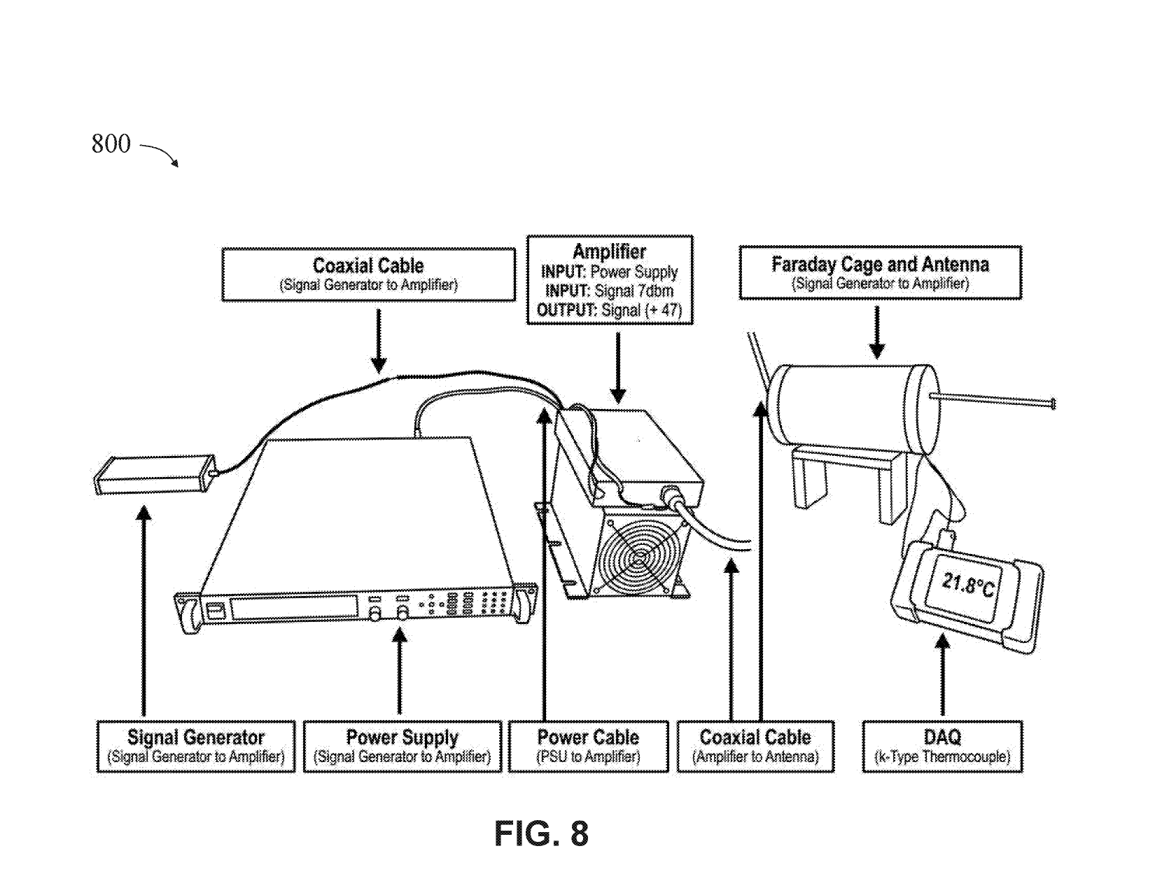

Referring now to FIG. 8, an illustration 800 of an experimental set up for a direct observation and measurement of high frequency input (EMF) on SS 316 feedstock is shown. In an embodiment, the illustration 800 may include a signal generation and amplification chain operatively coupled to an electromagnetic field emission assembly, together with instrumentation for monitoring the thermal response of the feedstock during electromagnetic exposure. In a non-limiting example, the experimental setup may include a signal generator configured to produce a high-frequency electrical signal at a selected frequency and power level. The signal generator may be electrically coupled to an amplifier by way of a coaxial cable. The amplifier may be configured to receive the input signal and increase the signal power to a level sufficient to induce electromagnetic heating in conductive material. A power supply may be electrically coupled to the amplifier to provide operating power thereto. In a non-limiting example, the amplified high-frequency signal may be transmitted from the amplifier to an antenna by way of a coaxial cable. The antenna may be positioned within or adjacent to a Faraday cage configured to limit unintended electromagnetic emissions and reduce interference with surrounding equipment. The antenna may be arranged to emit a high-frequency electromagnetic field into a defined exposure region containing the SS 316 feedstock. In a non-limiting example, illustration 800 may further include a temperature measurement system configured to measure a thermal response of the SS 316 feedstock during electromagnetic field exposure. The temperature measurement system may include a thermocouple positioned in thermal communication with the feedstock and coupled to a data acquisition device. The data acquisition device may be configured to record temperature data over time, thereby enabling direct observation of heating rates and peak temperatures induced by the electromagnetic field. In a non-limiting example, the arrangement shown in illustration 800 may allow for controlled variation of electromagnetic field parameters, including frequency and power level, while simultaneously measuring the resulting temperature response of the SS 316 feedstock. Such a configuration may enable quantitative assessment of electromagnetic field coupling and provide experimental validation of electromagnetic field-induced heating effects suitable for powder conditioning in cold spray and related material deposition processes.

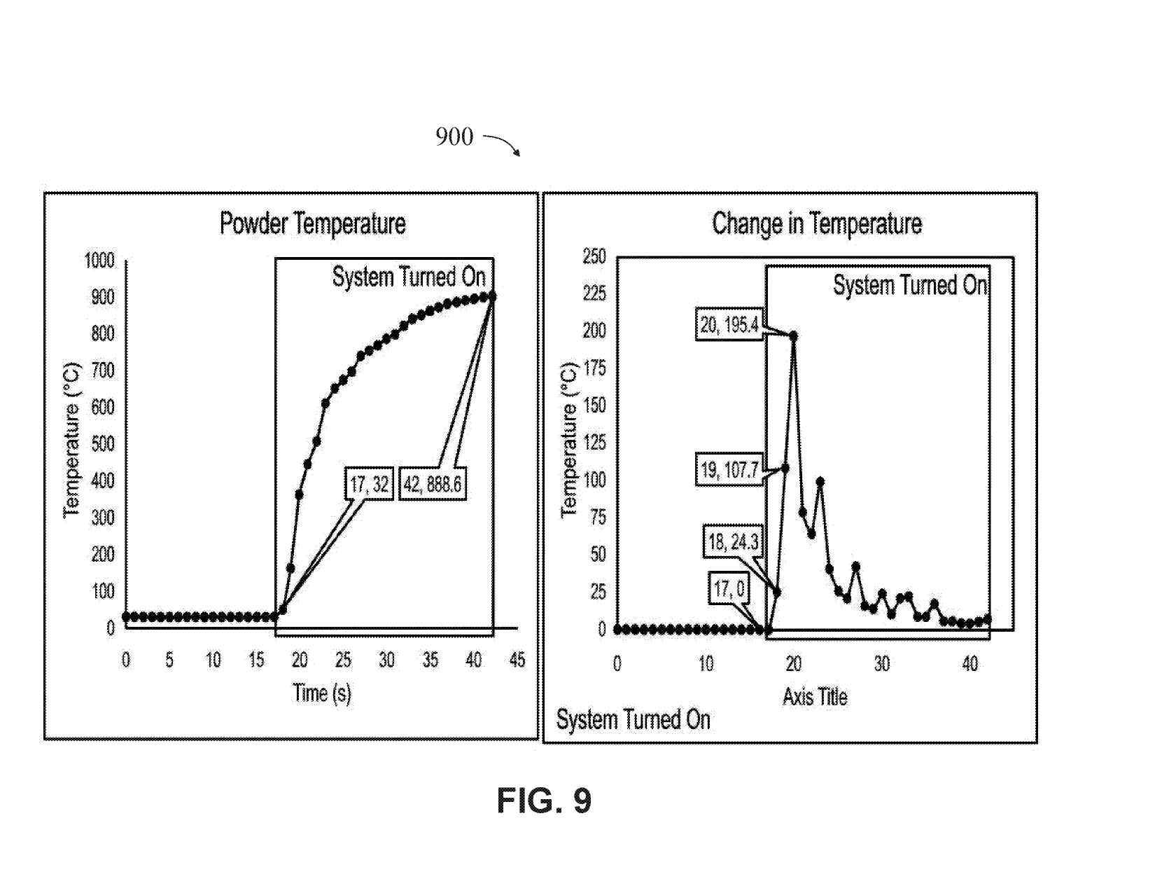

Referring now to FIG. 9, an illustration 900 of two charts displaying thermal responses over time with a 3.5 GHz and a 7 dBm high-frequency signal input applied is shown. In an embodiment, a first chart of illustration 900 presents a chart entitle “Powder Temperature” that includes a temperature (in degrees Celsius) versus time (in seconds) profile obtained while a 3.5 GHz, 7 dBm high-frequency signal is applied. The chart shows that prior to system activation, the powder temperature remains substantially constant at a low baseline level. Upon activation of the system at a defined time point, the powder temperature increases sharply, indicating rapid absorption of energy by the powder material. Following the initial rise, the temperature continues to increase at a reduced rate and trends toward a higher, substantially steady temperature, reflecting sustained energy coupling and progressive thermal accumulation within the powder. In a non-limiting example, the second chart of illustration 900 presents a chart entitled “Change in Temperature” which includes a temperature (in degrees Celsius) versus time (in seconds) corresponding to the same operating conditions. This chart highlights a pronounced transient peak in temperature change immediately following system turn-on, evidencing a rapid rate of heating at the onset of high-frequency signal application. After the transient peak, the magnitude of temperature change decreases and exhibits smaller oscillations over time, indicating a reduction in heating rate as the system approaches thermal equilibrium. The decay in temperature change further illustrates stabilization of the thermal response once continuous energy input and heat dissipation reach a substantially balanced condition.

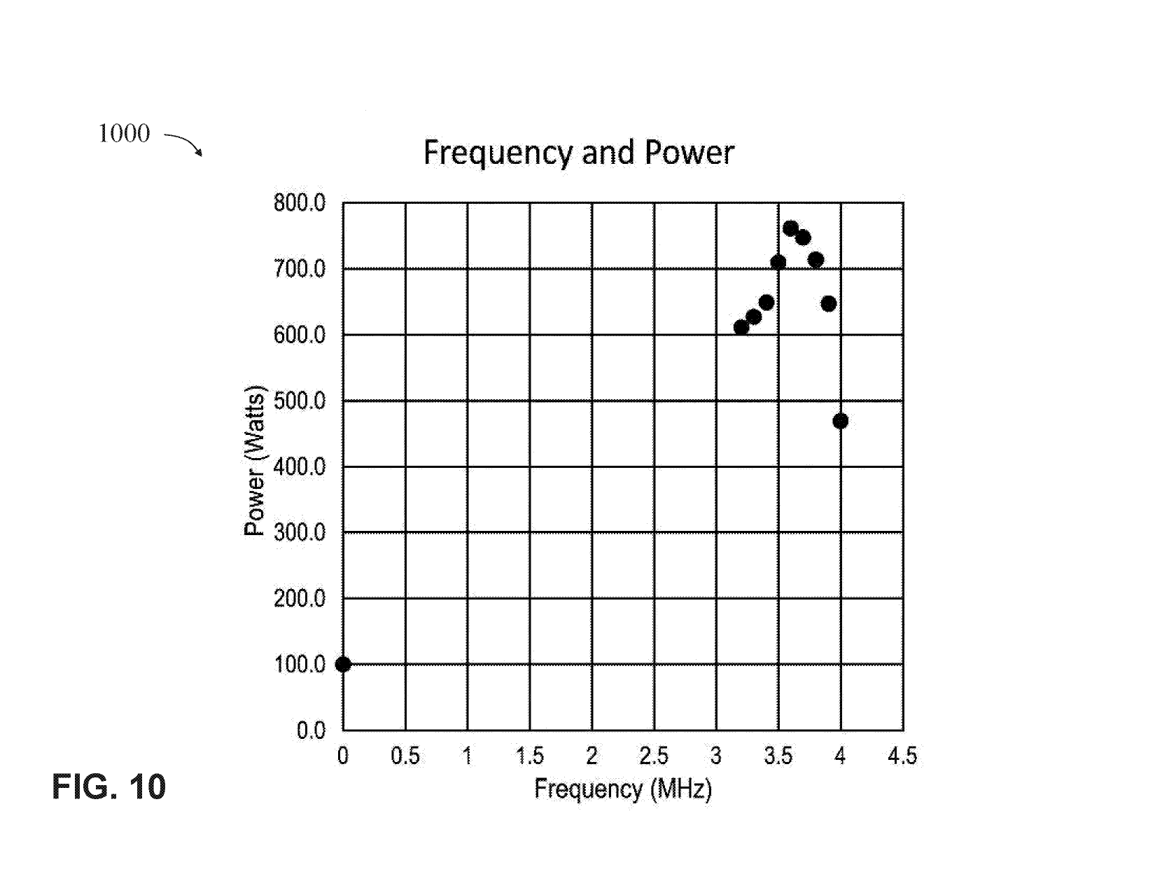

Referring now to FIG. 10, an illustration 1000 of a power draw of a helical coil with respect to frequency is shown. The chart plots electrical power consumption on the vertical axis in watts versus applied signal frequency on the horizontal axis in gigahertz, illustrating a nonlinear relationship across the tested frequency range. At lower frequencies, the helical coil exhibits relatively low power draw, while increasing frequency results in a substantial rise in power consumption, reaching a maximum at approximately 3.6 GHz. This peak may indicate enhanced electromagnetic coupling between the applied high-frequency signal and the helical coil. At frequencies beyond the peak, the power draw decreases, indicating diminished coupling efficiency. The illustrated response demonstrates frequency-dependent behavior of the helical coil, with the peak power draw identifying a frequency range associated with the most significant energy transfer into the system.

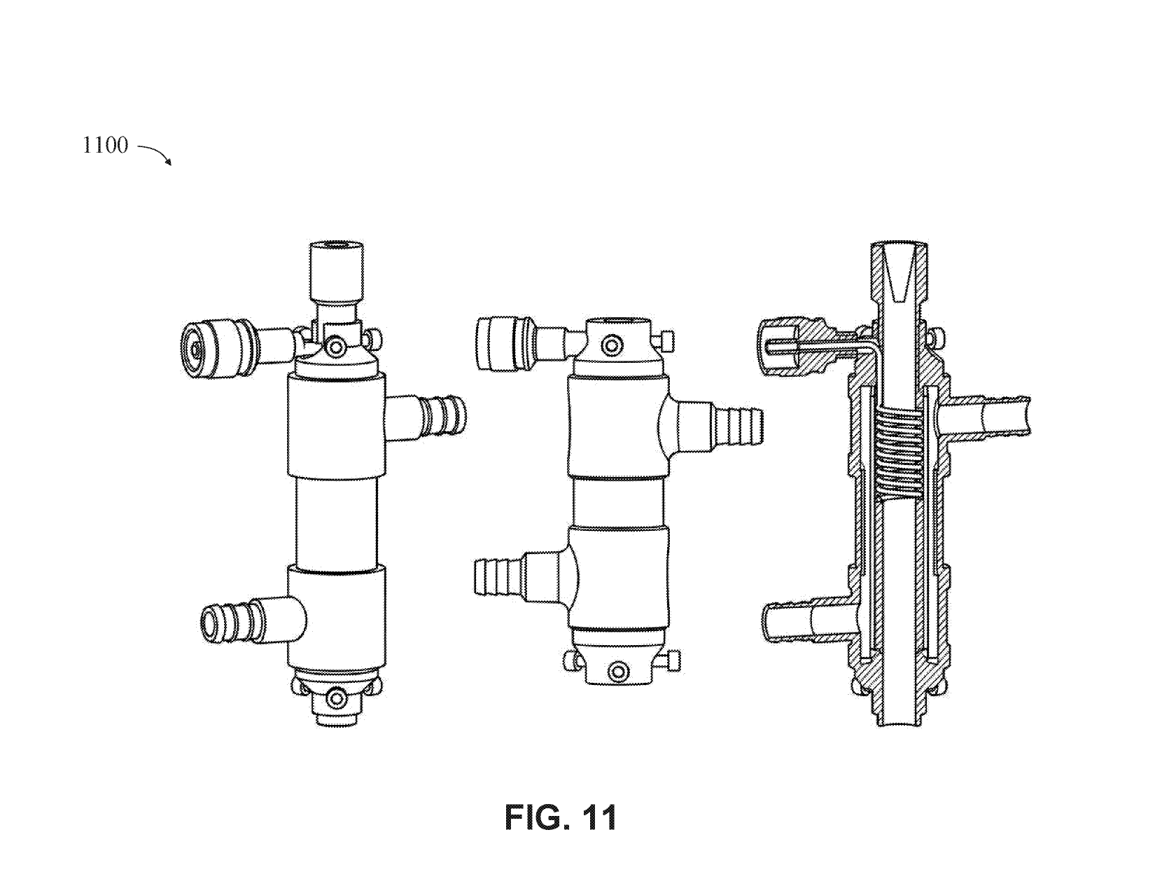

Referring now to FIG. 11, an illustration 1100 of a Design (Left) Build (Center) and Cross Section (Right) of transition strategy from static to dynamic testing of introducing high frequency energy (EMF) into feedstock is shown. In a non-limiting example, illustration 1100 includes a design representation shown at a left portion of the figure, a physical build shown at a center portion of the figure, and a cross-sectional representation shown at a right portion of the figure, each corresponding to different stages of development of the transition strategy. In a non-limiting example, the left portion of illustration 1100 displays a design configuration of a feedstock conditioning device configured to couple high-frequency electromagnetic field energy into powder material. The design representation may show an outer housing formed from an electrically conductive material and including multiple ports or fittings. These ports may be configured for attachment to powder delivery lines, carrier gas lines, cooling lines, or electrical connections, and may define internal flow paths for the powder feedstock during operation. In a non-limiting example, the center portion of illustration 1100 displays a fabricated or assembled embodiment of the device corresponding to the design shown in the left portion. The build representation may include a metallic housing, such as a copper or copper-alloy structure, assembled from multiple joined components. The physical build may further include threaded interfaces, fittings, mounting features, and the like configured to allow integration with experimental test setups or cold spray hardware. This build representation may demonstrate manufacturability and physical implementation of the transition strategy. In a non-limiting example, the right portion of illustration 1100 illustrates a cross-sectional view of the device, revealing internal features configured to introduce high-frequency electromagnetic field energy into the feedstock. The cross section may show an internal passage through which powder feedstock flows, surrounded at least in part by an electromagnetic field-generating element, such as an inductive coil or antenna. The internal geometry may be configured to position the feedstock within a region of concentrated electromagnetic field exposure while maintaining separation from external components. In a non-limiting example, the cross-sectional view may further illustrate how the electromagnetic field-generating element may be embedded within or adjacent to the housing, allowing electromagnetic energy to couple into the feedstock during dynamic flow conditions. This configuration may enable transition from static testing, in which powder is stationary, to dynamic testing, in which powder is transported through the device under conditions representative of cold spray operation. In a non-limiting example, illustration 1100 may demonstrate a progression from conceptual design, to physical construction, to functional internal architecture for introducing high-frequency electromagnetic field energy into powder feedstock. The transition strategy shown in FIG. 11 may support dynamic evaluation of electromagnetic field-assisted powder conditioning and provides a scalable architecture suitable for integration with cold spray and related material processing systems.

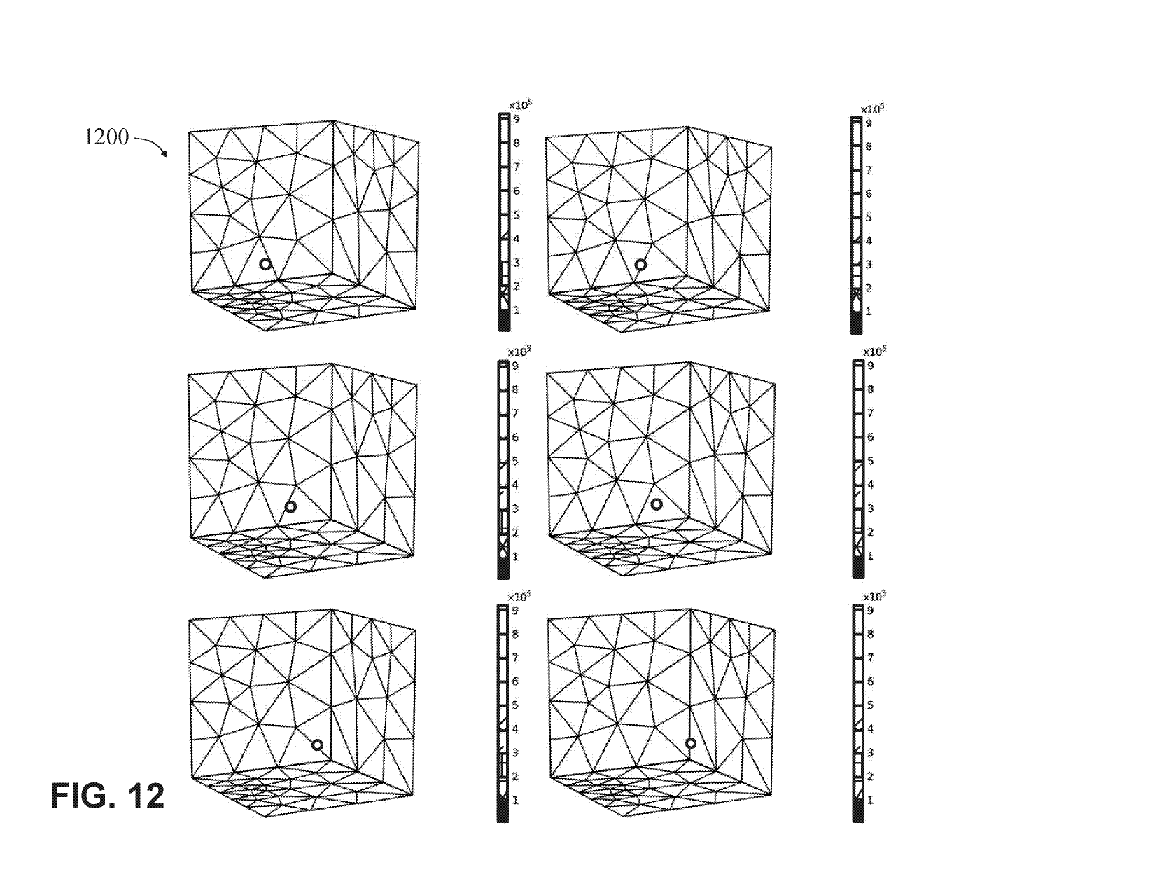

Referring now to FIG. 12, an illustration 1200 of a particle in flight traveling under an RF emitter traveling at 1200 m/s as simulated by a finite-element analysis and Multiphysics simulation software platform radio-frequency module is shown. Without limitation, illustration 1200 may depict a modeled representation of a particle in flight traveling under a radio-frequency emitter at a velocity of approximately 1200 m/s, as simulated using a radio-frequency module of a Multiphysics modeling environment. In a non-limiting example, illustration 1200 may include a plurality of sequential simulation frames showing a conductive particle at different positions within a three-dimensional computational domain while exposed to a radio-frequency electromagnetic field. In a non-limiting example, each simulation frame illustrates a bounded modeling volume discretized into a finite element mesh, with the particle represented as a localized region within the domain. A color scale associated with each frame may indicate a magnitude of electromagnetic field interaction, induced current density, power dissipation, or related electromagnetic response within or proximate to the particle. The color progression across the frames illustrates changes in electromagnetic coupling as the particle translates through the emitter region. In a non-limiting example, the sequence of frames represents successive time steps corresponding to the particle’s motion at a velocity representative of cold spray operating conditions. As the particle traverses the region beneath the radio-frequency emitter, the particle experiences varying electromagnetic field intensity, resulting in localized induction of currents within the particle. These induced currents may produce resistive heating within the particle while the particle remains in flight. In a non-limiting example, the modeled environment is configured to evaluate both the magnitude and spatial distribution of electromagnetic field effects within the computational domain, thereby enabling assessment of whether high-frequency electromagnetic energy remains confined to a desired interaction region. The simulation results shown in illustration 1200 may be used to evaluate electromagnetic field containment and to assess potential exposure levels external to the emitter region. In a non-limiting example, illustration 1200 may demonstrate that a particle traveling at supersonic velocity can be exposed to radio-frequency electromagnetic energy for a sufficient duration to induce measurable electromagnetic interaction during flight. The modeling results may support the feasibility of selectively imparting thermal energy to powder feedstock particles under dynamic flow conditions while maintaining control over electromagnetic field distribution and system safety.

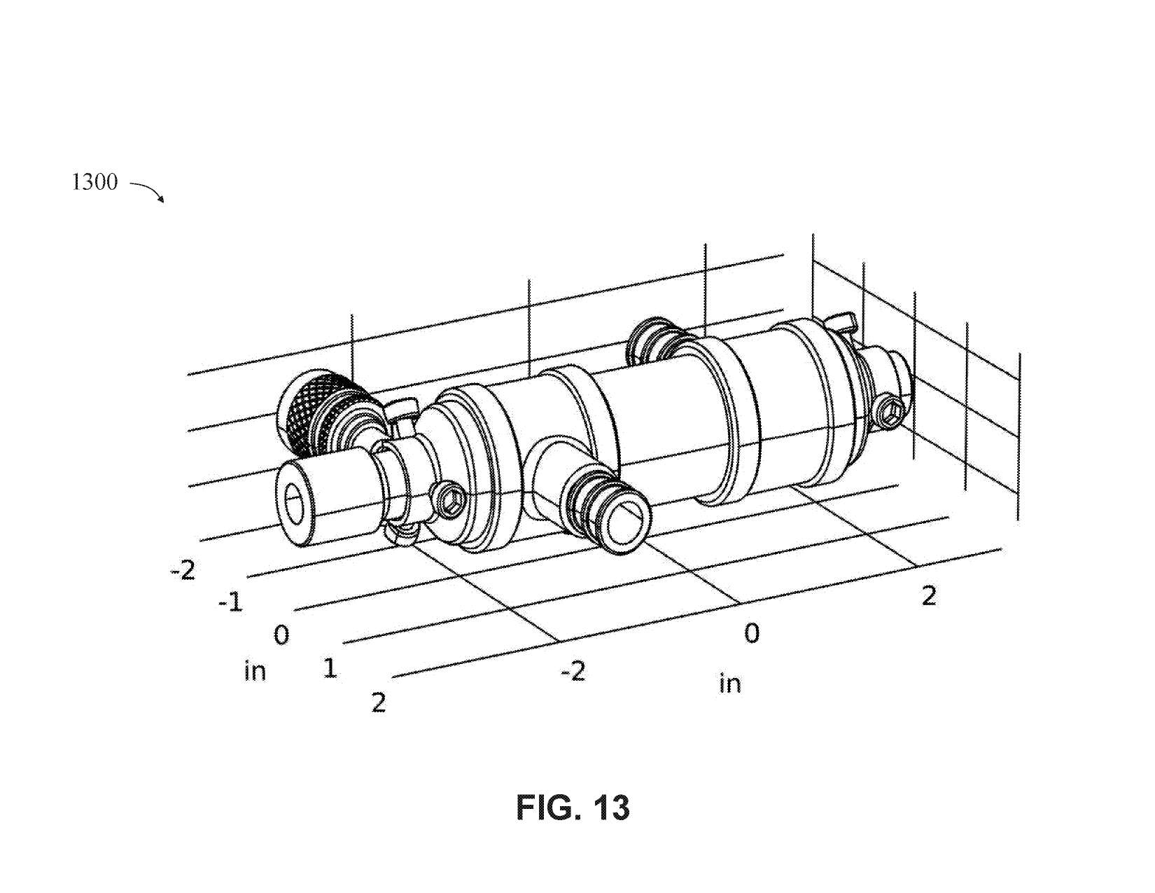

Referring now to FIG. 13, an illustration 1300 of an initial modeling for the environmental setup to determine an emission of high frequency (EMF) waves is shown. In a non-limiting example, the illustration 1300 shows a three-dimensional model of a feedstock conditioning device positioned within a surrounding spatial domain configured to assess electromagnetic field propagation beyond the device during operation. In a non-limiting example, the surrounding domain defines an environmental volume used to analyze the spatial distribution and attenuation of high-frequency electromagnetic field emissions as a function of distance from the device. The model may be used to evaluate field containment, environmental exposure, and system safety, and to guide design refinements intended to limit unintended electromagnetic emissions.

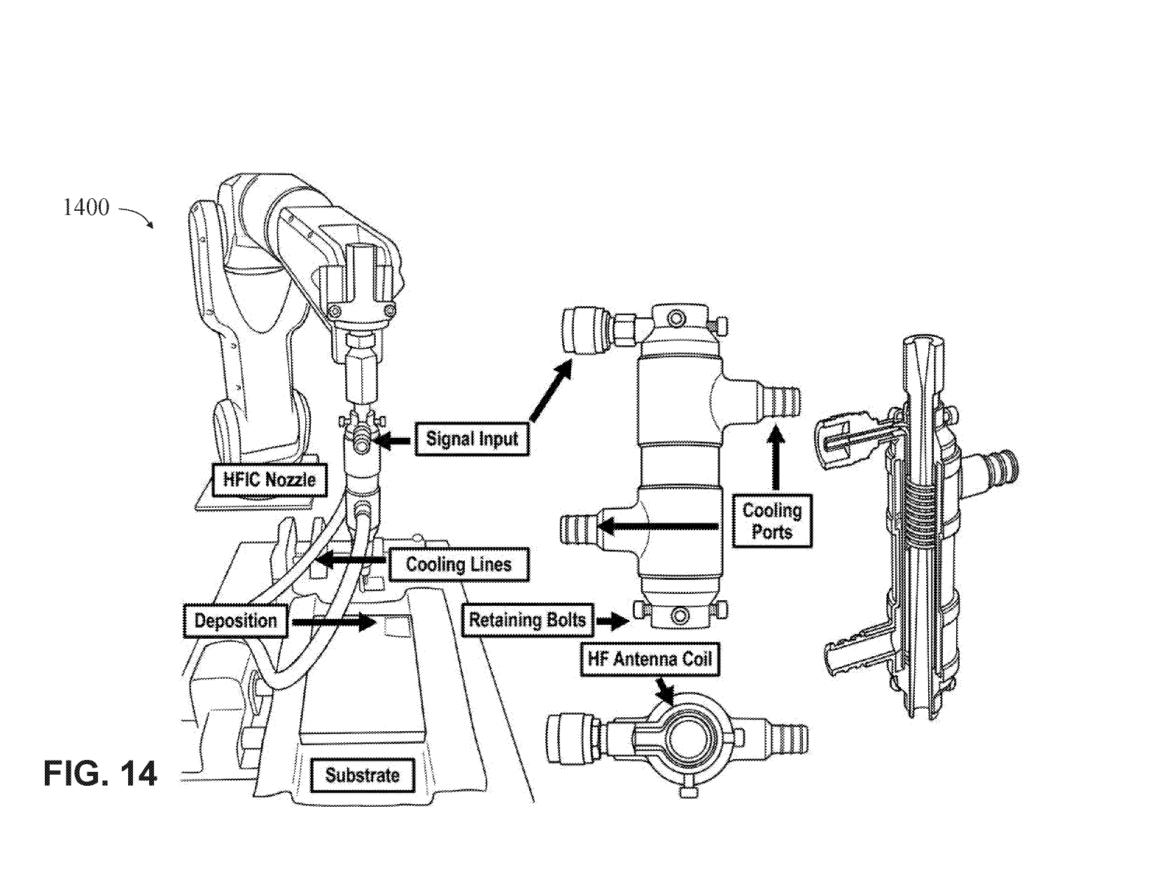

Referring now to FIG. 14, an illustration 1400 of a design (Left) Build (Center) and Cross Section (Right) of transition strategy from static to dynamic testing of introducing high frequency energy (EMF) into feedstock is shown. In a non-limiting example, illustration 1400 includes a design view shown at a left portion of the figure, a fabricated build shown at a center portion of the figure, and a cross-sectional view shown at a right portion of the figure. In a non-limiting example, the left portion illustrates the device integrated with a cold spray system, showing a nozzle assembly positioned above a substrate during deposition. The design view may identify functional interfaces including a powder injection nozzle, a signal input for electromagnetic field excitation, cooling lines configured to manage thermal loads, and a deposition region where conditioned feedstock is delivered to the substrate. In a non-limiting example, the center portion illustrates a physical build of the device, showing a metallic housing with cooling ports, retaining features, and external connections configured for integration with experimental or operational hardware. The build view demonstrates manufacturability and alignment of the device with the design intent. In a non-limiting example, the right portion illustrates a cross-sectional representation of the device, revealing an internal electromagnetic field-generating element, such as an antenna or inductive coil, positioned around an internal passage through which the powder feedstock flows. The cross section illustrates how high-frequency electromagnetic field energy is coupled into the feedstock during dynamic flow conditions. In a non-limiting example, illustration 1400 demonstrates a progression from system-level integration, to physical construction, to internal functional architecture, thereby enabling dynamic evaluation of electromagnetic field-assisted powder conditioning under conditions representative of cold spray operation.

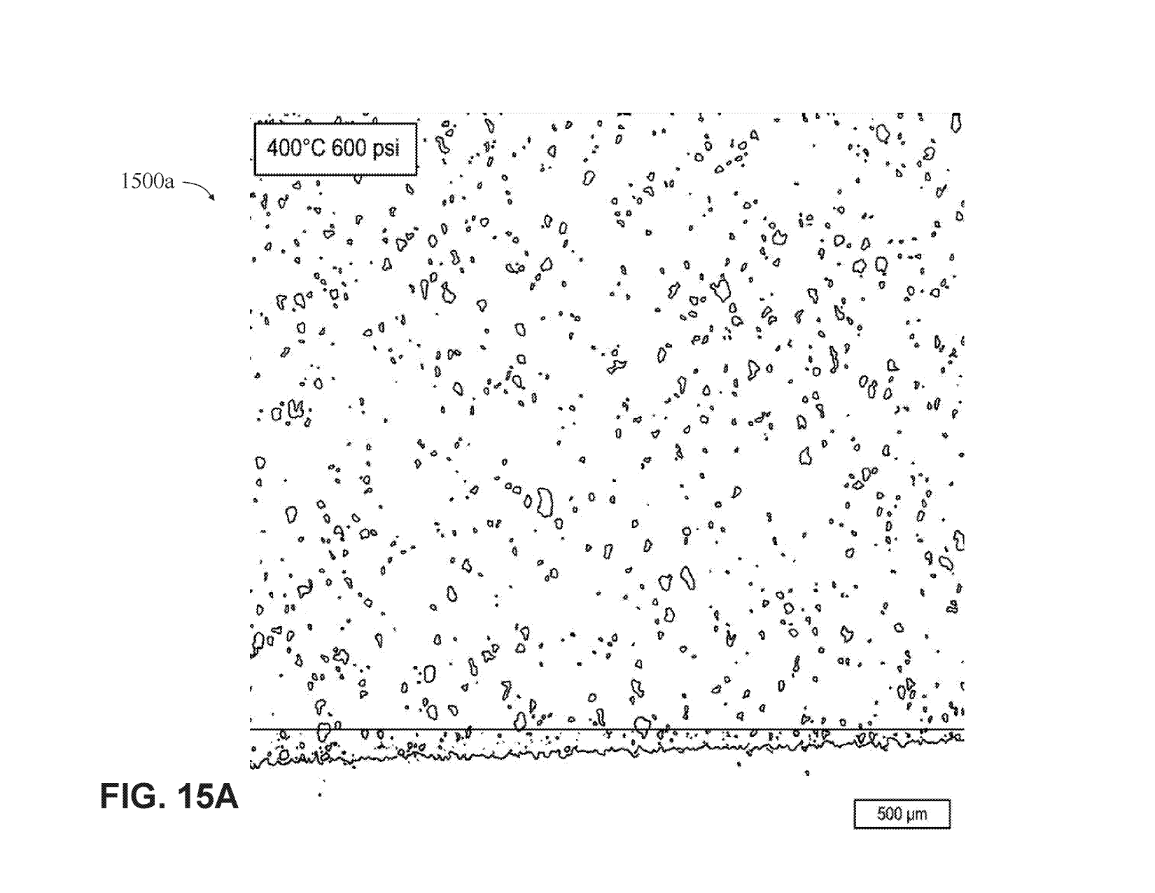

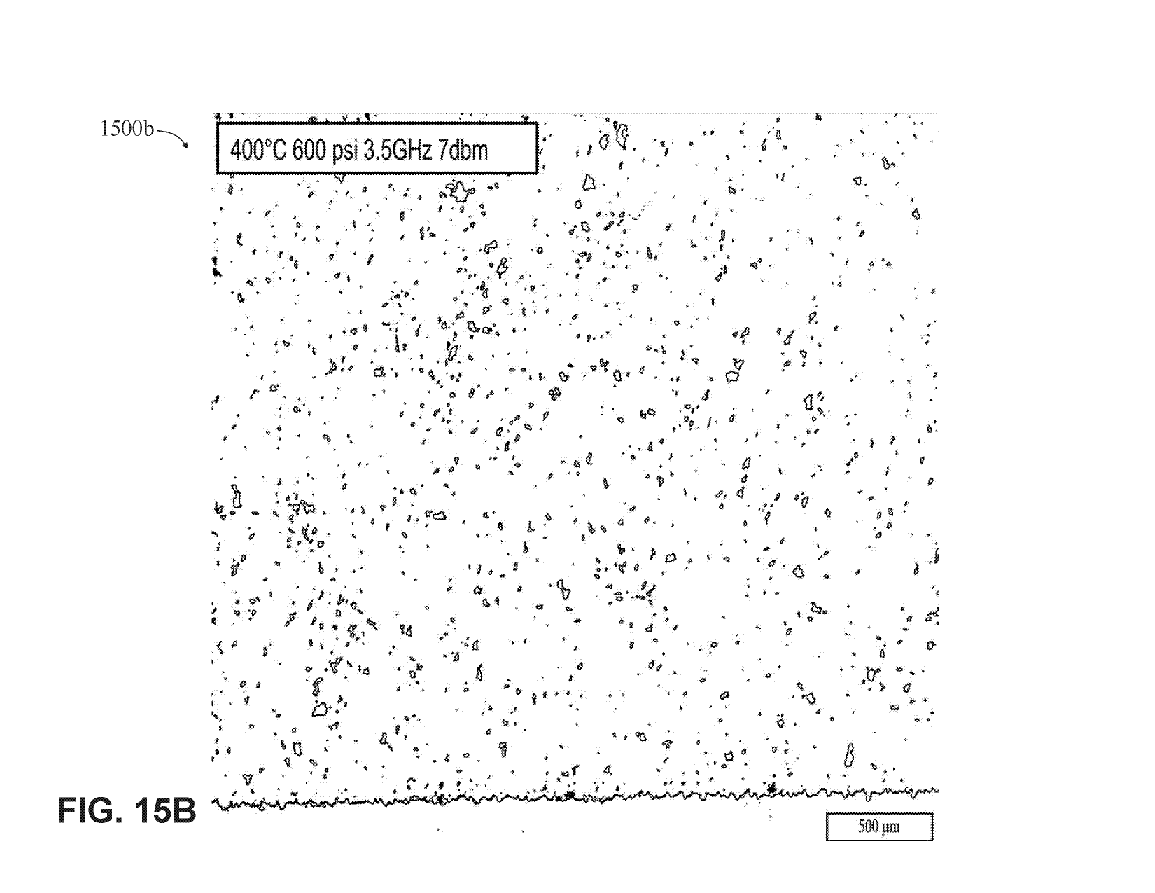

Referring now to FIG. 15A, an illustration 1500a of a control spray completed at 400 psi and 600 ˚C is shown. Without limitation, illustration 1500a depicts a control spray performed at a carrier gas pressure of approximately 400 psi and a process temperature of approximately 600 °C, without application of high-frequency electromagnetic field energy. In a non-limiting example, the control spray represents a baseline cold spray deposition condition in which powder feedstock is accelerated and deposited onto a substrate using conventional thermal and pressure inputs alone. The resulting deposited material shown in illustration 1500a may exhibit characteristic surface morphology, consolidation behavior, and coating quality associated with deposition under these operating conditions in the absence of electromagnetic field-assisted heating.

Referring now to FIG. 15B, an illustration 1500b of an experimental spray completed at 400 psi and 600 ˚C and high frequency signal (EMF) of 3.5 GHz and 7.0 dBm input is shown. Without limitation, illustration 1500b depicts an experimental spray performed under substantially the same carrier gas pressure of approximately 400 psi and process temperature of approximately 600 °C, while additionally applying a high-frequency electromagnetic field to the feedstock. In a non-limiting example, the experimental spray includes application of a high-frequency signal having a frequency of approximately 3.5 GHz and an input power level of approximately 7.0 dBm. The electromagnetic field may be coupled into the feedstock upstream of or during deposition, resulting in localized thermal conditioning of the powder particles during flight. In a non-limiting example, comparison of illustrations 1500a and 1500b demonstrates the effect of high-frequency electromagnetic field application on deposition behavior under otherwise equivalent process conditions. The experimental spray shown in illustration 1500b may exhibit differences in deposition efficiency, surface finish, particle deformation, or consolidation relative to the control spray, indicating that electromagnetic field-assisted heating contributes additional energy to the feedstock without increasing bulk process temperature or pressure. In a non-limiting example, FIG. 15A and FIG. 15B together provide comparative evidence that application of high-frequency electromagnetic field energy can modify cold spray deposition outcomes while maintaining identical nominal pressure and temperature settings, thereby supporting the role of electromagnetic field-assisted processing in enhancing feedstock conditioning and deposition performance.

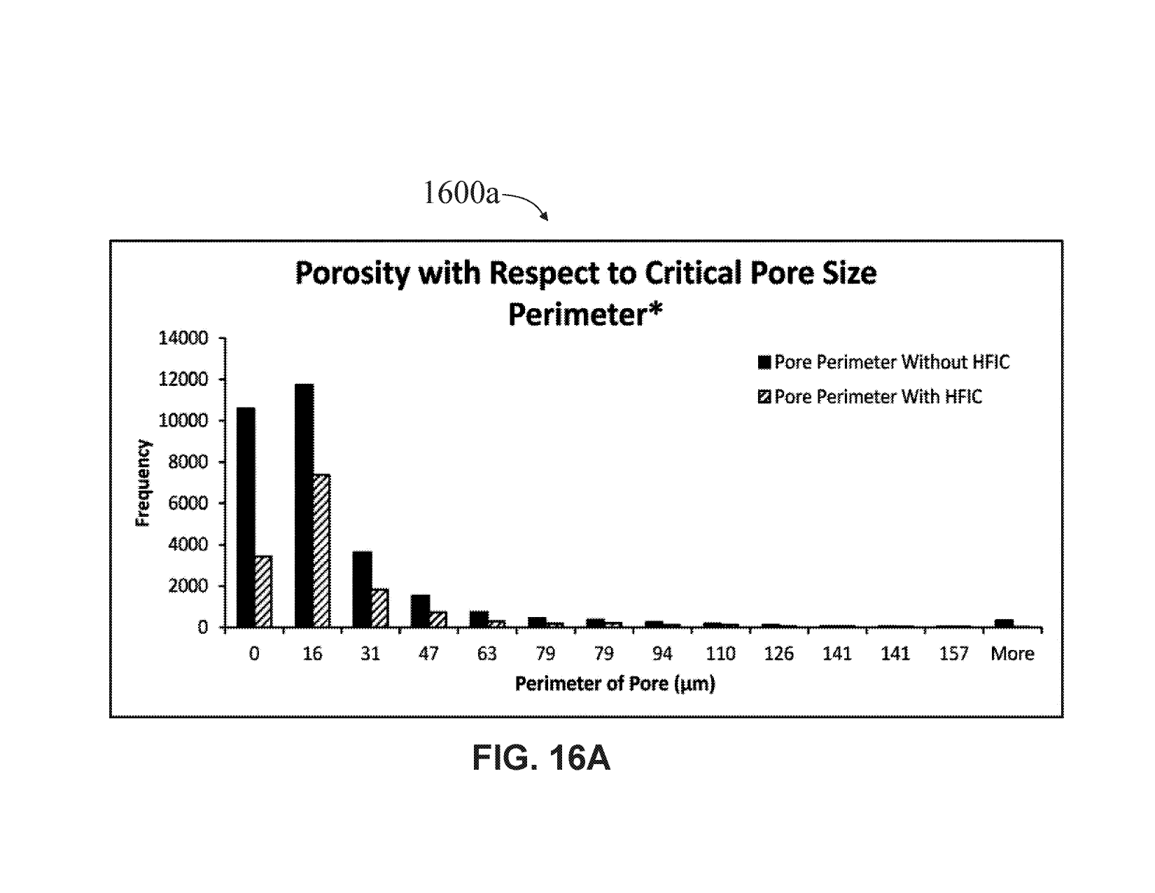

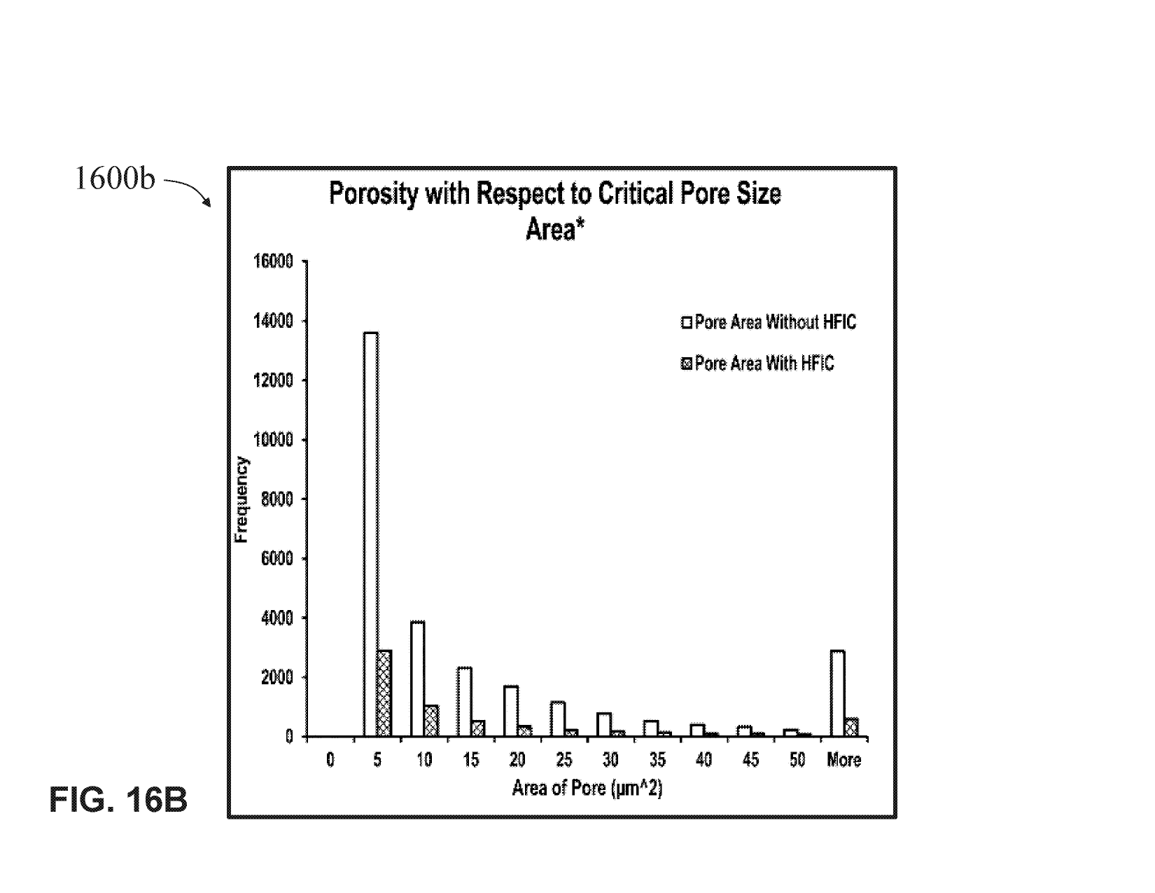

Referring now to FIG. 16A, an illustration 1600a of a first chart quantification of perimeter values with respect to critical pore size is shown. In a non-limiting example, the chart presents a frequency distribution of measured pore perimeters within a deposited material, with pore perimeter expressed along a horizontal axis and frequency of occurrence expressed along a vertical axis. In a non-limiting example, illustration 1600a includes a first data set corresponding to deposition performed without application of high-frequency electromagnetic field assistance and a second data set corresponding to deposition performed with high-frequency electromagnetic field assistance. The data sets are visually distinguished within the chart, allowing direct comparison of pore perimeter distributions under the two processing conditions. In a non-limiting example, the chart illustrates that deposition performed with high-frequency electromagnetic field assistance exhibits a reduced frequency of larger pore perimeter values relative to deposition performed without electromagnetic field assistance. Conversely, the distribution of smaller pore perimeter values may be shifted or reduced, indicating a change in pore morphology and consolidation behavior. In a non-limiting example, illustration 1600a provides quantitative evidence that application of high-frequency electromagnetic field energy during deposition influences pore size characteristics, including reduction of critical pore perimeters associated with structural weakness. The chart therefore supports the conclusion that electromagnetic field-assisted processing may improve deposit density and mechanical integrity by mitigating the formation of larger pores within the deposited material.

Referring now to FIG. 16B, an illustration 1600b of a second chart quantification of area values with respect to critical pore size is shown. In a non-limiting example, the second chart presents a frequency distribution of measured pore areas within a deposited material, with pore area expressed along a horizontal axis and frequency of occurrence expressed along a vertical axis. In a non-limiting example, illustration 1600b includes a first data set corresponding to deposition performed without application of high-frequency electromagnetic field assistance and a second data set corresponding to deposition performed with high-frequency electromagnetic field assistance. The two data sets are visually distinguishable within the chart, enabling direct comparison of pore area distributions under otherwise similar processing conditions. In a non-limiting example, the second chart illustrates that deposition performed with high-frequency electromagnetic field assistance exhibits a reduced frequency of larger pore area values relative to deposition performed without electromagnetic field assistance. The distribution of pore areas may be shifted toward smaller values, indicating a reduction in the prevalence of large-area pores associated with critical defects. In a non-limiting example, illustration 1600b provides quantitative evidence that application of high-frequency electromagnetic field energy during deposition influences pore area characteristics within the deposited material. The reduction in critical pore area values supports the conclusion that electromagnetic field-assisted processing may improve deposit density and structural integrity by mitigating formation and growth of larger pores.

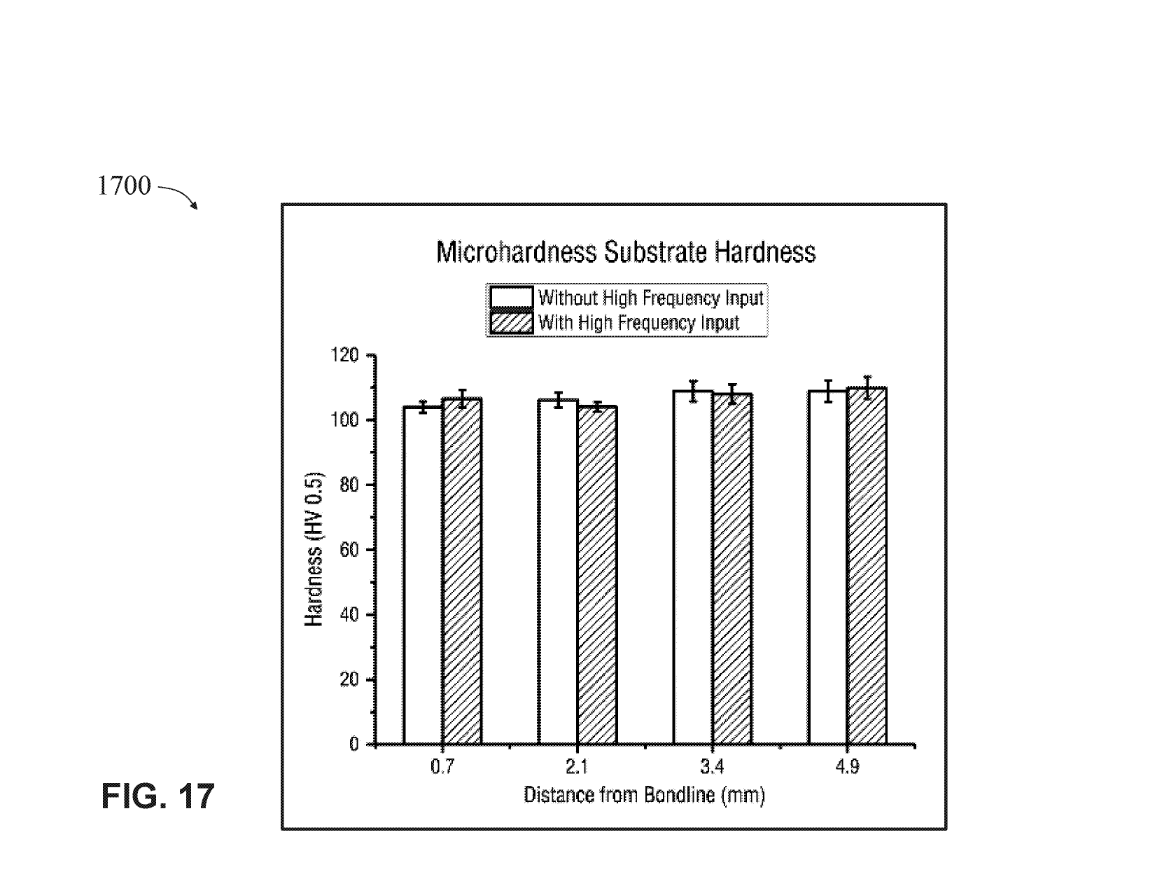

Referring now to FIG. 17, an illustration 1700 of a chart displaying microhardness of substrate with respect to distance from bondline is shown. As used in this disclosure, a “bondline” is an interface region between a deposited material and an underlying substrate at which mechanical bonding, metallurgical interaction, or both are established during a deposition or joining process. In a non-limiting example, the chart presents microhardness values measured at multiple locations within the substrate at increasing distances from the bondline, with hardness expressed along a vertical axis and distance from the bondline expressed along a horizontal axis. In a non-limiting example, illustration 1700 includes a first data set corresponding to deposition performed without application of high-frequency electromagnetic field input and a second data set corresponding to deposition performed with application of high-frequency electromagnetic field input. The data sets are visually distinguishable, enabling direct comparison of substrate microhardness profiles under the two processing conditions. In a non-limiting example, the chart indicates that microhardness values remain substantially consistent across the measured distances from the bondline for both processing conditions. The similarity of microhardness values suggests that application of high-frequency electromagnetic field input during deposition does not produce a significant alteration in substrate hardness away from the bondline.

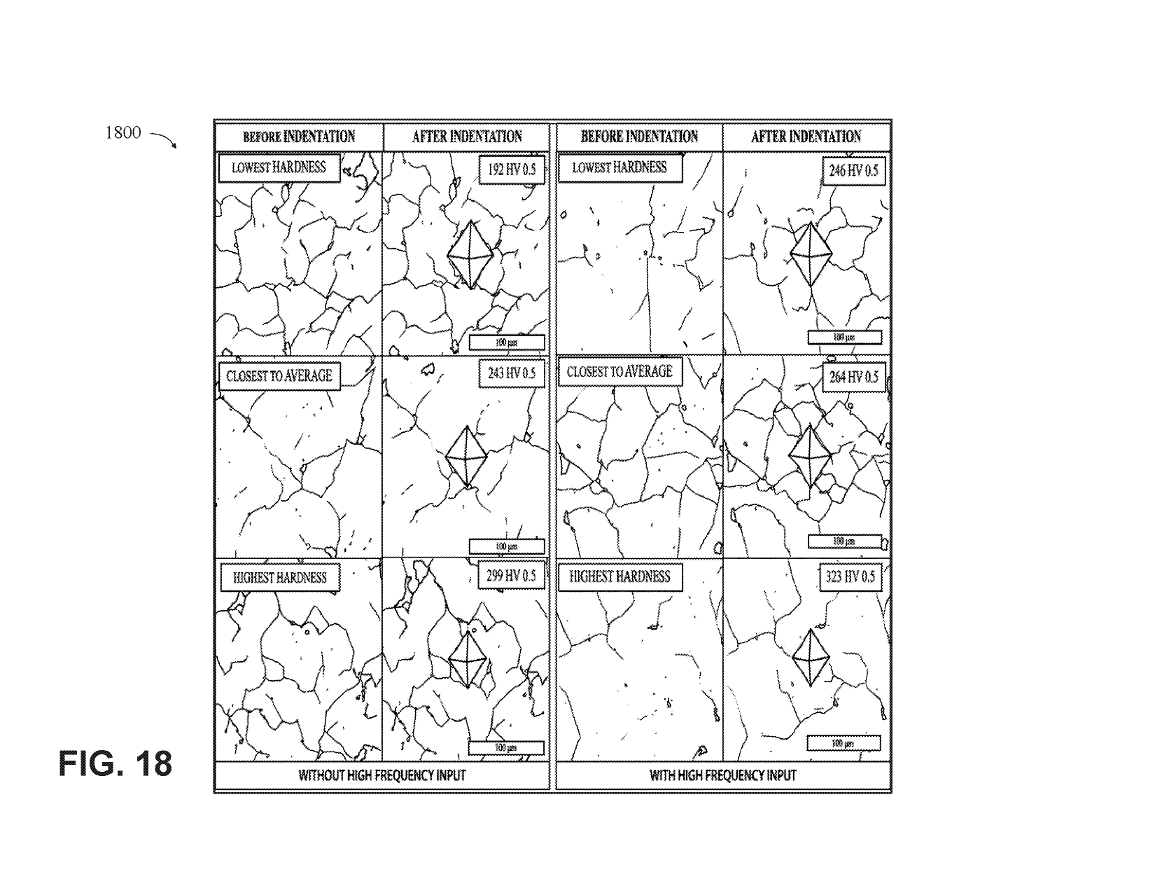

Referring now to FIG. 18, an illustration 1800 of a hardness measurements of the control (left) and the experimental high frequency input (EMF) (right) is shown. In an embodiment, illustration 1800 depicts Vickers hardness (HV) measurements obtained from the control deposition and from the experimental deposition performed with high-frequency electromagnetic field input. In a non-limiting example, illustration 1800 is arranged such that measurements corresponding to the control condition are shown on the left portion of the figure, while measurements corresponding to the electromagnetic field-assisted condition are shown on the right portion of the figure. In a non-limiting example, illustration 1800 includes micrographs of a deposited material captured before indentation and after indentation at multiple locations within the deposit. The measurement locations are explicitly labeled as lowest hardness, closest to average, and highest hardness. The post-indentation micrographs show characteristic indentation impressions corresponding to a standardized Vickers microhardness test conducted using a 0.5 kgf load, denoted as HV 0.5. In a non-limiting example, the control condition shown on the left portion of illustration 1800 exhibits Vickers hardness values of approximately 192 HV 0.5 at the lowest hardness location, approximately 243 HV 0.5 at the location closest to the average hardness, and approximately 299 HV 0.5 at the highest hardness location. These values represent the hardness distribution of the deposited material formed in the absence of high-frequency electromagnetic field input. In a non-limiting example, the experimental condition shown on the right portion of illustration 1800 exhibits increased Vickers hardness values across corresponding measurement locations. The labeled hardness values include approximately 246 HV 0.5 at the lowest hardness location, approximately 264 HV 0.5 at the location closest to the average hardness, and approximately 323 HV 0.5 at the highest hardness location. The increased hardness values indicate enhanced consolidation of the deposited material when high-frequency electromagnetic field input is applied during deposition. In a non-limiting example, comparison of the control and experimental measurements indicates that application of high-frequency electromagnetic field input increases the hardness of the deposited material across all measured regions. The increased hardness is consistent with improved particle deformation, bonding, and compaction resulting from additional energy imparted to the powder feedstock during deposition. In a non-limiting example, illustration 1800 further demonstrates that the observed changes in Vickers hardness values are attributable to the application of high-frequency electromagnetic field input, as other processing parameters are maintained substantially constant between the control and experimental conditions. The results therefore support the conclusion that electromagnetic field-assisted processing enhances material properties of cold spray deposits in a reproducible and controlled manner.

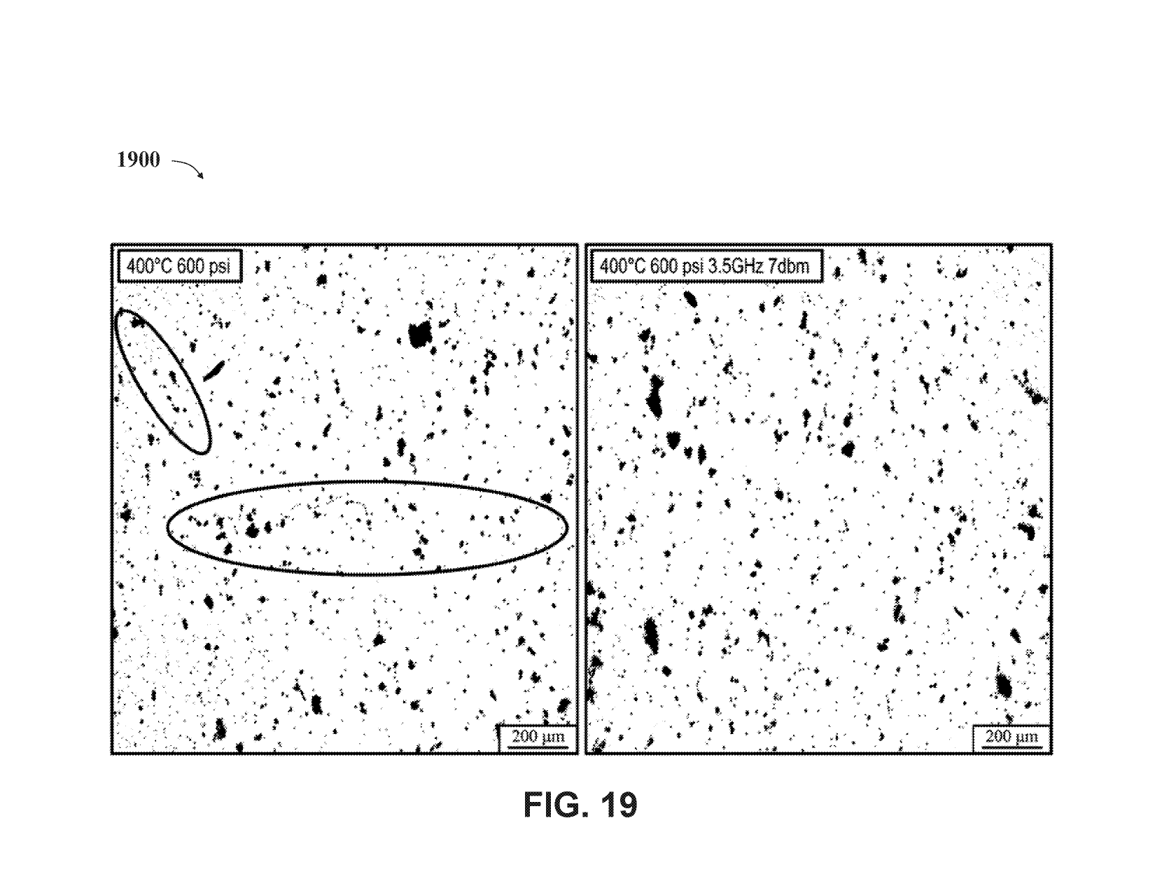

Referring now to FIG. 19, an illustration 1900 of an optical analysis of the bulk deposition revealed microcracking in the control sample, whereas the sample deposited with EMF assistance exhibited minimal to no microcracking, is shown. In a non-limiting example, illustration 1900 is arranged such that a control deposition condition is shown on a left portion of the figure and an electromagnetic field-assisted deposition condition is shown on a right portion of the figure. In a non-limiting example, the control sample shown on the left portion of illustration 1900 corresponds to a deposition performed at approximately 400 °C and 600 psi without application of high-frequency electromagnetic field input. The optical micrograph includes visible features identified as microcracks within the bulk deposited material. Selected regions of interest are highlighted in the illustration to emphasize elongated and interconnected cracking features extending through the deposited structure. In a non-limiting example, the sample shown on the right portion of illustration 1900 corresponds to a deposition performed at approximately 400 °C and 600 psi while additionally applying a high-frequency electromagnetic field having a frequency of approximately 3.5 GHz and an input power level of approximately 7 dBm. The optical micrograph of the electromagnetic field-assisted sample exhibits a substantially reduced presence of microcracking relative to the control sample, with few to no observable crack features within the bulk deposition. In a non-limiting example, comparison of the left and right portions of illustration 1900 demonstrates that application of high-frequency electromagnetic field assistance during deposition reduces the formation and propagation of microcracks within the deposited material under otherwise equivalent processing conditions. The reduction in microcracking is consistent with improved particle bonding, enhanced compaction, and more uniform stress distribution within the deposit. In a non-limiting example, illustration 1900 further supports the conclusion that the observed differences in microcracking behavior are attributable to the application of high-frequency electromagnetic field input, as other deposition parameters are maintained substantially constant between the control and experimental conditions. The optical analysis therefore provides additional evidence that electromagnetic field-assisted processing improves bulk structural integrity of cold spray deposits in a controlled and reproducible manner.

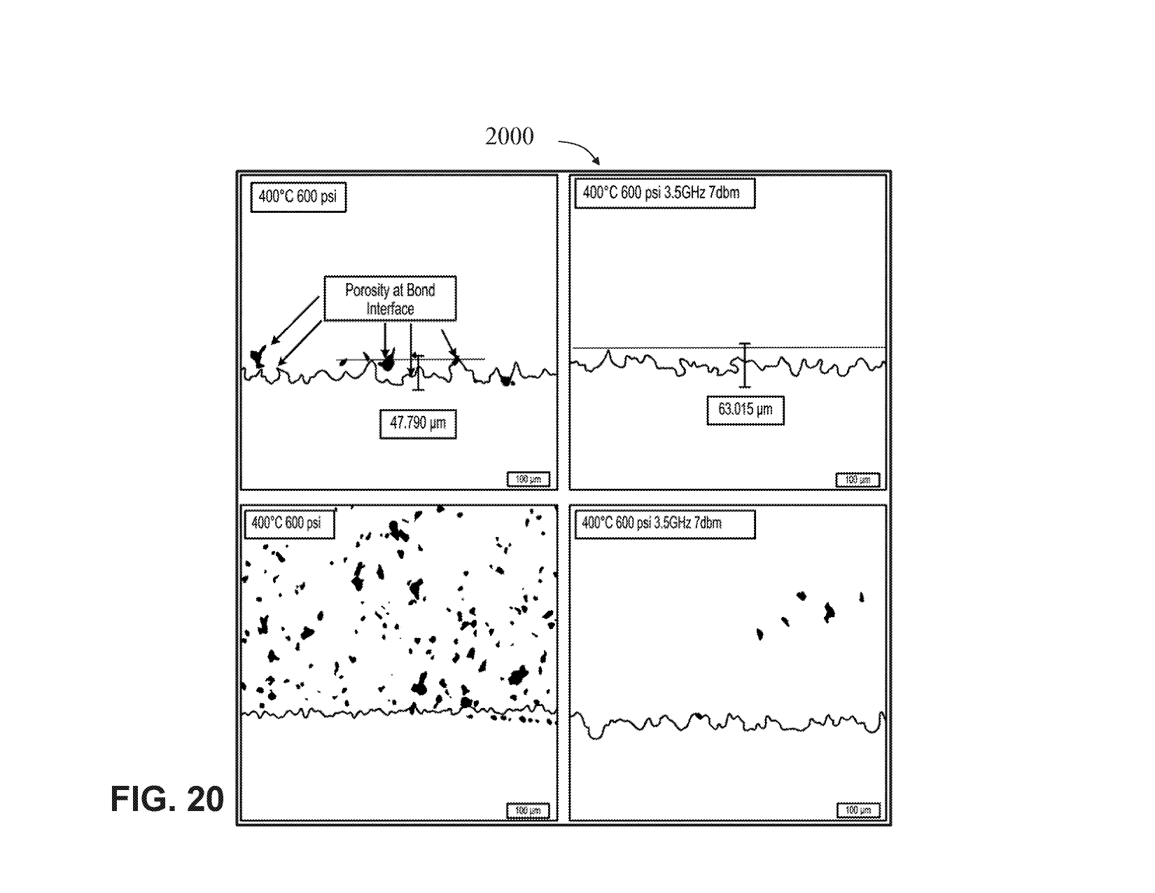

Referring now to FIG. 20, an illustration 2000 of a bond line analysis comparing the control sample (left) reveals pores and cracking, while the experimental sample (right) is free of detrimental artifacts, is shown. Without limitation, the experimental bond line may be 24.2% thicker than that of the control. In a non-limiting example, illustration 2000 is arranged such that the control sample is shown on a left portion of the figure and the experimental sample is shown on a right portion of the figure. In a non-limiting example, the control sample corresponds to a deposition performed at approximately 400 °C and 600 psi without application of high-frequency electromagnetic field input. The optical micrographs of the control sample show a bond line region characterized by visible porosity and cracking at or near the interface between the deposited material and the substrate. Labeled features in the illustration 2000 identify pores distributed along the bond interface, as well as localized cracking indicative of incomplete particle bonding or stress concentration. A representative bond line thickness measurement of approximately 47.790 µm is shown for the control sample. In a non-limiting example, the experimental sample corresponds to a deposition performed at approximately 400 °C and 600 psi with application of a high-frequency electromagnetic field having a frequency of approximately 3.5 GHz and an input power level of approximately 7 dBm. The optical micrographs of the experimental sample show a substantially more uniform bond line region with minimal to no observable porosity or cracking. A representative bond line thickness measurement of approximately 63.015 µm is shown for the experimental sample. In a non-limiting example, comparison of the control and experimental bond line regions demonstrates that application of high-frequency electromagnetic field assistance during deposition reduces interfacial defects and promotes formation of a thicker, more continuous bond line. The measured bond line thickness of the experimental sample represents an increase of approximately 24.2% relative to the control sample. In a non-limiting example, illustration 2000 further supports the conclusion that high-frequency electromagnetic field-assisted processing enhances interfacial bonding between the deposited material and the substrate. The reduction in porosity and cracking, together with increased bond line thickness, is consistent with improved particle deformation, compaction, and metallurgical interaction at the bond interface, achieved while maintaining substantially identical bulk processing parameters.

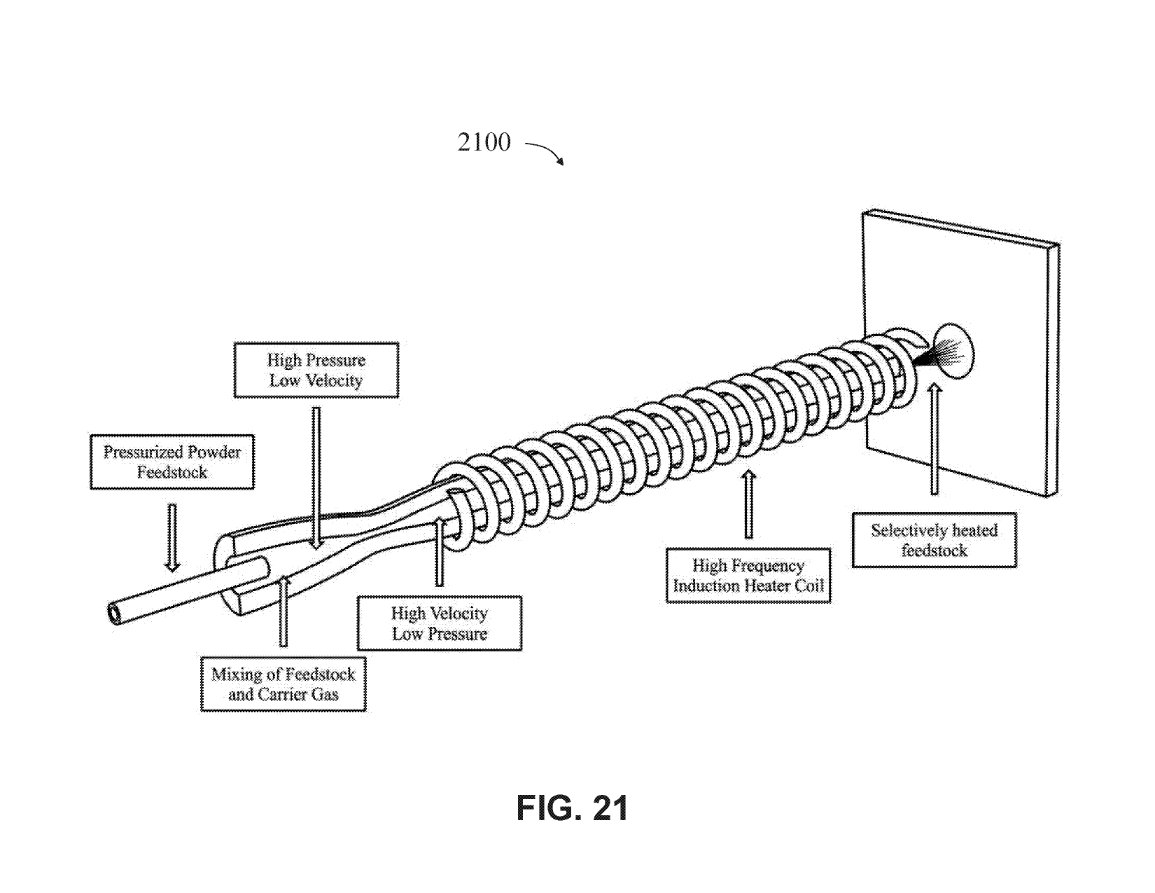

Referring now to FIG. 21, an illustration 2100 of a graphical representation of a concept to inductively heat powder particle just prior to deposition is shown. In a non-limiting example, the illustration shows a cold spray flow path extending from a powder injection region toward a substrate, with a high-frequency electromagnetic field–generating inductive heating element positioned along a downstream portion of the spray barrel at or downstream of a stagnation point of the carrier gas flow. In a non-limiting example, illustration 2100 depicts pressurized powder feedstock introduced into a carrier gas stream comprising helium, nitrogen, air, or another suitable gas, and accelerated through a nozzle toward the substrate. The carrier gas may initially be at relatively high pressure and lower velocity upstream of the nozzle and transition to lower pressure and higher velocity as the flow progresses toward the deposition region. The powder feedstock is entrained within the carrier gas and transported through the barrel under conditions suitable for cold spray deposition. In a non-limiting example, a high-frequency induction heater coil energized by a radio-frequency alternating current is positioned around a diverging and/or straight-bore portion of the barrel downstream of a mixing region for the powder feedstock and carrier gas. The induction heater coil is configured to generate a tunable radio-frequency electromagnetic field that couples with the metallic powder particles as they pass through the coil region. The electromagnetic field induces eddy currents within the particles, resulting in internal resistive heating of the particles while they remain in flight. In a non-limiting example, the illustration indicates that the powder particles are selectively heated just prior to impact with the substrate, as shown by a localized heated region near the exit of the barrel. This selective heating thermally softens the particles and increases the total energy of the particles at impact without requiring a corresponding increase in bulk carrier gas temperature or pressure, thereby reducing the critical velocity required for effective particle deformation and bonding. In a non-limiting example, illustration 2100 demonstrates that inductive heating of powder particles can be implemented in a system-agnostic and modular manner by integrating the induction heater coil along the spray barrel, allowing adaptation across different cold spray machines and platforms. Because the electromagnetic heating is applied downstream of the stagnation point and primarily to the particles rather than the nozzle, thermal loading of the nozzle is reduced and the likelihood of fouling is minimized. In a non-limiting example, the concept enables use of non-helium carrier gases, including nitrogen or air, while achieving particle deformation and deposition behavior comparable to higher-velocity helium-based systems. In this manner, the inductively heated non-helium system can produce depositions having mechanical properties, porosity levels, and bonding characteristics similar to or better than those achieved using helium, thereby supporting improved deposition efficiency, reduced operating cost, and enhanced material properties immediately prior to deposition.

With continued reference to FIG. 21, in a non-limiting example, the electromagnetic field-assisted cold spray approach described may provide a plurality of technical advantages relative to conventional cold spray processing. Selective inductive heating of powder feedstock prior to impact may increase mechanical properties of the deposited material in the as-sprayed state by promoting improved particle deformation, bonding, and compaction. Without limitation, because thermal softening is applied downstream of the nozzle and localized primarily to the powder particles, the likelihood of nozzle fouling may be reduced relative to systems relying on elevated bulk gas temperatures. As used in this disclosure, “fouling” is the undesired accumulation or adhesion of material on internal components of a processing system. Without limitation, fouling may occur on the internal components such as the nozzle or barrel which may interfere with normal flow, operation, or performance of the system. In a non-limiting example, selective electromagnetic conditioning of the powder feedstock may alleviate or eliminate the need for pre-treatment or mechanical preconditioning of powders prior to deposition. The localized nature of the heating further reduces thermal loading of the substrate and surrounding material, which may mitigate formation of thermal gradients, residual stresses, or distortion in the part being repaired or fabricated. In a non-limiting example, reduction in required carrier gas pressure and temperature enabled by electromagnetic field assistance may expand the range of compatible deposition parameters and substrate-material combinations. The modular configuration of the electromagnetic field-generating components allows adaptation across a variety of cold spray platforms without substantial modification of existing hardware. Additionally, tunable control of radio-frequency input parameters may enable material-specific optimization for different powder alloys, particle sizes, or feedstock compositions. In a non-limiting example, the relatively low overall thermal input associated with electromagnetic field-assisted processing may reduce oxidation in thermally sensitive materials while maintaining effective deposition behavior. The approach may be compatible with non-helium carrier gases, including nitrogen or air, thereby enabling cost-effective, domestically sourced operation while achieving deposition characteristics comparable to or exceeding those of helium-based systems.

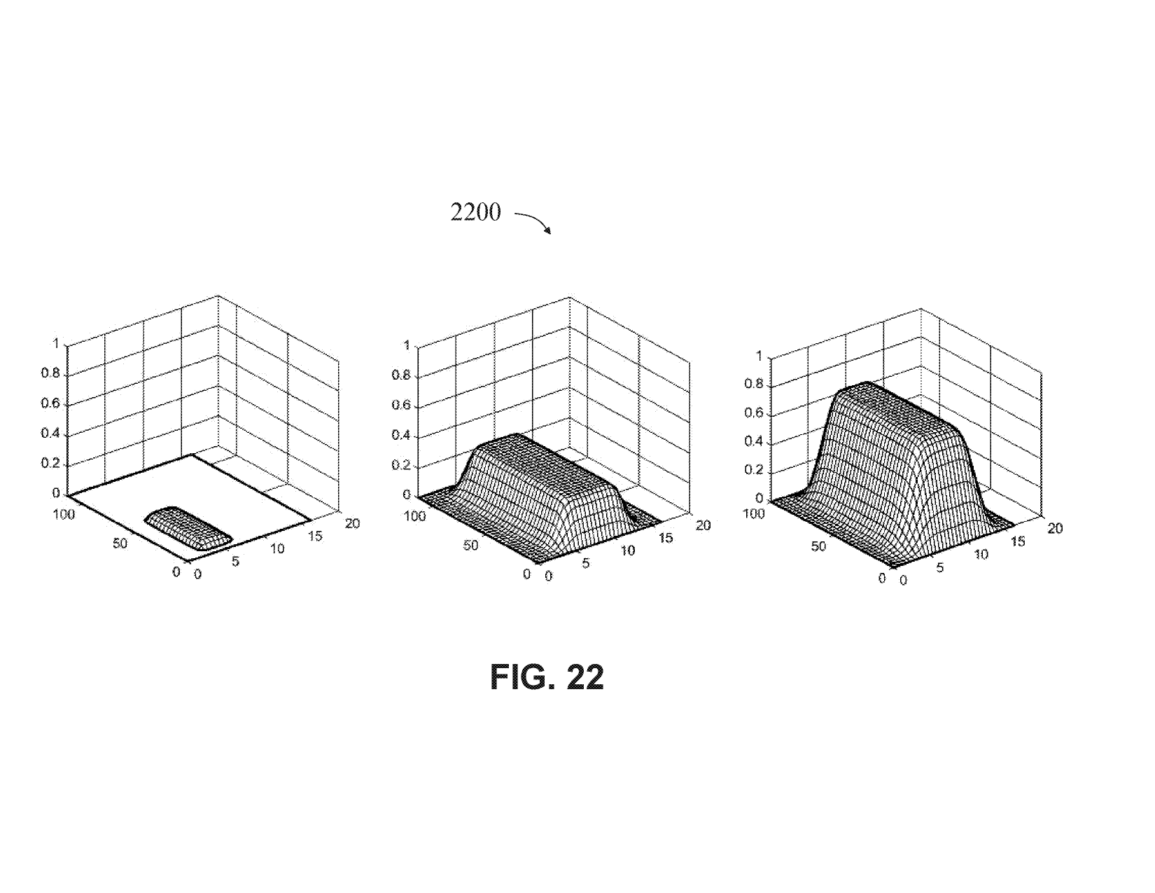

Referring now to FIG. 22, an illustration 2200 of a time lapse for deposition using a raster pattern onto a flat plate is shown. In a non-limiting example, illustration 2200 includes a sequence of three-dimensional deposition profiles corresponding to successive time intervals during cold spray processing, as generated by a numerical deposition model. In a non-limiting example, each frame of illustration 2200 represents a modeled height profile of deposited material obtained by numerically integrating a deposition profile over time as a spray nozzle traverses the flat plate along a raster pattern. The deposition profile may be approximated by a Gaussian distribution projected onto the substrate, with one or more scaling factors applied to account for spray geometry, nozzle orientation, and angular dependence of particle impact. The deposition profiles may be derived from experimentally measured height profiles of individual cold spray tracks deposited at multiple spray angles and may be approximated using a Gaussian-based distribution scaled according to spray geometry and particle impact angle. In a non-limiting example, an earliest frame of illustration 2200 shows an initial deposition region formed by one or more passes of the spray plume. Subsequent frames illustrate progressive buildup of material as additional raster passes overlap previously deposited regions, resulting in increased deposited thickness and lateral continuity. The color gradients shown in the three-dimensional profiles indicate relative deposited height, with increasing height corresponding to cumulative material deposition over time. In a non-limiting example, illustration 2200 visualizes the effects of spray geometry, raster overlap, and angular dependence of particle impacts on deposition uniformity and buildup behavior. Without limitation, by capturing the temporal evolution of deposition, the time-lapse representation supports analysis of secondary particle impacts, porosity formation, and buildup efficiency associated with raster-based cold spray processing. In a non-limiting example, illustration 2200 therefore provides a modeling framework for predicting material buildup on a flat substrate during raster deposition and supports optimization of spray parameters, raster strategies, and process conditions to achieve controlled thickness, reduced porosity, and improved deposition quality.

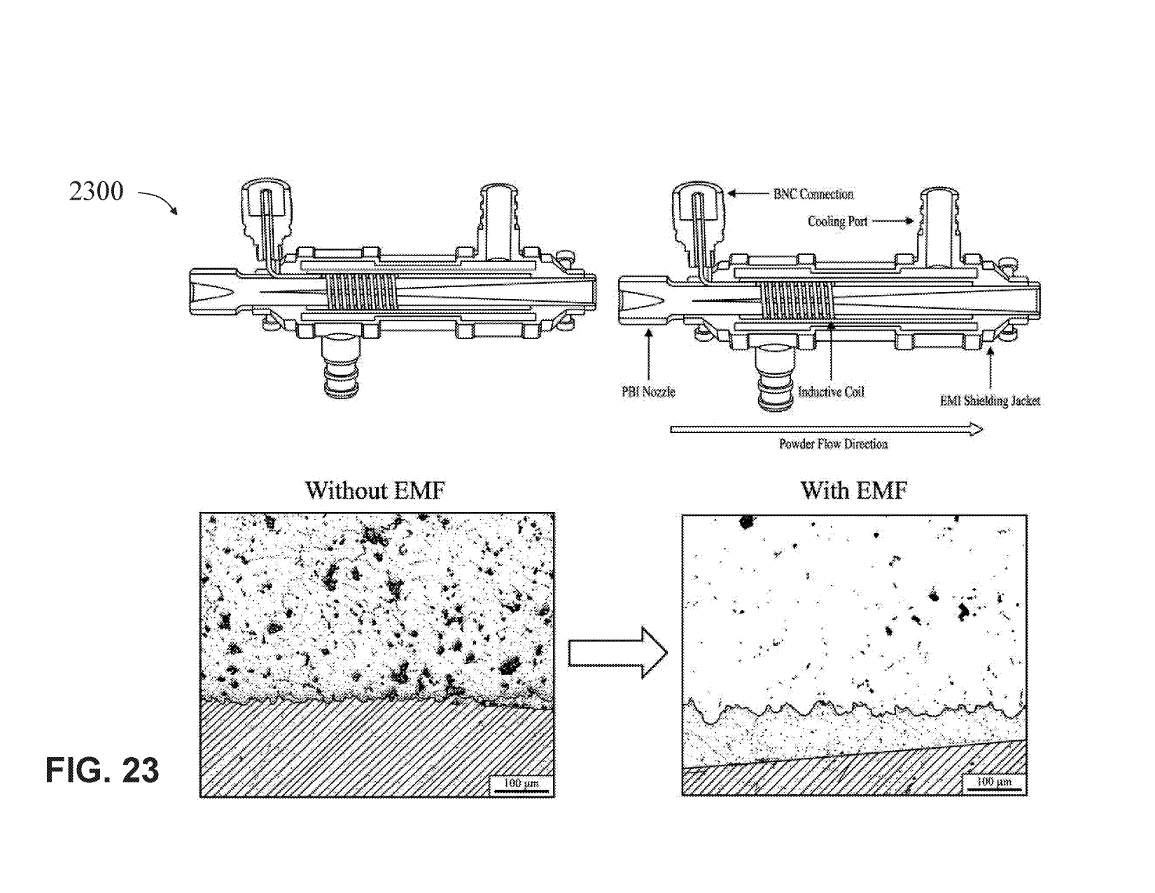

Referring now to FIG. 23, an illustration 2300 of a proposed EMF augmentation device from phase I with micrographs illustrating a reduction in porosity with EFM assistance for SS 316 is shown. In a non-limiting example, illustration 2300 includes a schematic and cross-sectional representation of the EMF augmentation device integrated with a cold spray nozzle, along with comparative microstructural images of deposits formed without EMF assistance and with EMF assistance. In a non-limiting example, the upper portion of illustration 2300 illustrates the EMF augmentation device positioned along a downstream portion of a cold spray nozzle, such as within a diverging or straight-bore section of the nozzle. The device may include an electromagnetic field-generating element, such as an inductive coil, arranged to couple high-frequency electromagnetic energy into powder feedstock as the feedstock travels toward a substrate. The configuration demonstrates how the EMF augmentation device may be applied to existing cold spray nozzles in a system-agnostic manner without requiring modification of upstream hardware. In a non-limiting example, illustration 2300 further includes a cross-sectional view of the EMF augmentation device showing internal placement of the electromagnetic field-generating element relative to the powder flow path. The cross-sectional view illustrates how the electromagnetic field is concentrated in a region where powder particles are exposed immediately prior to deposition, enabling localized thermal softening of the particles while limiting heating of surrounding components. In a non-limiting example, the lower portion of illustration 2300 includes micrographs of SS 316 deposits formed without EMF assistance and with EMF assistance. SS 316 is Type 316 stainless steel, a chromium-nickel-molybdenum stainless steel alloy. Without limitation the SS 316 may be used for corrosion-resistant structural and industrial applications. The micrograph corresponding to deposition without EMF assistance shows a higher density of pores distributed throughout the deposited material. In contrast, the micrograph corresponding to deposition with EMF assistance shows a visibly reduced pore population, indicating improved consolidation of the deposited material. In a non-limiting example, comparison of the micrographs demonstrates that application of EMF assistance during cold spray deposition reduces porosity in SS 316 deposits. The reduction in porosity is consistent with increased particle deformation and improved interparticle bonding resulting from additional energy imparted to the powder feedstock prior to impact. In a non-limiting example, illustration 2300 therefore provides both structural and microstructural evidence supporting the effectiveness of the EMF augmentation device developed during Phase I, and illustrates how EMF-assisted cold spray processing can enhance material quality by reducing porosity while maintaining compatibility with existing cold spray systems.

It is to be noted that any one or more of the aspects and embodiments described herein may be conveniently implemented using one or more machines (e.g., one or more computing devices that are utilized as a user computing device for an electronic document, one or more server devices, such as a document server, etc.) programmed according to the teachings of the present specification, as will be apparent to those of ordinary skill in the computer art. Appropriate software coding can readily be prepared by skilled programmers based on the teachings of the present disclosure, as will be apparent to those of ordinary skill in the software art. Aspects and implementations discussed above employing software and/or software modules may also include appropriate hardware for assisting in the implementation of the machine executable instructions of the software and/or software module.

Such software may be a computer program product that employs a machine-readable storage medium. A machine-readable storage medium may be any medium that is capable of storing and/or encoding a sequence of instructions for execution by a machine (e.g., a computing device) and that causes the machine to perform any one of the methodologies and/or embodiments described herein. Examples of a machine-readable storage medium include, but are not limited to, a magnetic disk, an optical disc (e.g., CD, CD-R, DVD, DVD-R, etc.), a magneto-optical disk, a read-only memory “ROM” device, a random access memory “RAM” device, a magnetic card, an optical card, a solid-state memory device, an EPROM, an EEPROM, and any combinations thereof. A machine-readable medium, as used herein, is intended to include a single medium as well as a collection of physically separate media, such as, for example, a collection of compact discs or one or more hard disk drives in combination with a computer memory. As used herein, a machine-readable storage medium does not include transitory forms of signal transmission.

Such software may also include information (e.g., data) carried as a data signal on a data carrier, such as a carrier wave. For example, machine-executable information may be included as a data-carrying signal embodied in a data carrier in which the signal encodes a sequence of instruction, or portion thereof, for execution by a machine (e.g., a computing device) and any related information (e.g., data structures and data) that causes the machine to perform any one of the methodologies and/or embodiments described herein.

Examples of computing device include, but are not limited to, an electronic book reading device, a computer workstation, a terminal computer, a server computer, a handheld device (e.g., a tablet computer, a smartphone, etc.), a web appliance, a network router, a network switch, a network bridge, any machine capable of executing a sequence of instructions that specify an action to be taken by that machine, and any combinations thereof. In one example, a computing device may include and/or be included in a kiosk.

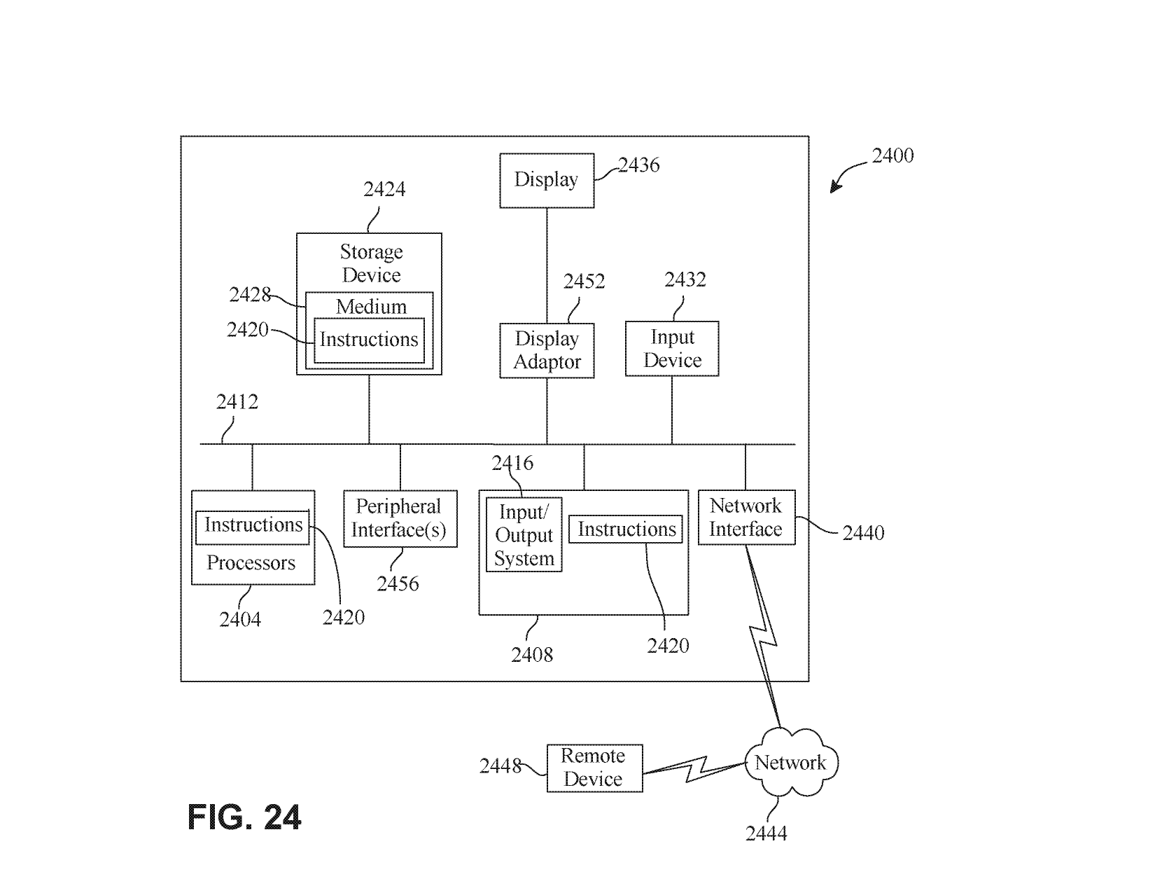

FIG. 24 shows a diagrammatic representation of one embodiment of computing device in the exemplary form of a computer system 2400 within which a set of instructions for causing a control system to perform any one or more of the aspects and/or methodologies of the present disclosure may be executed. It is also contemplated that multiple computing devices may be utilized to implement a specially configured set of instructions for causing one or more of the devices to perform any one or more of the aspects and/or methodologies of the present disclosure. Computer system 2400 includes a processor 2404 and a memory 2408 that communicate with each other, and with other components, via a bus 2412. Bus 2412 may include any of several types of bus structures including, but not limited to, a memory bus, a memory controller, a peripheral bus, a local bus, and any combinations thereof, using any of a variety of bus architectures.

Processor 2404 may include any suitable processor, such as without limitation a processor incorporating logical circuitry for performing arithmetic and logical operations, such as an arithmetic and logic unit (ALU), which may be regulated with a state machine and directed by operational inputs from memory and/or sensors; processor 2404 may be organized according to Von Neumann and/or Harvard architecture as a non-limiting example. Processor 2404 may include, incorporate, and/or be incorporated in, without limitation, a microcontroller, microprocessor, digital signal processor (DSP), Field Programmable Gate Array (FPGA), Complex Programmable Logic Device (CPLD), Graphical Processing Unit (GPU), general purpose GPU, Tensor Processing Unit (TPU), analog or mixed signal processor, Trusted Platform Module (TPM), a floating point unit (FPU), system on module (SOM), and/or system on a chip (SoC).

Memory 2408 may include various components (e.g., machine-readable media) including, but not limited to, a random-access memory component, a read only component, and any combinations thereof. In one example, a basic input/output system 2416 (BIOS), including basic routines that help to transfer information between elements within computer system 2400, such as during start-up, may be stored in memory 2408. Memory 2408 may also include (e.g., stored on one or more machine-readable media) instructions (e.g., software) 2420 embodying any one or more of the aspects and/or methodologies of the present disclosure. In another example, memory 2408 may further include any number of program modules including, but not limited to, an operating system, one or more application programs, other program modules, program data, and any combinations thereof.

Computer system 2400 may also include a storage device 2424. Examples of a storage device (e.g., storage device 2424) include, but are not limited to, a hard disk drive, a magnetic disk drive, an optical disc drive in combination with an optical medium, a solid-state memory device, and any combinations thereof. Storage device 2424 may be connected to bus 2412 by an appropriate interface (not shown). Example interfaces include, but are not limited to, SCSI, advanced technology attachment (ATA), serial ATA, universal serial bus (USB), IEEE 1394 (FIREWIRE), and any combinations thereof. In one example, storage device 2424 (or one or more components thereof) may be removably interfaced with computer system 2400 (e.g., via an external port connector (not shown)). Particularly, storage device 2424 and an associated machine-readable medium 2428 may provide nonvolatile and/or volatile storage of machine-readable instructions, data structures, program modules, and/or other data for computer system 2400. In one example, software 2420 may reside, completely or partially, within machine-readable medium 2428. In another example, software 2420 may reside, completely or partially, within processor 2404.

Computer system 2400 may also include an input device 2432. In one example, a user of computer system 2400 may enter commands and/or other information into computer system 2400 via input device 2432. Examples of an input device 2432 include, but are not limited to, an alpha-numeric input device (e.g., a keyboard), a pointing device, a joystick, a gamepad, an audio input device (e.g., a microphone, a voice response system, etc.), a cursor control device (e.g., a mouse), a touchpad, an optical scanner, a video capture device (e.g., a still camera, a video camera), a touchscreen, and any combinations thereof. Input device 2432 may be interfaced to bus 2412 via any of a variety of interfaces (not shown) including, but not limited to, a serial interface, a parallel interface, a game port, a USB interface, a FIREWIRE interface, a direct interface to bus 2412, and any combinations thereof. Input device 2432 may include a touch screen interface that may be a part of or separate from display device 2436, discussed further below. Input device 2432 may be utilized as a user selection device for selecting one or more graphical representations in a graphical interface as described above.

A user may also input commands and/or other information to computer system 2400 via storage device 2424 (e.g., a removable disk drive, a flash drive, etc.) and/or network interface device 2440. A network interface device, such as network interface device 2440, may be utilized for connecting computer system 2400 to one or more of a variety of networks, such as network 2444, and one or more remote devices 2448 connected thereto. Examples of a network interface device include, but are not limited to, a network interface card (e.g., a mobile network interface card, a LAN card), a modem, and any combination thereof. Examples of a network include, but are not limited to, a wide area network (e.g., the Internet, an enterprise network), a local area network (e.g., a network associated with an office, a building, a campus or other relatively small geographic space), a telephone network, a data network associated with a telephone/voice provider (e.g., a mobile communications provider data and/or voice network), a direct connection between two computing devices, and any combinations thereof. A network, such as network 2444, may employ a wired and/or a wireless mode of communication. In general, any network topology may be used. Information (e.g., data, software 2420, etc.) may be communicated to and/or from computer system 2400 via network interface device 2440.

Computer system 2400 may further include a video display adapter 2452 for communicating a displayable image to a display device, such as display device 2436. Examples of a display device include, but are not limited to, a liquid crystal display (LCD), a cathode ray tube (CRT), a plasma display, a light emitting diode (LED) display, and any combinations thereof. Display adapter 2452 and display device 2436 may be utilized in combination with processor 2404 to provide graphical representations of aspects of the present disclosure. In addition to a display device, computer system 2400 may include one or more other peripheral output devices including, but not limited to, an audio speaker, a printer, and any combinations thereof. Such peripheral output devices may be connected to bus 2412 via a peripheral interface 2456. Examples of a peripheral interface include, but are not limited to, a serial port, a USB connection, a FIREWIRE connection, a parallel connection, and any combinations thereof.

The foregoing has been a detailed description of illustrative embodiments of the invention. Various modifications and additions can be made without departing from the spirit and scope of this invention. Features of each of the various embodiments described above may be combined with features of other described embodiments as appropriate in order to provide a multiplicity of feature combinations in associated new embodiments. Furthermore, while the foregoing describes a number of separate embodiments, what has been described herein is merely illustrative of the application of the principles of the present invention. Additionally, although particular methods herein may be illustrated and/or described as being performed in a specific order, the ordering is highly variable within ordinary skill to achieve methods according to the present disclosure. Accordingly, this description is meant to be taken only by way of example, and not to otherwise limit the scope of this invention.

Exemplary embodiments have been disclosed above and illustrated in the accompanying drawings. It will be understood by those skilled in the art that various changes, omissions and additions may be made to that which is specifically disclosed herein without departing from the spirit and scope of the present invention.

What is claimed is:

1. A system for assisting in deposition of feedstock materials, the system comprising:
an electromagnetic field (EMF) emitter configured to heat a feedstock;
a feedstock delivery device configured to deliver the feedstock; and
a thermal spray device comprising a spray nozzle in fluid communication with the feedstock delivery device and configured to accelerate the feedstock towards a substrate, wherein the EMF emitter is positioned relative to the spray nozzle such that it heats the feedstock in flight.

2. The system of claim 1, wherein the EMF emitter is positioned downstream of a stagnation region of the spray nozzle such that the feedstock is heated in flight after acceleration by the spray nozzle and prior to impact with the substrate.

3. The system of claim 1, wherein the EMF emitter is configured to heat the feedstock to thermally soften the feedstock while maintaining the feedstock in a solid state during flight.

4. The system of claim 1, wherein the thermal spray device is configured to accelerate the feedstock using a carrier gas comprising nitrogen.

5. The system of claim 1, wherein the spray nozzle comprises a de Laval nozzle, and wherein the EMF emitter is positioned downstream of an outlet of the de Laval nozzle.

6. The system of claim 1, wherein the EMF emitter is configured to heat the feedstock by inducing electromagnetic coupling within the feedstock that generates internal thermal energy within the feedstock during flight.

7. The system of claim 1, further comprising one or more cooling channels coupled to the EMF emitter, wherein the one or more cooling channels are configured to control, using a cooling fluid, a temperature of at least the feedstock.

8. The system of claim 1, wherein the EMF emitter is configured to maintain a resonance frequency of about 550 MHz to about 6,000 MHz.

9. The system of claim 1, wherein the EMF emitter comprises a point source emitter configured to generate an EMF.

10. The system of claim 1, further comprising a case enclosing the spray nozzle and the EMF emitter, wherein the case and the EMF emitter are configured to be removable from the system, and wherein the case maintains a position of the EMF emitter.

11. A method for depositing feedstock materials, the method comprising:
heating, using an electromagnetic field (EMF) emitter, a feedstock;
delivering, using a feedstock delivery device, the feedstock; and
accelerating, using a thermal spray device comprising a spray nozzle in fluid communication with the feedstock delivery device, the feedstock towards a substrate, wherein the EMF emitter is positioned relative to the spray nozzle such that it heats the feedstock in flight.

12. The method of claim 11, further comprising:
heating, using the EMF emitter, the feedstock in flight after acceleration by the spray nozzle and prior to impact with the substrate, wherein the EMF emitter is positioned downstream of a stagnation region of the spray nozzle.

13. The method of claim 11, further comprising:
heating, using the EMF emitter, the feedstock to thermally soften the feedstock; and
maintaining the feedstock in a solid state during flight.

14. The method of claim 11, further comprises accelerating, using the thermal spray device, the feedstock using a carrier gas comprising nitrogen.

15. The method of claim 11, wherein the spray nozzle comprises a de Laval nozzle, and wherein the EMF emitter is positioned downstream of an outlet of the de Laval nozzle.

16. The method of claim 11, further comprising:
heating, using the EMF emitter, the feedstock by inducing electromagnetic coupling within the feedstock to generate internal thermal energy within the feedstock during flight.

17. The method of claim 11, further comprising:
controlling, using one or more cooling channels and a cooling fluid, a temperature of at least the feedstock, wherein the one or more cooling channels are coupled to the EMF emitter.

18. The method of claim 11, further comprising maintaining, using the EMF emitter, a resonance frequency of about 550 MHz to about 6,000 MHz.

19. The method of claim 11, further comprising, generating using a point source emitter of the EMF emitter, an EMF.

20. The method of claim 11, further comprising enclosing, using a case, the spray nozzle and the EMF emitter, wherein the case and the EMF emitter are configured to be removable, and wherein the case maintains a position of the EMF emitter.
